(19) United States
(12) Patent Application Publication
(10) Pub. No.: US 2023/0206102 A1
(43) Pub. Date: Jun. 29, 2023

(54) METHOD OF SIMULATING A QUANTUM COMPUTATION, SYSTEM FOR SIMULATING A QUANTUM COMPUTATION, METHOD FOR ISSUING A COMPUTATIONAL KEY, SYSTEM FOR ISSUING A COMPUTATIONAL KEY

(71) Applicant: THE UNIVERSITY OF BRITISH COLUMBIA, Vancouver (CA)

(72) Inventors: Robert RAUSSENDORF, Vancouver (CA); Michael Owen ZUREL, Vancouver (CA); Cihan OKAY, Ankara (TR)

(21) Appl. No.: 17/995,068

(22) PCT Filed: Apr. 1, 2021
(86) PCT No.: PCT/CA2021/050445

§ 371 Date: Sep. 29, 2022

Related U.S. Application Data
(60) Provisional application No. 63/004,701, filed on Apr. 3, 2020.

(51) Int. Cl. G06N 10/20; G06N 10/60

(52) U.S. Cl. CPC G06N 10/20; G06N 10/60

(57) ABSTRACT

A method of simulating a quantum computation is provided. The method includes determining, by a first system (110) including one r more first processing units (112), a size parameter of a quantum computation. The quantum computation is configured for solving a computational problem. The size parameter is characteristic of an input size of the computational problem. The method includes communicating, by the first system, the size parameter to a second system (120) including one or more second processing units (122). The method includes communicating, by the second system, a computational key to the first system, wherein the computational key is based on the size parameter of the quantum computation. The method includes performing, by the first system, a simulation of the quantum computation based on the computational key.

### CROSS-REFERENCE TO RELATED APPLICATION

This application claims priority from U.S. application No. 63/004,701 filed 3 Apr. 2020 and entitled CLASSICAL SIMULATION OF QUANTUM COMPUTATION USING A UNIVERSAL CLASSICAL KEY which is hereby incorporated herein by reference for all purposes. For purposes of the United States of America, this application claims the benefit under 35 U.S.C. § 119 of U.S. application No. 63/004,701 filed 3 Apr. 2020 and entitled CLASSICAL SIMULATION OF QUANTUM COMPUTATION USING A UNIVERSAL CLASSICAL KEY.

### FIELD

Embodiments of the present disclosure relate to a method for simulating a quantum computation, more specifically a method for classically simulating a quantum computation. Embodiments described herein involve reproducing the output of a quantum computation by performing a simulation of the quantum computation, wherein the simulation runs on a classical computing device, such as a computer operating based on classical bits. By performing the classical simulation, a computational problem that is solved by the quantum computation can be solved by the classical computing device.

### BACKGROUND

Quantum computation is an approach to computing in which information is encoded into quantum systems, such as qubits. By engineering physical interactions between the constituents of the quantum system, such as the qubits, computational processes which solve difficult computational problems can be realized. Quantum computation is distinguished from classical computation, the latter involving information processing based on classical bits (i.e. 0s and 1s) only.

Whereas it has been theoretically established that quantum computers can solve certain computational problems (such as, for example, prime factorization of large integers) much faster than any known classical algorithm, the physical realization of quantum computers involves complex, large-scale and expensive experimental set-ups which are not accessible, for example, to private users.

An approach taken by some is to design methods for classically simulating a quantum computation. Therein, the aim is to reproduce, by using a classical computer only, the output of a quantum computation by suitably mimicking the quantum computation on such classical computer. In other words, a classical simulation of a quantum computation allows reproducing the output of the quantum computation without actually physically implementing the quantum computation as such. Thereby, the complex experimental set-up needed for realizing the quantum computation can be avoided.

However, while some methods for classical simulation of quantum computation exist, at present they only regard a small subset of all possible quantum computations. For many quantum computations, no efficient classical simulation is known.

In light of the above, there is a need for improved methods for classical simulation of quantum computation.

### SUMMARY

According to an embodiment, a method of simulating a quantum computation is provided. The method includes determining, by a first system including one or more first processing units, a size parameter of a quantum computation. The quantum computation is configured for solving a computational problem. The size parameter is characteristic of an input size of the computational problem. The method includes communicating, by the first system, the size parameter to a second system including one or more second processing units. The method includes communicating, by the second system, a computational key to the first system, wherein the computational key is based on the size parameter of the quantum computation. The method includes performing, by the first system, a simulation of the quantum computation based on the computational key.

According to a further embodiment, a method of simulating a quantum computation is provided. The method includes determining, by a first system comprising one or more first processing units, a size parameter of a quantum computation. The quantum computation is configured for solving a computational problem. The size parameter is characteristic of an input size of the computational problem. The method includes communicating, by the first system, the size parameter to a second system comprising one or more second processing units. The method includes communicating, by the second system, a computational key to a third system comprising one or more third processing units, wherein the computational key is based on the size parameter of the quantum computation. The method includes performing, by the third system, a simulation of the quantum computation based on the computational key.

According to a further embodiment, a method for issuing a computational key is provided. The method includes receiving a size parameter of a quantum computation, wherein the quantum computation is configured for solving a computational problem, wherein the size parameter is characteristic of an input size of the computational problem. The method includes issuing a computational key, wherein the computational key is based on the size parameter of the quantum computation, wherein the computational key allows performing a simulation of the quantum computation based on the computational key.

According to a further embodiment, a method of simulating a quantum computation is provided. The method includes determining a size parameter of a quantum computation, wherein the quantum computation is configured for solving a computational problem, wherein the size parameter is characteristic of an input size of the computational problem. The method includes performing a simulation of the quantum computation based on a computational key, wherein the computational key is based on the size parameter of the quantum computation.

According to a further embodiment, a system for simulating a quantum computation is provided. The system includes a first system comprising one or more first processing units. The system includes a second system comprising one or more second processing units, the second system being communicatively coupled to the first system. The first system is configured to communicate a size parameter of a quantum computation to the second system. The quantum computation is configured for solving a computational problem. The size parameter is characteristic of an input size of the computational problem. The second system is configured for communicating a computational key to the first system, wherein the computational key is based on the size parameter of the quantum computation. The first system is configured for performing a simulation of the quantum computation based on the computational key.

According to a further embodiment, a system for simulating a quantum computation is provided. The system includes a first system including one or more first processing units. The system includes a second system including one or more second processing units. The second system is communicatively coupled to the first system. The system includes a third system including one or more third processing units, the second system being communicatively coupled to the third system. The first system is configured to communicate a size parameter of a quantum computation to the second system, wherein the quantum computation is configured for solving a computational problem, wherein the size parameter is characteristic of an input size of the computational problem. The second system is configured for communicating a computational key to the third system, wherein the computational key is based on the size parameter of the quantum computation. The third system is configured for performing a simulation of the quantum computation based on the computational key.

According to a further embodiment, a system for issuing a computational key is provided, for example a second system. The system includes one or more processing units. The one or more processing units are configured for receiving a size parameter of a quantum computation, wherein the quantum computation is configured for solving a computational problem, wherein the size parameter is characteristic of an input size of the computational problem. The one or more processing units are configured for issuing a computational key, wherein the computational key is based on the size parameter of the quantum computation, wherein the computational key allows performing a simulation of the quantum computation based on the computational key.

According to a further embodiment, a system for simulating a quantum computation is provided. The system includes one or more processing units. The one or more processing units are configured for determining a size parameter of a quantum computation, wherein the quantum computation is configured for solving a computational problem, wherein the size parameter is characteristic of an input size of the computational problem. The one or more processing units are configured for performing a simulation of the quantum computation based on a computational key, wherein the computational key is based on the size parameter of the quantum computation.

Embodiments are also directed at apparatuses for carrying out the disclosed methods and include apparatus parts for performing each described method aspect. These method aspects may be performed by way of hardware components, a computer programmed by appropriate software, by any combination of the two or in any other manner. Furthermore, embodiments according to the disclosure are also directed at methods for operating the described apparatus. The methods for operating the described apparatus include method aspects for carrying out every function of the apparatus.

### BRIEF DESCRIPTION OF THE DRAWINGS

So that the manner in which the above recited features of the present disclosure can be understood in detail, a more particular description of the disclosure, briefly summarized above, may be had by reference to embodiments. The accompanying drawings relate to embodiments of the disclosure and are described in the following:

FIG. 1 shows a system for simulating a quantum computation according to embodiments described herein, the system including a first system and a second system;

FIG. 2 illustrates a computational key being used by a first system for simulating a plurality of quantum computations;

FIG. 3 shows a system for simulating a quantum computation according to embodiments described herein, the system including a first system, a second system and a third system;

FIG. 4 shows a system for simulating a quantum computation according to embodiments described herein, the system including a first system, a second system, a third system and a plurality of further systems;

FIG. 5 illustrates a mapping from a quantum computation to a magic state quantum computation in standard form;

FIG. 6 shows a system for simulating a quantum computation according to embodiments described herein, the system including a first system, a second system and a third system;

FIG. 7 shows a system for simulating a quantum computation according to embodiments described herein;

FIG. 8 illustrates a method for simulating a quantum computation according to embodiments described herein;

FIG. 9 illustrates three possibilities for Ω∩M up to permutations of rows and columns, as described herein;

FIG. 10 illustrates the isotropic subspaces of E₂ of dimension 1 and 2, as described herein; and

FIGS. 11-13 illustrate the property that [symbol] (Sᵢ) for i=1, 2, . . . , 8 has full perrank, as described herein.

### DETAILED DESCRIPTION

Reference will now be made in detail to the various embodiments of the disclosure, one or more examples of which are illustrated in the figures. Within the following description of the drawings, the same reference numbers refer to same components. Generally, only the differences with respect to individual embodiments are described. Each example is provided by way of explanation of the disclosure and is not meant as a limitation of the disclosure. Further, features illustrated or described as part of one embodiment can be used on or in conjunction with other embodiments to yield yet a further embodiment. It is intended that the description includes such modifications and variations.

Embodiments described herein relate to a method for simulating quantum computations. In some embodiments, the simulation can be performed using a distributed system architecture. A first system, or client, aims to classically simulate a quantum computation which is configured for solving a computational problem. The first system sends a size parameter to a second system, e.g. a centralized server, wherein the size parameter is a parameter characteristic of the input size of the computational problem that is solved by the quantum computation. Based on the size parameter, the second system determines a computational key and sends the computational key to the first system. The computational key is comprised of classical information and may be determined by the second system by classical or quantum computing. Once the computational key has been determined and sent to the first system, a simulation of the quantum computation is performed by the first system based on the computational key, wherein the simulation may be entirely classical. In other words, based on the computational key, the first system can reproduce the output of the quantum computation, and hence solve the computational problem, by performing classical computing only, i.e. without physically realizing the quantum computation in question.

While the determination of the computational key as performed by the second system may be involve a long runtime for a classical computer, or may involve using a quantum computer, the computational key need only be determined once for a given size parameter. That is, if the first system—or any other system, e.g. another client—aims to classically simulate another quantum computation with a size parameter that is equal to, or less than, the initial size parameter, then the same computational key can be used for simulating this second quantum computation i.e. the second system need not re-compute the computational key. In this way, a method is provided where a same computational key can be used for classically simulating all quantum computations having a size parameter up to a certain value. There is no restriction on which kind of quantum computations can be simulated in this way. In other words, the simulation method according to embodiments described herein is universal in the sense that that arbitrary quantum computations can be classically simulated once a suitable computational key is made available by the second system.

For example, in one possible implementation, the second system may be a powerful centralized computing system (classical or quantum) that is devoted to the computation and storage of computational keys for increasing values of the size parameter. The second system may thus build a database containing the computational keys in question. Whenever a client (e.g. the first system) wishes to simulate any quantum computation, the second system issues (e.g. sells) a suitable computational key which enables the client, which may be a small private user, to simulate the quantum computation in question classically, e.g. by using a laptop or other classical computer.

### Definitions

A quantum computation can be understood as a computational process that is performed using a quantum system, i.e. a physical system whose properties and behavior are governed by the laws of quantum physics. The quantum system can be any system governed by the laws of quantum physics, such as a system including a plurality of ions, photons, superconducting qubits, and the like. The quantum system may have a plurality of constituents, such as qubits. A quantum computation may include initializing at least some of the constituents in an initial quantum state, or input quantum state, for example by performing one or more unitary operations on the quantum system by measuring the quantum system, by cooling the quantum system, or a combination thereof. An input quantum state can be understood as a quantum state of the quantum system that is configured to be prepared in an initial phase of the quantum computation. An input quantum state as described herein can be a pure quantum state or mixed quantum state. For ease of notation, an input quantum state may be denoted herein as |ψᵢₙₚᵤₜ>. Yet, the disclosure is not limited thereto and it shall be understood that the pure state |ψᵢₙₚᵤₜ> can be replaced by a mixed quantum state in any embodiment described herein.

After preparation of the input quantum state, a quantum computation may include evolving the quantum system, for example by unitary evolution of the quantum system or by measuring at least a portion of the quantum system or by a combination of both. To realize the operations performed during a quantum computation, such as unitary evolution or measurement, the quantum mechanical system may physically interact with entities such as electromagnetic fields, lasers, and the like. A quantum computation may include at least one measurement to provide a read-out of the quantum computation. The read-out may include a solution to the computational problem, or at least based on the read-out a solution to the computational problem can be determined using, for example, a classical (i.e. non-quantum) computer. The read-out may depend on the input quantum state and on the nature of the subsequent evolution of the quantum system performed during the quantum computation. A quantum computer may be controlled to perform a specific quantum computation by one or both of selection of the input quantum state and control of the evolution.

A qubit, or quantum bit, can be understood as a physical two-level system governed by the laws of quantum physics. A qubit can be in a quantum state |0> or in a quantum state |1>. The states |0> and |1> are basis states of the qubit. A qubit can be in an arbitrary superposition (or linear combination) of said basis states, namely a quantum state of the form a|0>+b|1> where a and b are complex coefficients. A quantum system including a plurality of qubits can be in a state of the form |000 . . . >, |001 . . . >, |101 . . . > and the like, each of which being a quantum basis state. Therein, for example, |101 . . . > is shorthand for |1>⊗|0>⊗1>⊗ . . . (where ⊗ is the tensor product) and denotes a quantum state wherein the first qubit is in the quantum state |1>, the second qubit is in the quantum state |0> and the third qubit is in the quantum state |1>. In total, there are 2ⁿ quantum basis states for a quantum system consisting of n qubits. A system of n qubits can be in a quantum state (pure quantum state) which is an arbitrary superposition of the 2ⁿ quantum basis states, for example a quantum state of the form a |000 . . . >+b|001 . . . >+c|101 . . . >+ . . . . A system of n qubits can be in a mixed quantum state, which is a probabilistic mixture (or ensemble) of pure quantum states.

A classical bit can take the values 0 and 1, and is distinguished from a quantum bit, or qubit. The term “bit” as used herein will mean a classical bit, unless it is specified explicitly that the bit is a quantum bit, i.e. a qubit.

A computational problem as described herein can be understood as a problem (or function) having an input of a certain size. The size of the input, or input size, can be understood as a quantity characteristic of the minimal amount of computational space that is capable of storing the input. The input size can be a quantity characteristic of the number of bits needed for representing the input. The input of a computational problem need not be presented in the form of a plurality of bits. For example, the input can include a set of one or more real or integer numbers which may represent a set of distances, energies, interaction strengths, weights, and the like. The input can take other forms, for example the input can include a lattice or any other kind of graph. The form of the input to a computational problem, as described herein, can be any form, not limited to the examples given above.

An aim of a computational problem can include computing an output of the computational problem based on the input of the computational problem. For example, a computational problem called “Factoring” can have, as an input, an m-bit positive integer I (where the number of bits m needed for representing the integer I in binary notation may be taken as the input size). A goal of the problem “Factoring” may consist of computing the prime factors of I. An output of the computational problem may include a list consisting of the prime factors of I. In another example, a problem called “graph isomorphism” can have, as an input, a pair of mathematical graphs G and G′ each having m nodes. The input size can be the number of nodes of each graph, i.e. the number m. A goal of the problem “graph isomorphism” may consist of determining whether the two graphs G and G′ are isomorphic. The output is “yes” if the two graphs are isomorphic and “no” if the graphs are not isomorphic.

A computational problem as described herein can be any computational problem that is computable by a quantum computer. Since a quantum computer, like a classical computer (Turing machine), can in principle compute any computable function if the runtime of the quantum computation is long enough, a computational problem as described herein can be an arbitrary computational problem, in other words an arbitrary computable function. In some embodiments, a computational problem can be a computational problem belonging to the complexity class BQP (bounded-error quantum polynomial time) which is the family of all computational problems that can be solved efficiently (i.e. in polynomial time in the input size of the computational problem) by a quantum computer. In other words, a computational problem as described herein can be any computational problem for which an efficient (i.e. polynomial-time) quantum algorithm exists. The problem “factoring” is one such example, in light of Shor's algorithm which is an efficient quantum algorithm for factoring integers. The present disclosure is not limited thereto. Many other examples of efficient quantum algorithms, and hence computational problems in the class BQP, exist.

A computational problem as described herein can be for example, a decision problem (being a problem where the output takes one of two values, such as “0” and “1” or “yes” and “no”), an optimization problem (where the task is to compute a minimum or maximum of a cost function or find parameter values that yield the minimum or maximum), a simulation problem (where the task is to simulate the properties or dynamics of a physical system of interest), and the like. A computational problem can be a computational problem situated in any of a variety of fields, such as physics, mathematics, chemistry, engineering, computer science and the like.

According to embodiments described herein, a system such as the first system performs a simulation of a quantum computation. The act of performing a simulation of a quantum computation can be understood as performing a computational process which reproduces at least the read-out of the quantum computation, at least approximately. For example, the read-out of the quantum computation may be or include a value 0 or 1 (i.e. a classical bit) obtained by performing a measurement of one of the qubits of the quantum system, where the value 0 may be obtained with probability p(0)=p and the value 1 may be obtained with probability p(1)=1−p. A simulation of the quantum computation can include a process which generates the value 0 with probability q(0) and the value 1 with probability q(1), such that q(0) and q(1) are equal to p(0) and p(1), respectively, at least approximately.

Additionally, a simulation of a quantum computation can include reproducing the outcomes of additional measurements that may be performed during the quantum computation, i.e. measurements other than the read-out measurement. For example, a quantum computation can include one or more measurements which can be performed before the read-out measurement. A simulation of the quantum computation can include performing a simulation of each of the one or more measurements, namely generating each outcome of each measurement with a probability which is approximately equal (for example up to a predetermined tolerance) to the probability assigned to that outcome by the measurement.

A simulation of a quantum computation can be a probabilistic process (or randomized process) wherein one or more outputs of the simulation are provided probabilistically. Performing a simulation can include generating one or more random numbers, such as one or more random bits, for example by the (one or more first processing units of the) first system or the (one or more third processing units of the) third system as described herein. The simulation can include processing the one or more random numbers, for example by the (one or more first processing units of the) first system or the (one or more third processing units of the) third system.

A simulation of a quantum computation may be a classical simulation. A classical simulation of a quantum computation can be understood as a simulation operating with classical bits (or classical information carriers other than bits, such as d-level information carriers which can take values 0, 1, . . . , d−1) only. A classical simulation does not involve physically realizing a quantum system or physically acting on a quantum system, such as a system of qubits, for encoding and processing information.

A Pauli operator, or Pauli observable, of a quantum system of n qubits is an operator (linear operator, or matrix) of the form c A₁⊗A₂⊗ . . . ⊗ Aₙ. Therein, c is a coefficient, wherein c is equal to 1 or −1. Further, each Aᵢ is a single-qubit operator (2×2 matrix) which is either the 2×2 identity matrix or one of the Pauli spin matrices σₓ, σ_{y} or az. Further, the symbol “0” denotes the tensor product.

A Pauli stabilizer state (or stabilizer state for short) is a quantum state |ψ> of n qubits which is the eigenvector, with eigenvalue +1, of each operator belonging to a commuting group S consisting of 2ⁿ Pauli operators of n qubits. Thus, A|ψ>=|ψ> for every A∈S. The group S is called the stabilizer of the Pauli stabilizer state. For any given number of qubits n, there are a finite number of Pauli stabilizer states, i.e. the set of stabilizer states of n qubits has a finite cardinality. According to embodiments described herein, the input quantum state |ψᵢₙₚᵤₜ> of a quantum computation (magic state quantum computation) may lie outside of the set of Pauli stabilizer states.

A magic quantum state (or magic state for short) can be understood as a quantum state that is not a Pauli stabilizer state. A magic state can be a pure or mixed quantum state that is not a probabilistic mixture of pure Pauli stabilizer states.

A Pauli operator, as described herein, is a Hermitian operator and thus represents an observable quantity of a quantum system. A Pauli measurement can be understood as a measurement of a Pauli operator. A Pauli measurement yields, as a measurement outcome, a value equal to 1 or −1 (these values being the possible eigenvalues of any Pauli operator), wherein each of these two values may occur with a certain probability. According to embodiments described herein, a quantum computation can include a plurality of Pauli measurements, in other words a measurement of a first Pauli operator, a measurement of a second Pauli operator, and so on.

A Clifford unitary operator or operation (or Clifford operation/operator for short) is a unitary operator U of n qubits having the property that, for every Pauli operator M of n qubits, the operator U M U* is again a Pauli operator, wherein U* denotes the Hermitian conjugate of U. In other words, the set of all Pauli operators is preserved (as a set) under the action of a Clifford unitary operator. Herein, the terms “Clifford unitary operator” and “Clifford operator” will be used interchangeably.

### Description of Embodiments

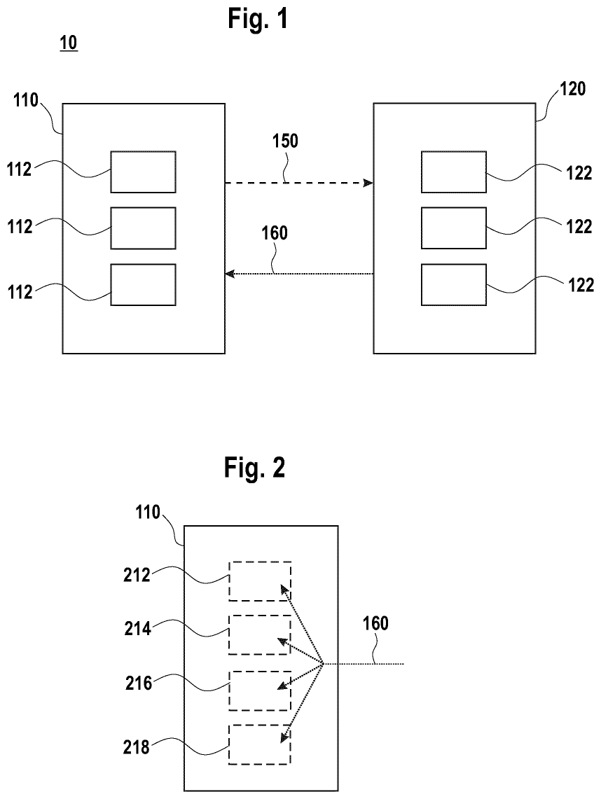

FIG. 1 shows a system 10 for simulating a quantum computation according to embodiments described herein. The system 10 includes a first system 110 and a second system 120 which may be spaced apart from each other. The first system 110 and the second system 120 may be in communication with each other so that information can be exchanged between the first system 110 and the second system 120. The first system 110 may include a transmitter for transmitting information to the second system 120. The second system 120 may include a receiver for receiving information transmitted to the second system 120 by the first system 110. The second system 120 may include a transmitter for transmitting information to the first system 110. The first system 110 may include a receiver for receiving information transmitted to the first system 110 by the second system 120.

The first system 110 may include one or more first processing units 112, e.g. one or more (non-quantum) computers. The first system 110 may be a distributed system. The one or more first processing units may be a plurality of first processing units that may be arranged at different locations and that may be coupled to each other, e.g. by wireless communication. Alternatively, the one or more first processing units 112 may be arranged in a same location. The one or more first processing units 112 may be a plurality of first processing units for performing a simulation of a quantum computation in parallel.

The first system 110 may be a classical information processing system, or classical computing system, in other words a system adapted for processing information in the form of classical information carriers, such as bits. In this context, the term “classical” is intended to distinguish from “quantum”. A classical system is distinguished from a quantum system.

According to embodiments described herein, an aim of the first system 110 may be to simulate a quantum computation. The first system 110 may aim to reproduce the output of a quantum computation, without actually carrying out the quantum computation itself, but rather by implementing a classical computational process which mimics, or simulates, the quantum computation. The quantum computation may be configured for solving a computational problem. By simulating the quantum computation, the first system 110 can compute a solution to the computational problem without physically performing the quantum computation. Performing a classical simulation has the advantage that there is no need for implementing a complex experimental set-up for physically realizing and evolving a quantum system, since a classical simulation can be executed solely with classical (i.e. non-quantum) computing systems.

A quantum computation that is simulated by the first system 110 can be any quantum computation. For example, the quantum computation can include a sequence of operations acting one after the other on an input quantum state |ψᵢₙₚᵤₜ>. The sequence of operations can include a plurality of unitary operations (or “quantum logic gates”) and/or one or more measurements. The unitary operations can be arbitrary unitary operators. Likewise, the measurements can be arbitrary measurements, i.e. measurements of arbitrary quantum observables. Other than a quantum computation involving a sequence of unitary operations and/or measurements, the quantum computation can be a quantum computation having a different form, for example an adiabatic quantum computation or any other kind of quantum computation.

A quantum computation that is simulated by the first system 110 can be a magic state quantum computation. A magic state quantum computation can be understood as a quantum computation consisting of a sequence of operations, wherein each operation is either a Clifford unitary operation or a Pauli measurement. In other words, a magic state quantum computation involves exclusively Pauli measurements and Clifford operations. A magic state quantum computation has an input quantum state |ωᵢₙₚᵤₜ> (sometimes called a “magic state”) which is not a Pauli stabilizer state. Magic state quantum computation is a universal method for quantum computation. The term “universal” means in this context that any arbitrary quantum computation outside of the paradigm of magic state quantum computation (for example a quantum computation including measurements which are not Pauli measurements and/or unitary operators which are not Clifford unitary operations, or an adiabatic quantum computation which may not include any explicit unitary logic gates at all) can be mapped to a corresponding magic state quantum computation. In addition, the resulting magic state quantum computation can be chosen such that no Clifford unitary operators are present, i.e. only Pauli measurements.

Accordingly, every computational problem that can be solved by a quantum computer in general can in fact be solved by a suitable magic state quantum computation, and even a magic state computation that involves Pauli measurements only. Further, constructive mappings from an arbitrary quantum computation to a corresponding magic state quantum computation are known. These mappings allow to explicitly design, for any given quantum computation outside of the magic state model, a suitable input quantum state (magic state) and a suitable sequence of Pauli measurements (and Clifford operations, if any) forming a magic state quantum computation, such that the output of the magic state quantum computation is the same, at least approximately, as the output of the initial quantum computation. Additionally, these mappings are efficient, i.e. have at most a polynomial overhead. Therefore, there is no loss of generality in assuming that any quantum computation simulated by the first system 110 is a magic state quantum computation involving Pauli measurements only—in the event that the quantum computation is not a magic state quantum computation of this kind, the quantum computation can, in a pre-processing phase, be re-cast as such a magic state quantum computation using one of the available mappings for doing so.

The first system 110 may determine (for example compute, estimate, retrieve from a database) a size parameter of the quantum computation, particularly the magic state quantum computation, that is to be simulated. The size parameter is a parameter, such as a number, which is characteristic of an input size of the computational problem solved by the quantum computation. For the purposes of the methods described herein, the scaling behavior of the size parameter (that is, the extent to which the size parameter increases as larger computational problems are considered) is of particular relevance. For example, if the computational problem has an input size equal to m, the size parameter may be equal to m. Yet, the disclosure is not limited thereto. Alternatively, the size parameter may be, for example, m/2, m/6 or 10 m, or more generally a·m for some coefficient a, which all have the same scaling behavior as the input size m, namely a scaling according to O(m). In some examples, the size parameter may be m² or m³ or more generally a polynomial of m, which may have a scaling behavior that is different from but still similar to the scaling behavior of the input size m—namely, the scaling behavior and the input size are related by a polynomial function. According to embodiments described herein, the size parameter depends on the input size of the computational problem solved by the quantum computation. The size parameter of the quantum computation may increase as the input size of the computational problem increases.

According to embodiments, the size parameter can be associated with, or depend on, the input quantum state |ψᵢₙₚᵤₜ> of the magic state quantum computation that is to be simulated. For example, the input quantum state |ψᵢₙₚᵤₜ> can be a state of n qubits having the form

|ψᵢₙₚᵤₜ>=|ψ₁>⊗ . . . ⊗ |ψ_{K}>⊗|ψ_{K+1}>⊗ . . . ⊗|ψ_{K+N}>.

Therein, each |ψᵢ> may be a single-qubit quantum state, so that K+N=n equals the number of qubits of the input quantum state. Further, each of the first K states |ψ₁>, . . . , |ψ_{K}> may be a Pauli stabilizer state, and each of the N remaining states |ψ_{K+1}>, . . . , |ψ_{K+N}> may not be a Pauli stabilizer state. Thus, in this example, the input quantum state |ψᵢₙₚᵤₜ> can be a tensor product of n single-qubit states consisting of K Pauli stabilizer states and N=n−K states that are not Pauli stabilizer states. For such an input quantum state, the size parameter of the quantum computation can be a function of the number N, i.e. the number of states that are not Pauli stabilizer states. For example, the size parameter may be taken to be equal to N. As described above, the scaling behavior of the size parameter, more so than its exact value, is of relevance for the present method. Accordingly, the size parameter may be set to be, for example, N/2, 21N, and the like, or more generally a function of N having a scaling that is polynomially related to N. The size parameter may increase with the number N. As the number N increases, the size parameter may increase as well.

The disclosure is not limited to the above example. The input quantum state |ψᵢₙₚᵤₜ> can have a different form. For example, the states |ψᵢ> need not be single-qubit quantum states, i.e. they can be states defined on multiple qubits. In such case, the size parameter may be a function of the number N and/or of the total number of qubits taken up by the states |ψ_{K+1}>, . . . , |ψ_{K+N}> that are not Pauli stabilizer states.

In yet another example, as described above, the quantum computation that is to be simulated may initially not be provided as a magic state quantum computation but may have a different form such as for example a sequence of unitary operations (that are not Clifford operations) followed by a final read-out measurement. In such case, the size parameter can be taken, for example, to be the number of unitary gates of the sequence, or the number of unitary gates that are not Clifford gates, or a polynomial function thereof.

It shall be understood that a quantum computation that is to be simulated, as described herein, need as such not be actually performed physically as part of the present method. Neither the first system 110 nor the second system 120, nor any other system, may physically realize an actual quantum system for performing the quantum computation in question. Indeed, one of the aims of the present disclosure is to provide a classical simulation of the quantum computation, i.e. a classical process which reproduces the output of the quantum computation, so that the actual implementation of the quantum computation as a physical process—which may require a very complex experimental set-up—can be avoided. Rather, the first system 110 may be provided with a classical description of the quantum computation that is to be simulated. A classical description of the quantum computation may have the form of classical data specifying, for example, the input quantum state and the subsequent sequence of operations (unitary operations, measurements, and the like) that make up the quantum computation. The classical description of the quantum computation can be understood as information in the form of list of instructions (which is classical information) that defines the quantum computation in question and that would allow, for example, an engineer to realize the quantum computation in practice.

Once the size parameter has been determined, the first system 110 may communicate the size parameter to the second system 120, as indicated in FIG. 1 by arrow 150. Optionally, the first system 110 may additionally communicate a classical description of the quantum computation, particularly the magic state quantum computation, that is to be simulated to the second system 120, so that the second system 120 knows which quantum computation is to be simulated. Alternatively, the first system 110 may at least send a classical description of the input quantum state |ψᵢₙₚᵤₜ> to the second system 120, so that the second system 120 at least knows on which input quantum state the quantum computation acts, without possibly sending any further information regarding the quantum computation to the second system 120. In other embodiments, the first system 110 may send only the size parameter to the second system 120, i.e. without sending any other information regarding the quantum computation to the second system 120.

The second system 120 may include one or more second processing units 122. The second system 120 may be a distributed system. The one or more second processing units 122 may be a plurality of second processing units that may be arranged at different locations and that may be coupled to each other, e.g. by wireless communication. Alternatively, the one or more second processing units 122 may be arranged in a same location.

Like the first system 110, the second system 120 may be a classical information processing system, or classical computing system, i.e. a system configured for processing information based on classical information carriers such as classical bits. Alternatively, the second system 120 may be a quantum information processing system, or a quantum computing system. The second system 120 may include a physical quantum system and devices (such as measurement devices, lasers, and the like) configured for physical interacting with the quantum system to perform quantum computing. As a further alternative, the second system 120 may be a hybrid system including both a classical system and a quantum system.

The second system 120 may be configured for determining a computational key based on the size parameter of the quantum computation transmitted by the first system 110. The computational key may be based on a representation of the input quantum state |ψᵢₙₚᵤₜ> of the quantum computation as a probability distribution Pᵢₙₚᵤₜ, as described in the following.

A convex operator set Δ is considered, wherein the set Δ consists of all Hermitian n-qubit operators X for which the condition

Tr(X)=1 and Tr(|σ><σ|X)≥0

holds for all n-qubit Pauli stabilizer states |σ>. Therein, the number n may be the number of qubits of the input quantum state |ψᵢₙₚᵤₜ>. In cases where it is beneficial to highlight the number of qubits n, the set Δ will be denoted as Δ(n) or Δn.

That the set Δ is comprised of n-qubit operators does not imply that the operators in question are actually realized as physical operations acting on a physical quantum system. The set Δ can be understood as a mathematical set, i.e. as classical information. The terminology “n-qubit operator” is used for the sake of brevity but, in the context of the set Δ, an n-qubit operator can be understood as a mathematical object, namely a matrix having dimensions 2ⁿ×2ⁿ, where n is the number of qubits associated with the quantum computation that is to be simulated.

The set Δ, being a convex set, has several extreme points A_{α} (and in the case of the set Δ, the number of extreme points is finite). An extreme point A_{α} can also be called a “vertex”. The input quantum state |ψᵢₙₚᵤₜ> of a quantum computation may be represented as a probability distribution Pᵢₙₚᵤₜ (the probability distribution Pᵢₙₚᵤₜ is also denoted herein by p_{ρ}). The probability distribution Pᵢₙₚᵤₜ is a probability distribution over a plurality of extreme points of the convex operator set Δ. The probability distribution Pᵢₙₚᵤₜ may be a probability distribution over the entire set of extreme points of the set Δ, so that the probability distribution Pᵢₙₚᵤₜ assigns a probability p(α) to each extreme point A_{α} of the set Δ (where the sum of all probabilities p(α) with A_{α} ranging over all extreme points of A is equal to 1). In such case, the probability distribution Pᵢₙₚᵤₜ may form an exact representation of the input quantum state. Alternatively, the probability distribution Pᵢₙₚᵤₜ may be a probability distribution over a subset of extreme points of the set Δ, so that a probability p(α) is only assigned to each extreme point A_{α} in the subset in question (where the sum of all probabilities p(α) with A_{α} ranging over all extreme points in the subset is equal to 1). In such case, the probability distribution Pᵢₙₚᵤₜ may form an approximate representation of the input quantum state.

The inventors have found that an arbitrary quantum state, and hence an arbitrary input quantum state |ψᵢₙₚᵤₜ> as described herein, is representable as a probability distribution over the convex operator set Δ (technical details including a mathematical proof of this statement as found by the inventors, are provided further below—see the section “Detailed technical discussion and mathematical proofs”). The second system 120 may determine the probability distribution Pᵢₙₚᵤₜ representing the input quantum state |ψᵢₙₚᵤₜ>, for example based on a classical description of the input quantum state |ψᵢₙₚᵤₜ> that was transmitted to the second system 120 by the first system 110, or at least based on the size parameter.

Determining the probability distribution Pᵢₙₚᵤₜ may include computing or estimating each of the individual probabilities p(α) of the probability distribution Pᵢₙₚᵤₜ. In some embodiments, the probability distribution Pᵢₙₚᵤₜ may be determined using a linear programming algorithm. Technical details thereof are provided further below (see the section “Detailed technical discussion and mathematical proofs”). In other embodiments, a quantum computation may be performed to compute the probability distribution Pᵢₙₚᵤₜ.

The second system 120 may determine, based on the size parameter of the quantum computation that is to be simulated, and particularly based on the determined probability distribution Pᵢₙₚᵤₜ, the computational key.

A computational key as described herein may include or consist of classical information. The computational key may contain information allowing the first system 110 to obtain at least one sample of the probability distribution Pᵢₙₚᵤₜ.

According to some embodiments, the computational key may include at least one sample of the probability distribution Pᵢₙₚᵤₜ. A sample, or random sample, of the probability distribution Pᵢₙₚᵤₜ, as described herein, can be understood as an extreme point A_{α} of the convex operator set Δ which is generated according to a probabilistic process as defined by the probability distribution Pᵢₙₚᵤₜ. In other words, sampling the probability distribution Pᵢₙₚᵤₜ may include performing a probabilistic process (or random process) wherein an extreme point A_{α} is randomly selected, such that the probability that the extreme point A_{α} is selected is equal to p(α) i.e. the probability assigned to the extreme point A_{α} by the probability distribution Pᵢₙₚᵤₜ. In this respect, it shall be understood that a sampling operation or process as described herein need not generate an actual extreme point A_{α} but may, equivalently, generate a classical description (or description for short) of the extreme point. For example, the sample may generate the index a rather than the actual extreme point A_{α}. In order not to overload the terminology, the present disclosure will sometimes use formulations like “the sample generates, as an output of the sample, an extreme point . . . ”. Such formulations can be understood as including situations in which a description of the extreme point, rather than the extreme point itself, is generated by the sample.

According to some embodiments, the computational key may include a plurality of samples of the probability distribution Pᵢₙₚᵤₜ, for example 5, 10, 100 or more samples. The plurality of samples may include a plurality of extreme points A_{α1}, A_{α2}, A_{α3}, . . . where each extreme point A_{α}_{ᵢ} has been randomly selected with probability p(αᵢ).

That the computational key contains information allowing a system such as the first system 110 to obtain at least one sample of the probability distribution Pᵢₙₚᵤₜ need not imply that the computational key necessarily includes any samples of the probability distribution Pᵢₙₚᵤₜ. The computational key may include information allowing a user or system (such as the first system) to generate one or more samples of probability distribution Pᵢₙₚᵤₜ. For example, the computational key may include a list of instructions (e.g. in the form of a (randomized) algorithm) which allow a user or system themselves to sample the probability distribution Pᵢₙₚᵤₜ. Such a computational key can allow the user or system to generate a plurality of samples, i.e. extreme points A_{α1}, A_{α2}, A_{α3}, . . . where each extreme point A_{α}_{ᵢ} is randomly selected with probability p(αᵢ).

The computational key depends on the probability distribution Pᵢₙₚᵤₜ and hence on the input quantum state |ψᵢₙₚᵤₜ>. The computational key may not depend on the sequence of operations that are to be performed on the input quantum state |ψᵢₙₚᵤₜ> in the quantum computation. Particularly, taking the quantum computation to be a magic state quantum computation, the computational key may not depend on the Pauli measurements and/or Clifford unitary operations of the quantum computation. In this sense, the computational key may depend only on the input quantum state |ψᵢₙₚᵤₜ>.

Determining the computational key may be a computationally hard task, meaning that an algorithm used by the second system 120 for computing the computational key may have a long running time. However, since the computational key is based on the input quantum state only, i.e. does not depend on the sequence of operations (Pauli measurements, Clifford unitary operations) that are performed in the quantum computation that is to be simulated, the computational key has to be computed only once, and can thereafter be re-used arbitrary many times for any other quantum computation having the same input quantum state |ψᵢₙₚᵤₜ>, irrespective of which specific sequence of operations is included in the quantum computation in question.

The second system 120 may communicate, or transmit, the computational key to the first system 110, as indicated in FIG. 1 by arrow 160. The first system 110 may use the computational key for simulating the quantum computation, as described in the following.

As described above, without loss of generality, a quantum computation that is to be simulated can be taken to be a magic state quantum computation involving Pauli measurements only, i.e. not including any Clifford unitary operations (if the initial quantum computation as of a different kind, the quantum computation can be (efficiently) mapped to a magic state quantum computation which solves the same computational problem and which at most has a polynomial increase in the length of the computation, while not including any Clifford unitary operations). The inventors have found that Pauli measurements can be represented as probabilistic processes acting on the extreme points of the convex operator set Δ. When a Pauli measurement is performed on a quantum state, the measurement results in one of two possible measurement outcomes, which may be represented as, for example, 0 and 1 (or, equivalently, 1 and −1, and the like). Each measurement outcome occurs with a certain probability. Further, a measurement causes the initial quantum state (the “pre-measurement” quantum state) to change (except when the quantum state is an eigenstate of the Pauli operator which is being measured). The quantum state obtained after the measurement (the “post-measurement” quantum state) is one of two quantum states, a first quantum state being associated with the measurement outcome 0 and a second quantum state being associated with the measurement outcome 1. As described above, any quantum state can be represented as a probability distribution over the convex operator set Δ. The inventors have further found (technical details are provided further below—see the section “Detailed technical discussion and mathematical proofs”) that a Pauli measurement can be represented, i.e. modelled, as a probabilistic process (sampling process) which takes, as an input, (a description of) an extreme point of the convex operator set Δ, particularly an extreme point which results from sampling the probability distribution representing the quantum state on which the Pauli measurement acts. Further, the probabilistic process involves sampling from a probability distribution which outputs (i) a value 0 or 1 (or equivalently, 1 or −1, and the like) corresponding to the possible measurement outcomes of the Pauli measurement, and (ii) another (description of an) extreme point of the convex operator set Δ. The outputted value 0 or 1 is referred to herein as a simulated measurement outcome. The probabilities with which the values 0 and 1 occur in the probabilistic process modeling the Pauli measurement are equal to the probabilities with which the values 0 and 1 would occur in the Pauli measurement. Therefore, the probabilistic process can be used to perform a classical simulation of the Pauli measurement in question. Further, if the Pauli measurement is a first Pauli measurement, and if the quantum computation includes a second Pauli measurement after the first Pauli measurement, then this second Pauli measurement can likewise be modeled as a second probabilistic process which takes, as an input, the (description of the) extreme point that was outputted by the probabilistic process representing the first Pauli measurement (see item (ii) above), and which involves sampling from a second probability distribution which outputs (i′) a simulated measurement outcome corresponding to the possible measurement outcomes of the second Pauli measurement, and (ii′) a further extreme point of the convex operator set Δ.

An advantage of the representation of quantum states and Pauli measurements by probability distributions is that in the latter processes no negative values occur. In other approaches (such as approaches using phase space representations and/or Wigner functions), a recurring problem is that the methods in question involve negative values when modelling quantum states and measurements. Such negative values are known to cause a slowdown in classical simulation methods, since a representation as probability distributions requires all values to be positive. In comparison, the representation of quantum states and Pauli measurements in terms of the convex operator set Δ according to the present disclosure involves nonnegative values only, in other words both the quantum states and the Pauli measurements can be represented as genuine probability distributions.

In light of the above, the first system 110 may use the computational key for simulating the magic state quantum computation. As described above, the computational key may include a sample of the probability distribution Pᵢₙₚᵤₜ representing the input quantum state |ψᵢₙₚᵤₜ>, or may at least contain information allowing the first system 110 to provide a sample of the probability distribution Pᵢₙₚᵤₜ. The sample yields, as an output of the sample, an extreme point of the convex operator set Δ. The sequence of Pauli measurements of the magic state quantum computation can be simulated by the first system 110 without needing any further information or assistance from the second system 120. Each Pauli measurement can be simulated by the first system 110 by performing the probabilistic process representing the Pauli measurement in question, as described above. A first probabilistic process, which represents a first Pauli measurement of the quantum computation, takes as an input the extreme point of the convex operator set Δ that was generated by sampling from the probability distribution Pᵢₙₚᵤₜ. Further, the first probabilistic process includes sampling a probability distribution P₁ which outputs a simulated measurement outcome (e.g. 0 or 1) representing a measurement outcome of the first Pauli measurement as well as a further extreme point of the convex operator set Δ. A second probabilistic process, which represents a second Pauli measurement of the quantum computation may have, as an input, the extreme point outputted by the first probabilistic process, and may involve sampling from a second probability distribution P₂ which outputs a respective simulated measurement outcome as well as a further extreme point. Likewise, each subsequent probabilistic process representing a further Pauli measurement of the quantum computation may have, as an input, the extreme point outputted by the previous probabilistic process, and may output a respective simulated measurement outcome as well as a further extreme point. Particularly, where the magic state quantum computation includes one or more Pauli measurements providing a read-out of the quantum computation, also those measurements can likewise be simulated by a probabilistic process as described above. In this way, a classical simulation of the magic state quantum computation can be performed by the first system 110 using the computational key. Since the probabilities with which the simulated measurement outcomes are outputted by the probabilistic processes are equal to the measurement probabilities of the corresponding Pauli measurements, the classical simulation can reproduce the output(s) of the quantum computation. A classical simulation of the magic state quantum computation based on the computational key is provided by the first system 110. Particularly, by virtue of the classical simulation, a solution to the computational problem can be determined by the first system 110.

In some cases, in order to determine a solution to the computational problem, the magic state quantum computation may have to be repeated several times (particularly when the output of the magic state quantum computation is provided probabilistically, i.e. non-deterministically). In such cases, the above-described procedure for simulating the quantum computation may be repeated several times. Each subsequent simulation starts out from a new sample of the probability distribution Pᵢₙₚᵤₜ (as described above, the computational key may include a plurality of samples of said distribution, or may include information allowing a plurality of such samples to be provided). Based on the sample in question, the simulation procedure as described above is carried out. Accordingly, repeated runs of the quantum computation can be simulated based on the computational key.

As described above, magic state quantum computation, even when involving Pauli measurements only, is a universal method for quantum computation, so that any arbitrary quantum computation outside of the paradigm of magic state quantum computation can be (efficiently) mapped to a corresponding magic state quantum computation. Accordingly, every computational problem that can be solved by a quantum computer in general can in fact be solved within the paradigm of magic state quantum computation. Yet further, as regards the input quantum state |ψᵢₙₚᵤₜ>, a specific type of input quantum state can be considered, while maintaining universality. For example, the input quantum state can have the form

|ψᵢₙₚᵤₜ>=|ψ₁>⊗ . . . ⊗|ψ_{K}>⊗|ψ_{K+1}>⊗ . . . ⊗|ψ_{K+N}>,

wherein each of the K first states is equal to the basis state |0>, in other words, |ψ₁>= . . . =|ψ_{K}>=|₀>. The quantum state |0> is a Pauli stabilizer state. Further, each of the N second states is equal to a fixed single-qubit state |T>, i.e. |ψ_{K+1}>= . . . =|ψ_{K+N}>=|T>. The quantum state |T>(magic state) is not a Pauli stabilizer state. For example, the state |T> may be equal to

|T>=(|0>+exp(iπ/4)|1>)√2.

The subclass of magic state quantum computations which have, as in input quantum state, a state of the form |ψᵢₙₚᵤₜ>=|0>⊗ . . . ⊗ |0>⊗ |T>⊗ . . . ⊗ |T>, and where only Pauli measurements are performed, are referred to herein as magic state quantum computations in standard form. The class of magic state quantum computations which are in standard form is capable of universal quantum computation. This means that, if a quantum computation that is to be simulated by the first system 110 (or any other system) falls outside this subclass of magic state quantum computations, then the quantum computation in question can be efficiently (i.e. with at most polynomial overhead) mapped to a magic state quantum computation in standard form, so that the resulting magic state quantum computation solves the same computational problem as the initial quantum computation. Thus, instead of simulating the initial quantum computation directly, the magic state quantum computation in standard form can be simulated.

Within the class of magic state quantum computations in standard form acting on a given number of qubits, the only variable parameter of the input quantum state may be the number N of states |T> which occur in the input quantum state |ψᵢₙₚᵤₜ>. Accordingly, the number N may be the only parameter of the input quantum state which may depend on the computational problem that is solved by the quantum computation in question. All other aspects of the input quantum state may be constant, i.e. independent of the specific computational problem under consideration.

In a magic state quantum computation in standard form, the number N of states |T> which occur in the above decomposition of the input quantum state may be determined by the input size of the computational problem. The input quantum state |ψᵢₙₚᵤₜ> may only depend on the input size of the computational problem, and may not depend on any remaining information characterizing the computational problem. Such remaining information may all be encoded into the sequence of Pauli measurements performed during the magic state quantum computation. For example, if the computational problem involves determining the prime factorization of an m-bit integer, the number N may be determined by the length m of the integer. The remaining information characterizing which m-bit integer is to be factorized—in other words the actual bits (or digits) of the m-bit integer—may be encoded in the sequence of Pauli measurements that make up the quantum computation. The input quantum state may not depend on such remaining information.

As described above, the input quantum state |ψᵢₙₚᵤₜ> may be represented by the probability distribution Pᵢₙₚᵤₜ. Since, in a magic state quantum computation in standard form, the input quantum state |ψᵢₙₚᵤₜ> may only depend on the input size of the computational problem, also the probability distribution Pᵢₙₚᵤₜ may only depend on the input size of the computational problem, and not on any remaining information characterizing the computational problem. Further, as described above, the computational key provided by the second system 120 is configured for allowing the first system 110 (or any other system) to obtain a sample of the probability distribution Pᵢₙₚᵤₜ. Accordingly, the computational key may also depend only on the input size of the computational problem. For example, in the example described above, the computational key may depend on the length m of the integer to be factorized but not on the actual bits of the integer in question.

In light of the above, the computational key may depend only on the input size of the computational problem. Accordingly, since the size parameter as described herein is a parameter which is characteristic of the input size of the computational problem, the computational key may depend only on the size parameter of the quantum computation that is to be simulated. If two different magic state quantum computations solve two respective computational problems having the same input size (or, likewise, the size parameters of both quantum computations are the same), then the two quantum computations may have the same input quantum state |ψᵢₙₚᵤₜ>=|0>⊗ . . . ⊗|0>⊗ |T>⊗ . . . ⊗ |T> (with the same number N of states |T>) and, hence, the computational key may be the same computational key for both quantum computations. Accordingly, the same computational key can be re-used for simulating a plurality of quantum computations. For example, the same computational key can be used for factoring all m-bit integers having a fixed length m.

More generally, if a computational key is issued by the second system 120 for solving a computational problem having a first input size (or, in other words, for simulating a quantum computation having a first size parameter), then the same computational key can be used for solving any computational problem having an input size which is smaller than or equal to the first input size (or for simulating any quantum computation having a size parameter which is smaller than or equal to the first size parameter). This is because a computational problem having an input size m′ can be regarded as an instance of a computational problem having a larger input size m>m′. For example, an m′-bit integer can be regarded as an m-bit integer where the first m-m′ bits are zero. Accordingly, the same computational key can be used for factoring all m′-bit integers having a length m′ which is smaller than or equal to a fixed length m.

It shall be understood that, in the above discussion, the specific form of the state |T> shown above is one example and the disclosure shall not be limited thereto. The state |T> can in fact be any fixed single-qubit state which is not a Pauli stabilizer state, and the resulting class of magic state quantum computations will also be capable of universal quantum computation. Likewise, the state |0> in the decomposition of the input quantum state can be replaced by any Pauli stabilizer state. In another example, the input quantum state need not be a tensor product of single qubit state. For example, the input quantum state may be a tensor product of k-qubit states (where k=2, 3, 4, . . . ), wherein part of the states are copies of a fixed k-qubit Pauli stabilizer state and the remaining part are copies of fixed k-qubit state which is not a Pauli stabilizer state. In any of these variations, the capability of performing universal quantum computation is also maintained.

In light of the above, the first system 110 (or any other system) may perform, based on the computational key, a simulation of a first quantum computation having a first size parameter. Further, the first system 110 may perform, based on the same computational key, a simulation of a plurality of quantum computations, wherein each quantum computation of the plurality of quantum computations has a size parameter which is equal to or less than the size parameter of the first quantum computation.

FIG. 2 shows the computational key being received by the first system 110 from the second system (not shown), as indicated by the arrow 160. The computational key may be used by the first system 110 (for example by the one or more first processing units, which are not shown in FIG. 2 for ease of presentation) for simulating a first quantum computation 212. The same computational key may be used by the first system 110 for simulating a second quantum computation 214 and/or a plurality of further quantum computations 216, 218, wherein the size parameter of the second quantum computation 214 and the size parameter of the further quantum computations 216, 218 is smaller than or equal to the size parameter of the first quantum computation 212.

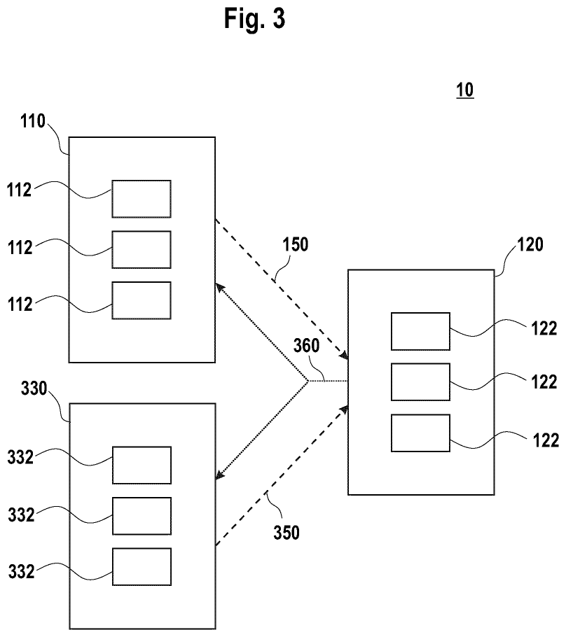

The plurality of quantum computations that may be simulated based on a same computational key, as described above, need not all be simulated by a same system such as the first system 110. The second system 120 can transmit the computational key to the first system 110 for simulating a first quantum computation and can transmit the same computational key to a third quantum system for simulating a second quantum computation, as illustrated in FIG. 3.

FIG. 3 shows a system 10 for simulating a quantum computation according to embodiments described herein. The system 10 includes a first system 110 and a second system 120 as described herein. The system 10 includes a third system 330 which may be spaced apart from the first system 110 and/or from the second system 120. The third system 330 may include one or more third processing units 332, e.g. one or more classical (i.e. non-quantum) computers. The third system 330 may be a classical information processing system, like the first system 110. The third system 330 and the second system 120 may be in communication with each other so that information can be exchanged between the third system 330 and the second system 120. The third system 330 may include a transmitter for transmitting information to the second system 120. The third system 330 may include a receiver for receiving information transmitted to the third system 330 by the second system 120.

An aim of the first system 110 may be to simulate a first quantum computation. The first quantum computation may be configured for solving a first computational problem. The first quantum computation may have a first size parameter. The first system 110 may transmit the first size parameter to the second system 120, as indicated by the arrow 150. The second system 120 may transmit a computational key to the first system 110, as indicated by the arrow 360, the computational key being based on the first size parameter. Using the computational key, the first system 110 may perform a classical simulation of the first quantum computation, as described herein.

An aim of the third system 330 may be to simulate a second quantum computation. The second quantum computation may be configured for solving a second computational problem. The second quantum computation may have a second size parameter which may be equal to or smaller than the first size parameter of the first quantum computation. The third system 330 may transmit the second size parameter to the second system 120, as indicated by the arrow 350. The second system 120 may transmit the computational key (i.e. the same computational key that was transmitted to the first system 110) to the third system 330, as indicated by the arrow 360. Using the computational key, the third system 330 may perform a classical simulation of the second quantum computation.

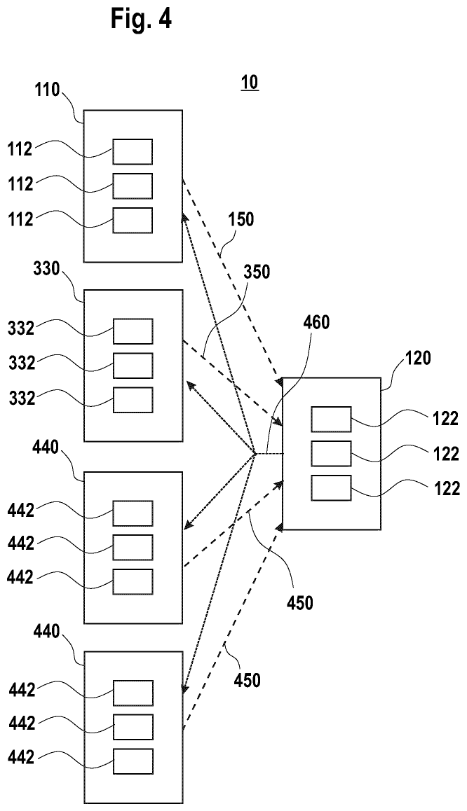

As illustrated in FIG. 4, the system 10 may include a one or more further systems 440. Each system 440 may be a classical information processing system including one or more processing units 442, similar to the first system 110. Each system 440 may wish to simulate a respective quantum computation having a respective size parameter which is smaller than or equal to the first size parameter of the first quantum computation that is simulated by the first system 110. Each system 440 may transmit the respective size parameter to the second system 120, as indicated by the arrows 450. The second system 120 may send the computational key, i.e. the same computational key that is sent to the first system 110 and the third system 330, to each of the systems 440, as indicated by the arrow 460. Using the computational key, each system 440 may perform a classical simulation of the respective quantum computation.

The second system 120 as described herein may store the computational key. When the second system receives a size parameter of a quantum computation such that the stored computational key is suitable for simulating the quantum computation in question, the computational key may be transmitted to the respective system by the second system 120.

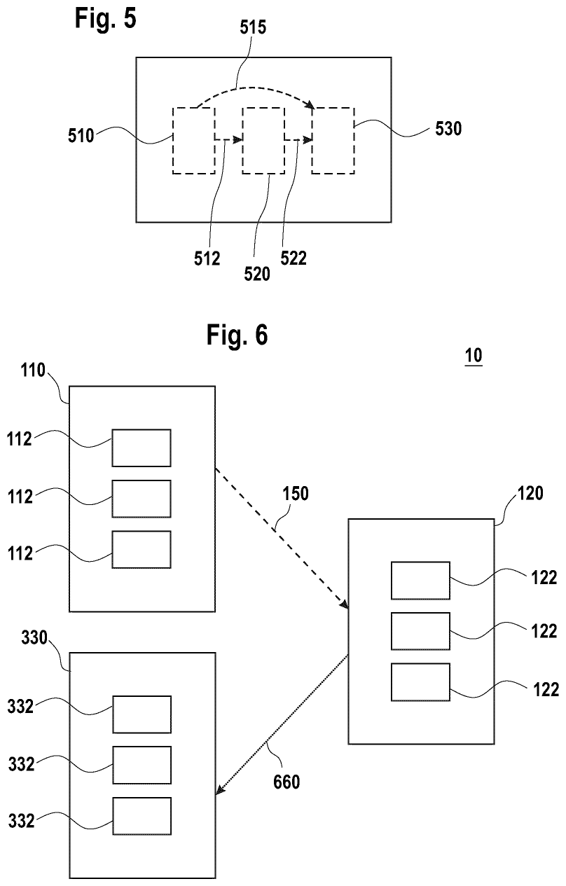

FIG. 5 illustrates a mapping from an arbitrary quantum computation to a magic state quantum computation in standard form. Quantum computation 510 need not be a magic state quantum computation. The quantum computation 510 may include unitary operations which are not Clifford operations, measurements which are not Pauli measurements, may be an adiabatic quantum computation, and the like. Given a description of the quantum computation 510, a description of a magic state quantum computation 520 can be determined efficiently, i.e. in polynomial time (using a classical computing system), as indicated by arrow 512. The magic state quantum computation 520 may have a size (number of operations) which is at most polynomially larger than the size of the quantum computation 510. Further, the magic state quantum computation 520 may solve the same computational problem, at least approximately, as the quantum computation 510. In other words, the quantum computation 510 and the magic state quantum computation 520 may be computationally equivalent. Likewise, given the description of the magic state computation 520, a description of a magic state computation 530 in standard form can be efficiently computed, as indicated by arrow 522, wherein the magic state computations 520 and 530 are also computationally equivalent (i.e. the solve the same computational problems and their sizes are polynomially related).

Alternatively, the description of the magic state quantum computation 530 in standard form can be computed directly from the description of the quantum computation 510, as indicated by the arrow 515. The intermediate mapping indicated by arrows 512 and 522 can be omitted. If the quantum computation 510 is already a magic state quantum computation, or even a magic state quantum computation in standards form, the mappings in question may not be needed.

The size parameter of the quantum computation 510, the magic state quantum computation 520 and the magic state quantum computation 530 may be the same size parameter. For example, the size parameter may be set to be equal to the number N of states |T> in the decomposition of the input quantum state of the quantum computation 530 in standard form. As described above, the disclosure is not limited thereto. The size parameter may be equal to a different quantity, as illustrated in the examples above.

In a further variation, the first system 110 may transmit the size parameter of a quantum computation to the second system 120 and, instead of transmitting the computational key to the first system 110, the second system 120 may transmit the computational key to another system different from the first system 110, such as for example the third system 330. This is illustrated in FIG. 6.

FIG. 6 shows a system 10 for simulating a quantum computation according to embodiments described herein. The system 10 includes a first system 110, a second system 120 and a third system 330 as described herein. The first system 110 may communicate a size parameter of a quantum computation to the second system 120, as indicated by arrow 150. The second system 120 may determine a computational key based on the size parameter. The second system 120 may transmit the computational key to the third system 330, as indicated by arrow 660. Based on the computational key, the third system 330 may perform a classical simulation of the quantum computation.

A probability distribution, such as P₁, P₂, or Pᵢ as described herein that is configured for simulating a measurement, may be a product distribution being a product of several probability distributions. Providing a sample of the probability distribution P₁, P₂, or Pᵢ may include providing a sample of each of the probability distributions in the product. For example, a probability distribution, such as P₁, P₂, or Pᵢ, may be a product of two probability distributions. A first probability distribution in the product may assign a probability to each simulated measurement outcome. A second probability distribution in the product may assign a probability to each of a plurality of extreme points of a convex operator set as described herein. Sampling the first probability distribution may yield, as an outcome of the sample, a simulated measurement outcome as described herein. Sampling the second probability distribution may yield, as an outcome of the sample, an extreme point of the convex operator set.

As described herein, based on the computational key, the first system 110 (or the third system 330, or any other system) may perform a simulation of a magic state quantum computation, wherein each Pauli measurement of the magic state quantum computation may be simulated by sampling from a probability distribution associated with the set Δ. Therein, Δ=Δ(n) is a convex operator set including a class of n-qubit operators as defined above, wherein n is the number of qubits of the input quantum state (i.e. the number of qubits on which the magic state quantum computation acts). According to embodiments, instead of sampling from a plurality of probability distributions each associated with the same set Δ(n), a classical simulation may also be performed by sampling from probability distributions which are associated with respective sets Δ(n₁), Δ(n₂), Δ(n₃), and so on, involving different numbers of qubits. For each i, the convex operator set Δ(nᵢ) may consist of all Hermitian nᵢ-qubit operators X such that Tr (X)=1 and Tr (|σ><σ|X)≥0 for all nᵢ-qubit Pauli stabilizer states |σ>. The number of qubits n₁ associated with the first of these sets, namely Δ(n₁), may be equal to the number of qubits n of the input quantum state, i.e. the number of qubits n of the set Δ=Δ(n) associated with the probability distribution Pᵢₙₚᵤₜ, or may be smaller than the number n. The number of qubits nᵢ associated with the respective sets Δ(nᵢ) may be decreasing, namely n₁>n₂>n₃> . . . . The first Pauli measurement of the magic state quantum computation may be simulated by sampling from a first probability distribution P₁, wherein the sampling yields, as an outcome, a first simulated measurement outcome (e.g. a value 0 or 1) and an extreme point of the set Δ(n₁). A second Pauli measurement, which is to be performed after the first Pauli measurement in the magic state quantum computation, may be simulated by sampling from a second probability distribution P₂, wherein the sampling yields a second simulated measurement outcome and an extreme point of the set Δ(n₂) where n₁>n₂. Between the first Pauli measurement and the second Pauli measurement, further Pauli measurements may be included in the magic state quantum computation, each of which may be simulated by sampling a probability distribution associated with the set Δ(n₁), so that the above-described second Pauli measurement may be the first one where the number of qubits associated with the convex operator set in question decreases. Continuing in this manner, a third Pauli measurement, which is performed after the second Pauli measurement in the magic state quantum computation (where the third Pauli measurement may or may not directly follow the second Pauli measurement), may be simulated by sampling from a third probability distribution P₃, wherein the sampling yields, as an outcome, a third simulated measurement outcome and an extreme point of the set Δ(n₃) where n₂>n₃. The simulation may continue in this manner, in other words the simulation of the subsequent Pauli measurements may involve sampling from respective probability distributions Pᵢ associated with the respective sets Δ(nᵢ), wherein the number of qubits associated with the respective sets Δ(nᵢ) may be decreasing.

In some embodiments, the following approach may be taken to transition from a convex operator set Δ(nᵢ) associated with nᵢ qubits to a convex operator set Δ(nᵢ₊₁) associated with nᵢ₊₁ qubits, wherein nᵢ₊₁ is smaller than nᵢ. As described herein, a sample of a probability distribution Pᵢ may be provided in order to simulate a (Pauli) measurement of the magic state quantum computation, wherein the sample yields a simulated measurement outcome and an extreme point of the convex operator set Δ(nᵢ). According to embodiments, it may be determined whether the extreme point of the set Δ(nᵢ) obtained by sampling the probability distribution Pᵢ has a certain specific form, namely the form U A_{α} ⊗ πU*, wherein U is a unitary Clifford operator, π is a Pauli projector of n−m qubits and A_{α} is an extreme point of a convex operator set Δ(m) of m-qubit operators, wherein m is smaller than nᵢ. The convex operator set Δ(m) may consist of all Hermitian m-qubit operators X such that Tr (X)=1 and Tr (|σ><σ|X)≥0 for all m-qubit Pauli stabilizer states |σ>. A Pauli projector can be understood as a projector (orthogonal projector operator) on an eigenspace of a Pauli operator. If A is a Pauli operator, then the operators (I+A)/2 and (I−A)/2 are Pauli projectors on the +1 and −1 eigenspaces, respectively, of the Pauli operator A. If the extreme point obtained by sampling the probability distribution Pᵢ is determined to have the form U A_{α} ⊗ π U* (called herein a composite vertex) the simulation of the quantum computation may proceed based on the convex operator set Δ(m) instead of the preceding set Δ(nᵢ), and we may set nᵢ₊₁ to be equal to the number m, so that Δ(nᵢ₊₁)=Δ(m). The convex operator set Δ(nᵢ₊₁)=Δ(m) is associated with a number of qubits m which is smaller than the number of qubits nᵢ associated with the set Δ(nᵢ). The next measurement of the quantum computation may be simulated by providing a sample of a probability distribution Pᵢ₊₁ associated with the set Δ(nᵢ₊₁). The sample of the probability distribution Pᵢ₊₁ may yield, as an outcome of the sample, an extreme point of the convex operator set Δ(nᵢ₊₁) and a simulated measurement outcome of the measurement in question. This approach may be continued for the whole simulation: whenever an extreme point of a respective convex operator set is provided as an outcome of a sampling process, it may be determined whether the extreme point in question is a composite vertex in the sense described above and, if yes, the convex operator set can be reduced in terms of the number of qubits involved, in the manner described above.

In light of the above, a quantum computation that is to be simulated (in particular a magic state quantum computation) may include, or consist of, a plurality of Pauli measurements M₁, M₂ . . . M_{T}, wherein T may be 5 or larger, 10 or larger, or 100 or larger. For each i, the (i+1)-th measurement Mᵢ₊₁ may be configured to be performed after the i-th measurement M. Each i-th measurement M may be representable as a probability distribution P. A simulation of the quantum computation may include, for each i-th measurement M, providing a sample of the probability distribution P. The sample may yield, as an outcome of the sample, an extreme point of the convex operator set Δ(nᵢ) and a simulated measurement outcome of the i-th measurement M. For each i, the number of qubits nᵢ₊₁ associated with the convex operator set Δ(nᵢ₊₁) relating to the (i+1)-th measurement Mᵢ₊₁ may be equal to or smaller than, particularly smaller than, the number of qubits nᵢ associated with the convex operator set Δ(nᵢ) relating to the i-th measurement M. The technical details as to how the probability distributions Pᵢ may be constructed are provided further below (see the section “Detailed technical discussion and mathematical proofs”).

When performing a simulation of a quantum computation in the manner described above, namely by sampling from probability distributions that are associated with a decreasing sequence of qubit numbers n₁>n₂>n₃> . . . , eventually a probability distribution may be encountered which is associated with 2 qubits. That is, for a certain i, we may have nᵢ=2. Sampling from the probability distribution in question yields, as an outcome of the sample, an extreme point of the convex operator set Δ(2) and a simulated measurement outcome. The inventors have found a characterization of the extreme points of the set Δ(2) in terms of a graphical description. Namely, every extreme point of the set Δ(2) can be represented as a graph having a full perrank. Vice versa, a family of graphs [symbol] (S) can be identified (namely certain graphs that are obtained from value assignments on maximal isotropic subspaces), such that every graph [symbol] (S) with full perrank corresponds to an extreme point of the set Δ(2). Using this representation of the extreme points of the set Δ(2) as graphs of full perrank, providing a sample of the probability distribution associated with the set Δ(2) can be facilitated. The technical details of this graph-theoretic characterization are provided further below (see the section “Detailed technical discussion and mathematical proofs”).

Particularly, using the graph-theoretic characterization, a list of extreme points of the set Δ(2) can be provided. The list in question is provided further below in Appendix B. The set of all extreme points of Δ(2) can be partitioned into a set of orbits under the action of the Clifford group (i.e. the group consisting of all Clifford unitary operators on two qubits). Any two extreme points belonging to a same orbit are related to each other by a Clifford unitary operation. The list in appendix B provides a representative extreme point for each such orbit. Using the list in question, providing a sample of the probability distribution associated with the set Δ(2) can be facilitated.

According to an embodiment (as illustrated for example in FIG. 1), a method of simulating a quantum computation is provided. The method includes determining, by a first system (such as first system 110) including one or more first processing units, a size parameter of a quantum computation. The quantum computation is configured for solving a computational problem. The size parameter is characteristic of an input size of the computational problem. The method includes communicating, by the first system, the size parameter to a second system (such as second system 120) including one or more second processing units. The method includes communicating, by the second system, a computational key to the first system, wherein the computational key is based on the size parameter of the quantum computation. The method includes performing, by the first system, a simulation of the quantum computation based on the computational key.

The first system may include a transmitter for communicating the size parameter to the second system. The second system may include a transmitter for communicating the computational key to the first system. The simulation of the quantum computation may be performed by the one or more first processing units of the first system.

Performing the simulation of the quantum computation based on the computational key may include computing a solution to the computational problem based on the computational key. The solution may be an approximate solution or an exact solution to the computational problem.

A quantum computation simulated by the first system may be a first quantum computation. The method may include performing, by the first system (for example by the one or more first processing units), a simulation of a second quantum computation based on the computational key, i.e. the same computational key as used for simulating the first quantum computation. The second quantum computation may be different from the first quantum computation. The second quantum computation may have a size parameter which is equal to or less than the size parameter of the first quantum computation. The second quantum computation may be configured to solve a second computational problem different from the first computational problem. Performing a simulation of the second quantum computation based on the computational key may include computing a solution to the second computational problem based on the computational key.

A quantum computation simulated by the first system may be a first quantum computation. The method may include communicating, by a third system (such as third system 330), a size parameter of a second quantum computation to the second system. The size parameter may be transmitted by a transmitter of the third system. The second quantum computation may be different from the first quantum computation. The size parameter of the second quantum computation may be equal to or less than the size parameter of the first quantum computation. The method may include communicating, by the second system (for example by a transmitter of the second system), the computational key to the third system, i.e. the same computational key as used for simulating the first quantum computation. The method may include performing, by the third system (for example by one or more third processing units of the third system), a simulation of the second quantum computation based on the computational key. The second quantum computation may be configured to solve a second computational problem different from the first computational problem. Performing a simulation of the second quantum computation based on the computational key may include computing a solution to the second computational problem based on the computational key.

A quantum computation simulated by the first system may be a first quantum computation. The method may include performing a simulation of a plurality of quantum computations based on the computational key, i.e. the same computational key as used for simulating the first quantum computation. Each quantum computation of the plurality of quantum computations may have a size parameter which is equal to or less than the size parameter of the first quantum computation. The plurality of quantum computations may include 3, 4, 5, 6, 7, 8, 9, 10 or more quantum computations.

The simulations of the plurality of quantum computations can be performed by a plurality of systems, such as 3, 4, 5, 6, 7, 8, 9, 10 systems. The simulation of each respective quantum computation of the plurality of quantum computations can be performed by a respective system of the plurality of systems. The simulation of the first quantum computation can be performed by the first system as described herein. The simulation of a second quantum computation can be performed by the third system as described herein. According to other embodiments, the simulations of at least some, and possibly all, the plurality of quantum computations can be performed by a same system, such as the first system.

A simulation of a quantum computation as described herein, for example a simulation performed by the first system, the third system or any other system, may be a classical simulation performed by a non-quantum computing system.

A quantum computation as described herein (such as for example the first quantum computation or the second quantum computation, or any other quantum computation) may include an input quantum state. The input quantum state may not be a Pauli stabilizer state. The input quantum state may include or consist of a tensor product of K first quantum states and a tensor product of N second quantum states, wherein each first quantum state is a Pauli stabilizer state and each second quantum state is not a Pauli stabilizer state. An input quantum state may have the form

|ψᵢₙₚᵤₜ>=|ψ₁>⊗ . . . ⊗|ψ_{K}>⊗|_{K+1}>└ . . . ⊗|ψ_{K+N}>.

In other words, the input quantum state |ψᵢₙₚᵤₜ> can be a tensor product of K+N quantum states. The input quantum state can be a state of n qubits in total, wherein n=K+N. In other words, K+N may be equal to the total number of qubits of the input quantum state. The K states |ψ₁>, . . . , |ψ_{K}>, referred to herein as first quantum states, may be each be Pauli stabilizer states. Each first quantum state |ψᵢ> may be a state of kᵢ qubits. The total number of qubits taken up by the first quantum states |ψ₁>, . . . |ψ_{K}> may be equal to k₁+ . . . +k_{K}. In some embodiments, each first quantum state may be a single-qubit state, so that the total number of qubits taken up by the first quantum states is K. The N states |ψ_{K+1}>, . . . , |ψ_{K+N}>, referred to herein as second quantum states, may not be Pauli stabilizer states. Each second quantum state Iv; > may be a state of mᵢ qubits. The total number of qubits taken up by the second quantum states |ψ_{K+1}>, . . . , |ψ_{K+N}> may be equal to m₁+ . . . +m_{N}. In some embodiments, each second quantum state may be a single-qubit state, so that the total number of qubits taken up by the second quantum states is N.

A size parameter of a quantum computation may depend on at least one of the number N of second quantum states and the total number of qubits of the N second quantum states. Each i-th second quantum state may be a state of mᵢ qubits, wherein the total number of qubits of the N second quantum states is equal to m₁+ . . . +m_{N}. The size parameter may increase with the number N of second quantum states.

A quantum computation as described herein may include a sequence of operations applied to the input quantum state. The sequence of operations may include a plurality of Pauli measurements. Additionally or alternatively, the sequence of operations may include a plurality of Clifford unitary operations. All measurements performed in the quantum computation may be Pauli measurements, and/or all unitary operations performed in the quantum computation may be Clifford unitary operations. A quantum computation may be a magic state quantum computation.

An input size of a computational problem may depend on, or be characteristic of, a number of bits used for representing an input of the computational problem.

The size parameter of a quantum computation as described herein (such as for example the first quantum computation or the second quantum computation, or any other quantum computation) may increase as the input size of the computational problem solved by the quantum computation increases.

A computational key determined by the second system based on a size parameter of a quantum computation may depend only on the size parameter of the quantum computation, such that two quantum computations which are different from each other but which have the same size parameter result in the same computational key.

A computational key determined by the second system based on a size parameter of a quantum computation may be associated with, or depend on, the input quantum state of the quantum computation.

An input quantum state of a quantum computation as described herein may be representable, particularly approximately representable, as a probability distribution Pᵢₙₚᵤₜ. A computational key that is determined based on the size parameter of the quantum computation may contain information allowing a system (such as the first system, the third system, or any other system) to obtain at least one sample of the probability distribution Pᵢₙₚᵤₜ. The computational key may contain information allowing the system to obtain a plurality of samples (for example at least 5, 10, 100, 1000 or even more samples) of the probability distribution Pᵢₙₚᵤₜ. The probability distribution Pᵢₙₚᵤₜ may be a probability distribution over a plurality of extreme points of a convex operator set Δ. The convex operator set Δ may consist of all Hermitian n-qubit operators X such that Tr (X)=1 and Tr (|σ><σ|X)≥0 for all n-qubit Pauli stabilizer states |σ>. The plurality of extreme points may be a finite set of extreme points. The plurality of extreme points may include all extreme points of the set Δ or some of the extreme points of the set Δ.

The method may include providing a sample of the probability distribution Pᵢₙₚᵤₜ. The sample may be generated by a system (e.g. the first system or third system or any other system) using the computational key communicated to the system in question by the second system. Alternatively, the sample may be included in the computational key communicated to the system in question by the second system. The sample may yield, as an outcome of the sample, an extreme point of the convex operator set Δ. The convex operator set Δ may be a set of n-qubit operators, denoted as A=Δ(n), as described herein. The convex operator set Δ(n) may consist of all Hermitian n-qubit operators X such that Tr (X)=1 and Tr (|σ><σ|X)≥0 for all n-qubit Pauli stabilizer states |σ>.

A quantum computation as described herein may include a first measurement, particularly a Pauli measurement, wherein the first measurement may be representable as a probability distribution P₁. A simulation of the quantum computation (e.g. a simulation performed by the first system, the third system, or any other system) may include providing a sample of the probability distribution P₁. The sample of the probability distribution P₁ may be provided based on, i.e. using, the sample of the probability distribution Pᵢₙₚᵤₜ.

The sample of the probability distribution Pᵢ may yield, as an outcome of the sample, an extreme point of a convex operator set Δ(n₁) and a simulated measurement outcome of the first measurement. The convex operator set Δ(n₁) may be a set of n₁-qubit operators, wherein either n₁ is equal to n and the convex operator set Δ(n₁) is equal to the convex operator set Δ(n) (the latter set being associated with the probability distribution Pᵢₙₚᵤₜ as described above) or, alternatively, n₁ is smaller than n and the convex operator set Δ(n₁) is different from the convex operator set Δ(n). The convex operator set Δ(n₁) may consist of all Hermitian n₁-qubit operators X such that Tr (X)=1 and Tr (|σ><σ|X)≥0 for all n₁-qubit Pauli stabilizer states |σ>.

A quantum computation as described herein may include a second measurement, particularly a Pauli measurement. The second measurement may be configured to be performed after the first measurement. The second measurement may be representable as a probability distribution P₂. A simulation of the quantum computation (e.g. a simulation performed by the first system, the third system, or any other system) may include providing a sample of the probability distribution P₂. The sample of the probability distribution P₂ may be based on the sample of the probability distribution P₁ and/or based on the sample of the probability distribution Pᵢₙₚᵤₜ. The sample of the probability distribution P₂ may yield, as an outcome of the sample, an extreme point of a convex operator set Δ(n₂) and a simulated measurement outcome of the second measurement. The convex operator set Δ(n₂) may be a set of n₂-qubit operators, wherein either n₂ is equal to n₁ and the convex operator set Δ(n₂) is equal to the convex operator set Δ(n₁) or, alternatively, n₂ is smaller than n₁ and the convex operator set Δ(n₂) is different from the convex operator set Δ(n₁). The convex operator set Δ(n₂) may consist of all Hermitian n₂-qubit operators X such that Tr (X)=1 and Tr (|σ><σ|X)≥0 for all n₂-qubit Pauli stabilizer states |σ>.

The number n₂ of the set Δ(n₂) may be equal to 2, i.e. n₂=2, so that Δ(n₂) is a set of 2-qubit operators. An extreme point of the convex operator set Δ(2) that is obtained by sampling the probability distribution P₂ may be representable as a graph having full perrank. Additionally or alternatively, data describing the extreme point of the convex operator set Δ(2) obtained by sampling the probability distribution P₂ may be determined using the list of extreme points of the set Δ(2) provided in Appendix B.

A quantum computation as described herein may include a plurality of measurements M₁, M₂ . . . M_{T}, wherein T is 2, 3, 4, 5 or larger, 10 or larger, or 100 or larger, particularly wherein the plurality of measurements are Pauli measurements. For each i, the (i+1)-th measurement Mᵢ₊₁ of the plurality of measurements may be configured to be performed after the i-th measurement M of the plurality of measurements. Each i-th measurement M may be representable as a probability distribution P. A simulation of the quantum computation (e.g. a simulation performed by the first system, the third system, or any other system) may include, for each i-th measurement Mᵢ, providing a sample of the probability distribution P. The sample of the probability distribution Pᵢ may be based on the sample of the probability distribution Pᵢ₋₁, based on one or more of samples of probability distribution Pₖ with k smaller than i, based on a sample of the probability distribution Pᵢₙₚᵤₜ, or any combination thereof. The sample of the probability distribution Pᵢ may yield, as an outcome of the sample, an extreme point of a convex operator set Δ(nᵢ) and a simulated measurement outcome of the i-th measurement M. The convex operator set Δ(nᵢ) may be a set of nᵢ-qubit operators. For each i, the number of qubits nᵢ₊₁ associated with the convex operator set Δ(nᵢ₊₁) relating to the (i+1)-th measurement Mᵢ₊₁ may be smaller than or equal to, particularly smaller than, the number of qubits nᵢ associated with the convex operator set Δ(nᵢ) relating to the i-th measurement M. For each i, the convex operator set Δ(nᵢ) may consist of all Hermitian nᵢ-qubit operators X such that Tr (X)=1 and Tr (|σ><σ|X)≥0 for all nᵢ-qubit Pauli stabilizer states |σ>.

A quantum computation as described herein may include an i-th measurement and an (i+1)th measurement configured to be performed directly after the i-th measurement. The i-th measurement may be representable as a probability distribution Pᵢ. A simulation of the quantum computation (e.g. a simulation performed by the first system, the third system. or any other system) may include providing a sample of the probability distribution Pᵢ. The sample of the probability distribution Pᵢ may yield, as an outcome of the sample, an extreme point of a convex operator set Δ(nᵢ) and a simulated measurement outcome of the i-th measurement, wherein the convex operator set Δ(nᵢ) is a set of nᵢ-qubit operators. A simulation of the quantum computation may include determining whether the extreme point of the convex operator set Δ(nᵢ) obtained by sampling the probability distribution Pᵢ has the form U A_{α} ⊗ π U*, wherein U is a unitary Clifford operator, π is a Pauli projector and A_{α} is an extreme point of a convex operator set Δ(m) of m-qubit operators, wherein m is smaller than nᵢ. The convex operator set Δ(m) may consist of all Hermitian m-qubit operators X such that Tr (X)=1 and Tr (|σ><σ|X)≥0 for all m-qubit Pauli stabilizer states |σ>. A simulation of the quantum computation may include, if the extreme point obtained by sampling the probability distribution Pᵢ has the form U A_{α} ⊗ π U*, providing a sample of a probability distribution Pᵢ₊₁, wherein the sample of the probability distribution Pᵢ₊₁ yields, as an outcome of the sample, an extreme point of the convex operator set Δ(m) and a simulated measurement outcome of the (i+1)th measurement.

A method as described herein may include determining, by the second system, the computational key from the size parameter. The computational key may be determined using a linear programming algorithm. The computational key may be determined by a non-quantum computing system or by a quantum computing system. The second system may be a non-quantum computing system or by a quantum computing system.

A method as described herein may include storing the computational key, for example by the second system.

The first system may include a plurality of first processing units, wherein a simulation of a quantum computation may be performed in parallel by the plurality of first processing units. The third system may include a plurality of third processing units, wherein a simulation of a quantum computation may be performed in parallel by the plurality of third processing units.

According to a further embodiment (as illustrated for example in FIG. 6) a method of simulating a quantum computation is provided. The method includes determining, by a first system comprising one or more first processing units, a size parameter of a quantum computation. The quantum computation is configured for solving a computational problem. The size parameter is characteristic of an input size of the computational problem. The method includes communicating, by the first system, the size parameter to a second system comprising one or more second processing units. The method includes communicating, by the second system, a computational key to a third system comprising one or more third processing units, wherein the computational key is based on the size parameter of the quantum computation. The method includes performing, by the third system, a simulation of the quantum computation based on the computational key. The method may include any aspects or features as described in relation to embodiments of the methods described herein.

According to a further embodiment, a system for simulating a quantum computation is provided. The system includes a first system comprising one or more first processing units. The system includes a second system comprising one or more second processing units, the second system being communicatively coupled to the first system. The first system is configured to communicate a size parameter of a quantum computation to the second system. The quantum computation is configured for solving a computational problem. The size parameter is characteristic of an input size of the computational problem. The second system is configured for communicating a computational key to the first system, wherein the computational key is based on the size parameter of the quantum computation. The first system is configured for performing a simulation of the quantum computation based on the computational key. The system may be configured for performing any of the methods according to embodiments described herein.

The system may include a third system including one or more third processing units. The third system may be configured for communicating a size parameter of a second quantum computation to the second system. The second quantum computation may be different from the first quantum computation. The size parameter of the second quantum computation may be equal to or less than the size parameter of the first quantum computation. The second system may be configured for communicating the computational key to the third system. The third system may be configured for performing a simulation of the quantum computation based on the computational key

According to a further embodiment, a system for simulating a quantum computation is provided. The system includes a first system including one or more first processing units. The system includes a second system including one or more second processing units. The second system is communicatively coupled to the first system. The system includes a third system including one or more third processing units, the second system being communicatively coupled to the third system. The first system is configured to communicate a size parameter of a quantum computation to the second system, wherein the quantum computation is configured for solving a computational problem, wherein the size parameter is characteristic of an input size of the computational problem. The second system is configured for communicating a computational key to the third system, wherein the computational key is based on the size parameter of the quantum computation. The third system is configured for performing a simulation of the quantum computation based on the computational key. The system may be configured for performing any of the methods according to embodiments described herein.

According to a further embodiment, a method for issuing a computational key is provided. The method includes receiving a size parameter of a quantum computation as described herein, wherein the quantum computation is configured for solving a computational problem, wherein the size parameter is characteristic of an input size of the computational problem. The method includes issuing a computational key, wherein the computational key is based on the size parameter of the quantum computation, wherein the computational key allows performing a simulation of the quantum computation based on the computational key.

The receiving of the size parameter and/or the issuing of the computational key may be performed by a system including one or more processing units. The size parameter may be received by a second system including one or more second processing units from a first system including one or more first processing units. The computational key may be issued by the second system to the first system or to a third system.

The quantum computation may be a first quantum computation. The method may include receiving a size parameter of a second quantum computation, wherein the second quantum computation may be different from the first quantum computation. The size parameter of the second quantum computation may be equal to or less than the size parameter of the first quantum computation. The method may include issuing, particularly re-issuing, the computational key, wherein the computational key allows performing a simulation of the second quantum computation based on the computational key.

The size parameter of the second quantum computation may be received by the second system and/or the computational key may be issued by the second system. The size parameter of the second quantum computation may be received from the first system or from the third system. The computational key may be issued to the first system or to the third system.

According to a further embodiment, a system for issuing a computational key is provided, for example a second system as described herein. The system includes one or more processing units. The one or more processing units are configured for receiving a size parameter of a quantum computation, wherein the quantum computation is configured for solving a computational problem, wherein the size parameter is characteristic of an input size of the computational problem. The one or more processing units are configured for issuing a computational key, wherein the computational key is based on the size parameter of the quantum computation, wherein the computational key allows performing a simulation of the quantum computation based on the computational key. The system may be configured for performing a method for issuing a computational key according to embodiments described herein.

According to a further embodiment, a method of simulating a quantum computation is provided. The method includes determining a size parameter of a quantum computation as described herein, wherein the quantum computation is configured for solving a computational problem, wherein the size parameter is characteristic of an input size of the computational problem. The method includes performing a simulation of the quantum computation based on a computational key, wherein the computational key is based on the size parameter of the quantum computation, as described herein. The method may be computer-implemented method. The method may be performed by a first system or third system as described herein. The method may be performed by one or more processing units.

The method may include receiving the computational key. The determining of the size parameter and/or the performing of the simulation may be carried out by a first system comprising one or more first processing units, as described herein. The method may include performing a simulation of a second quantum computation, or a simulation of a plurality of quantum computations, based on the computational key, as described herein.

According to a further embodiment, a system for simulating a quantum computation is provided. The system includes one or more processing units. The one or more processing units are configured for determining a size parameter of a quantum computation, wherein the quantum computation is configured for solving a computational problem, wherein the size parameter is characteristic of an input size of the computational problem, as described herein. The one or more processing units are configured for performing a simulation of the quantum computation based on a computational key, wherein the computational key is based on the size parameter of the quantum computation, as described herein. The system may be configured for performing a method of simulating a quantum computation according to embodiments described herein.

Also disclosed herein are the following aspects as provided below under items 1 through 156:
1. A method of simulating a quantum computation, comprising:
   determining, by a first system comprising one or more first processing units, a size parameter of a quantum computation, wherein the quantum computation is configured for solving a computational problem, wherein the size parameter is characteristic of an input size of the computational problem;
   communicating, by the first system, the size parameter to a second system comprising one or more second processing units;
   communicating, by the second system, a computational key to the first system, wherein the computational key is based on the size parameter of the quantum computation; and performing, by the first system, a simulation of the quantum computation based on the computational key.
2. The method according to item 1, wherein performing the simulation of the quantum computation based on the computational key includes computing a solution to the computational problem based on the computational key.
3. The method according to item 1 or item 2, wherein the quantum computation is a first quantum computation, the method further comprising:
   performing, by the first system, a simulation of a second quantum computation based on the computational key, wherein the second quantum computation is different from the first quantum computation, wherein the second quantum computation has a size parameter which is equal to or less than the size parameter of the first quantum computation.
4. The method according to any of the preceding items, wherein the quantum computation is a first quantum computation, the method further comprising:
   communicating, by a third system, a size parameter of a second quantum computation to the second system, wherein the second quantum computation is different from the first quantum computation, wherein the size parameter of the second quantum computation is equal to or less than the size parameter of the first quantum computation;
   communicating, by the second system, the computational key to the third system; and
   performing, by the third system, a simulation of the quantum computation based on the computational key.
5. The method according to item 3 or item 4, wherein the second quantum computation is configured to solve a second computational problem different from the first computational problem, wherein performing a simulation of the second quantum computation based on the computational key includes computing a solution to the second computational problem based on the computational key.
6. The method according to any of the preceding items, wherein the quantum computation is a first quantum computation, the method further comprising:
   performing a simulation of a plurality of quantum computations based on the computational key, wherein each quantum computation of the plurality of quantum computations has a size parameter which is equal to or less than the size parameter of the first quantum computation, wherein the plurality of quantum computations includes 3, 4, 5, 6, 7, 8, 9, 10 or more quantum computations.
7. The method according to any of the preceding items, wherein the quantum computation includes an input quantum state.
8. The method according to item 7, wherein the input quantum state is not a Pauli stabilizer state.
9. The method according to item 7 or item 8, wherein the input quantum state includes or consists of a tensor product of K first quantum states and a tensor product of N second quantum states, wherein each first quantum state is a Pauli stabilizer state and each second quantum state is not a Pauli stabilizer state.
10. The method according to item 9, wherein the size parameter of the quantum computation depends on at least one of:
   the number N of second quantum states; and
   the total number of qubits of the N second quantum states, particularly wherein each i-th second quantum state is a state of mᵢ qubits, wherein the total number of qubits of the n second quantum states is equal to m₁+ . . . +m_{N}.
11. The method according to item 9 or item 10, wherein K+N equals the total number of qubits of the input quantum state.
12. The method of any of items 9 to 11, wherein the size parameter of the quantum computation increases with the number N of second quantum states.
13. The method according to any of items 7 to 12, wherein the quantum computation includes a sequence of operations applied to the input quantum state, wherein the sequence of operations includes a plurality of Pauli measurements.
14. The method according to item 13, wherein the sequence of operations includes a plurality of Clifford unitary operations.
15. The method according to any of the preceding items, wherein all measurements performed in the quantum computation are Pauli measurements, and/or wherein all unitary operations performed in the quantum computation are Clifford unitary operations.
16. The method according to any of the preceding items, wherein the input size of the computational problem depends on, or is characteristic of, a number of bits used for representing an input of the computational problem.
17. The method according to any of the preceding items, wherein the size parameter of the quantum computation increases as the input size of the computational problem increases.
18. The method according to any of the preceding items, wherein the computational key depends only on the size parameter of the quantum computation, such that two quantum computations which are different from each other but which have the same size parameter result in the same computational key.
19. The method according to any of the preceding items, wherein the computational key is associated with the input quantum state of the quantum computation.
20. The method according to any of the preceding items, wherein the input quantum state is representable, particularly approximately representable, as a probability distribution Pᵢₙₚᵤₜ, wherein the computational key contains information allowing the first system to obtain at least one sample of the probability distribution Pᵢₙₚᵤₜ.
21. The method according to item 20, wherein the computational key contains information allowing the first system to obtain a plurality of samples of the probability distribution Pᵢₙₚᵤₜ.
22. The method according to item 20 or item 21, wherein the probability distribution Pᵢₙₚᵤₜ is a probability distribution over a plurality of extreme points of a convex operator set Δ.
23. The method according to item 22, wherein the plurality of extreme points is a finite set of extreme points.
24. The method according to item 22 or item 23, wherein the convex operator set Δ consists of all Hermitian n-qubit operators X such that Tr (X)=1 and Tr (|σ><σ|X)≥0 for all n-qubit Pauli stabilizer states |σ>.
25. The method according to any of items 22 to 24, wherein the plurality of extreme points includes all extreme points of the set Δ or includes some of the extreme points of the set Δ.
26. The method according to any of the preceding items, wherein the simulation of the quantum computation performed by the first system is a classical simulation performed by a non-quantum computing system.
27. The method according to any of the preceding items, wherein the method further comprises:
   providing a sample of the probability distribution Pᵢₙₚᵤₜ, wherein the sample is generated by the first system using the computational key or wherein the sample is included in the computational key communicated to the first system by the second system.
28. The method according to item 27, wherein the sample yields, as an outcome of the sample, an extreme point of the convex operator set Δ.
29. The method according to any of the preceding items, wherein the quantum computation includes a first measurement, particularly a Pauli measurement, wherein the first measurement is representable as a probability distribution P₁.
30. The method according to item 29, wherein the simulation of the quantum computation performed by the first system includes:
   based on the sample of the probability distribution Pᵢₙₚᵤₜ, providing a sample of the probability distribution P₁, wherein the sample of the probability distribution P₁ yields, as an outcome of the sample, an extreme point of the convex operator set Δ and a simulated measurement outcome of the first measurement.
31. The method according to item 29 or item 30, wherein the quantum computation includes a second measurement, particularly a Pauli measurement, wherein the second measurement is performed after the first measurement, wherein the second measurement is representable as a probability distribution P₂.
32. The method according to item 31, wherein the simulation of the quantum computation performed by the first system includes:
   based on the sample of the probability distribution P₁, providing a sample of the probability distribution P₂, wherein the sample of the probability distribution P₂ yields, as an outcome of the sample, an extreme point of the convex operator set Δ and a simulated measurement outcome of the second measurement.
33. The method according to any of the preceding items, wherein the quantum computation includes 5 or more, 10 or more, or 100 or more measurements, particularly Pauli measurements, wherein each i-th measurement is representable as a probability distribution Pᵢ.
34. The method according to item 33, wherein the simulation of the quantum computation performed by the first system includes, for each i-th measurement
   based on the sample of the probability distribution providing a sample of the probability distribution Pᵢ, wherein the sample of the probability distribution Pᵢ yields, as an outcome of the sample, an extreme point of the convex operator set Δ and a simulated measurement outcome of the i-th measurement.
35. The method according to any of the preceding items, the method further comprising:
   determining, by the second system, the computational key from the size parameter.
36. The method according to item 35, wherein the computational key is determined using a linear programming algorithm.
37. The method according to item 35 or item 36, wherein the computational key is determined by a non-quantum computing system or by a quantum computing system.
38. The method according to any of the preceding items, further comprising:
   storing the computational key by the second system.
39. The method according to any of the preceding items, wherein the first system comprises a plurality of processing units, wherein the simulation of the quantum computation is performed in parallel by the plurality of processing units.
40. A method of simulating a quantum computation, comprising:
   determining, by a first system comprising one or more first processing units, a size parameter of a quantum computation, wherein the quantum computation is configured for solving a computational problem, wherein the size parameter is characteristic of an input size of the computational problem;
   communicating, by the first system, the size parameter to a second system comprising one or more second processing units;
   communicating, by the second system, a computational key to a third system comprising one or more third processing units, wherein the computational key is based on the size parameter of the quantum computation; and
   performing, by the third system, a simulation of the quantum computation based on the computational key.
41. The method according to item 40, wherein performing the simulation of the quantum computation based on the computational key includes computing a solution to the computational problem based on the computational key.
42. The method according to item 40 or item 41, wherein the quantum computation is a first quantum computation, the method further comprising:
   performing, by the third system, a simulation of a second quantum computation based on the computational key, wherein the second quantum computation is different from the first quantum computation, wherein the second quantum computation has a size parameter which is equal to or less than the size parameter of the first quantum computation.
43. The method according to item 42, wherein the second quantum computation is configured to solve a second computational problem different from the first computational problem, wherein performing a simulation of the second quantum computation based on the computational key includes computing a solution to the second computational problem based on the computational key.
44. The method according to any of items 40 to 43, wherein the quantum computation is a first quantum computation, the method further comprising:
   performing a simulation of a plurality of quantum computations based on the computational key, wherein each quantum computation of the plurality of quantum computations has a size parameter which is equal to or less than the size parameter of the first quantum computation, wherein the plurality of quantum computations includes 3, 4, 5, 6, 7, 8, 9, 10 or more quantum computations.
45. The method according to any of any of items 40 to 44, wherein the quantum computation includes an input quantum state.
46. The method according to item 45, wherein the input quantum state is not a Pauli stabilizer state.
47. The method according to item 45 or item 46, wherein the input quantum state includes or consists of a tensor product of K first quantum states and a tensor product of N second quantum states, wherein each first quantum state is a Pauli stabilizer state and each second quantum state is not a Pauli stabilizer state.
48. The method according to item 47, wherein the size parameter of the quantum computation depends on at least one of:
   the number N of second quantum states; and
   the total number of qubits of the N second quantum states, particularly wherein each i-th second quantum state is a state of mᵢ qubits, wherein the total number of qubits of the n second quantum states is equal to m₁+ . . . +m_{N}.
49. The method according to item 47 or item 48, wherein K+N equals the total number of qubits of the input quantum state.
50. The method of any of items 47 to 49, wherein the size parameter of the quantum computation increases with the number N of second quantum states.
51. The method according to any of items 45 to 50, wherein the quantum computation includes a sequence of operations applied to the input quantum state, wherein the sequence of operations includes a plurality of Pauli measurements.
52. The method according to item 51, wherein the sequence of operations includes a plurality of Clifford unitary operations.
53. The method according to any of items 40 to 52, wherein all measurements performed in the quantum computation are Pauli measurements, and/or wherein all unitary operations performed in the quantum computation are Clifford unitary operations.
54. The method according to any of items 40 to 53, wherein the input size of the computational problem depends on, or is characteristic of, a number of bits used for representing an input of the computational problem.
55. The method according to any of items 40 to 54, wherein the size parameter of the quantum computation increases as the input size of the computational problem increases.
56. The method according to any of items 40 to 55, wherein the computational key depends only on the size parameter of the quantum computation, such that two quantum computations which are different from each other but which have the same size parameter result in the same computational key.
57. The method according to any of items 40 to 56, wherein the computational key is associated with the input quantum state of the quantum computation.
58. The method according to any of items 40 to 57, wherein the input quantum state is representable, particularly approximately representable, as a probability distribution Pᵢₙₚᵤₜ, wherein the computational key contains information allowing the third system to obtain at least one sample of the probability distribution Pᵢₙₚᵤₜ.
59. The method according to item 58, wherein the computational key contains information allowing the third system to obtain a plurality of samples of the probability distribution Pᵢₙₚᵤₜ
60. The method according to item 58 or item 59, wherein the probability distribution Pᵢₙₚᵤₜ is a probability distribution over a plurality of extreme points of a convex operator set Δ.
61. The method according to item 60, wherein the plurality of extreme points is a finite set of extreme points.
62. The method according to item 60 or item 61, wherein the convex operator set Δ consists of all Hermitian n-qubit operators X such that Tr (X)=1 and Tr (|σ><σ|X)≥0 for all n-qubit Pauli stabilizer states |σ>.
63. The method according to any of items 60 to 62, wherein the plurality of extreme points includes all extreme points of the set Δ or includes some of the extreme points of the set Δ.
64. The method according to any of items 40 to 63, wherein the simulation of the quantum computation performed by the third system is a classical simulation performed by a non-quantum computing system.
65. The method according to any of items 40 to 64, wherein the method further comprises:
   providing a sample of the probability distribution Pᵢₙₚᵤₜ, wherein the sample is generated by the third system using the computational key or wherein the sample is included in the computational key communicated to the third system by the second system.
66. The method according to item 65, wherein the sample yields, as an outcome of the sample, an extreme point of the convex operator set Δ.
67. The method according to any of the items 40 to 66, wherein the quantum computation includes a first measurement, particularly a Pauli measurement, wherein the first measurement is representable as a probability distribution P₁.
68. The method according to item 67, wherein the simulation of the quantum computation performed by the third system includes:
   based on the sample of the probability distribution Pᵢₙₚᵤₜ, providing a sample of the probability distribution P₁, wherein the sample of the probability distribution P₁ yields, as an outcome of the sample, an extreme point of the convex operator set Δ and a simulated measurement outcome of the first measurement.
69. The method according to item 67 or item 68, wherein the quantum computation includes a second measurement, particularly a Pauli measurement, wherein the second measurement is performed after the first measurement, wherein the second measurement is representable as a probability distribution P₂.
70. The method according to item 69, wherein the simulation of the quantum computation performed by the third system includes:
   based on the sample of the probability distribution P₁, providing a sample of the probability distribution P₂, wherein the sample of the probability distribution P₂ yields, as an outcome of the sample, an extreme point of the convex operator set Δ and a simulated measurement outcome of the second measurement.
71. The method according to any of items 40 to 70, wherein the quantum computation includes 5 or more, 10 or more, or 100 or more measurements, particularly Pauli measurements, wherein each i-th measurement is representable as a probability distribution P.
72. The method according to item 71, wherein the simulation of the quantum computation performed by the third system includes, for each i-th measurement:
   based on the sample of the probability distribution Pᵢ₋₁, providing a sample of the probability distribution Pᵢ, wherein the sample of the probability distribution Pᵢ yields, as an outcome of the sample, an extreme point of the convex operator set Δ and a simulated measurement outcome of the i-th measurement.
73. The method according to any of items 40 to 72, the method further comprising:
   determining, by the second system, the computational key from the size parameter.
74. The method according to item 73, wherein the computational key is determined using a linear programming algorithm.
75. The method according to item 73 or item 74, wherein the computational key is determined by a non-quantum computing system or by a quantum computing system.
76. The method according to any of items 40 to 75, further comprising:
   storing the computational key by the second system.
77. The method according to any of items 40 to 76, wherein the third system comprises a plurality of processing units, wherein the simulation of the quantum computation is performed in parallel by the plurality of processing units.
78. A system for simulating a quantum computation, comprising:
   a first system comprising one or more first processing units; and
   a second system comprising one or more second processing units, the second system being communicatively coupled to the first system,
   wherein the first system is configured to communicate a size parameter of a quantum computation to the second system, wherein the quantum computation is configured for solving a computational problem, wherein the size parameter is characteristic of an input size of the computational problem,
   wherein the second system is configured for communicating a computational key to the first system, wherein the computational key is based on the size parameter of the quantum computation, and
   wherein the first system is configured for performing a simulation of the quantum computation based on the computational key.
79. The system according to item 78, further comprising:
   a third system comprising one or more third processing units,
   wherein the third system is configured for communicating a size parameter of a second quantum computation to the second system, wherein the second quantum computation is different from the first quantum computation, wherein the size parameter of the second quantum computation is equal to or less than the size parameter of the first quantum computation,
   wherein the second system is configured for communicating the computational key to the third system,
   wherein the third system is configured for performing a simulation of the quantum computation based on the computational key
80. The system according to item 78 or item 79, wherein the system is configured for performing the method according to any of items 1 to 39.
81. A system for simulating a quantum computation, comprising:
   a first system comprising one or more first processing units;
   a second system comprising one or more second processing units, the second system being communicatively coupled to the first system; and
   a third system comprising one or more third processing units, the second system being communicatively coupled to the third system,
   wherein the first system is configured to communicate a size parameter of a quantum computation to the second system, wherein the quantum computation is configured for solving a computational problem, wherein the size parameter is characteristic of an input size of the computational problem,
   wherein the second system is configured for communicating a computational key to the third system, wherein the computational key is based on the size parameter of the quantum computation, and
   wherein the third system is configured for performing a simulation of the quantum computation based on the computational key.
82. The system according to item 81, wherein the system is configured for performing the method according to any of items 40 to 77.
83. A method for issuing a computational key, comprising:
   receiving a size parameter of a quantum computation, wherein the quantum computation is configured for solving a computational problem, wherein the size parameter is characteristic of an input size of the computational problem;
   issuing a computational key, wherein the computational key is based on the size parameter of the quantum computation, wherein the computational key allows performing a simulation of the quantum computation based on the computational key.
84. The method of item 83, wherein the receiving and/or the issuing are performed by a system including one or more processing units.
85. The method of item 83 or item 84, wherein the size parameter is received by a second system including one or more second processing units from a first system including one or more first processing units.
86. The method of item 85, wherein the computational key is issued by the second system to the first system or to a third system.
87. The method of any of items 83 to 86, wherein the quantum computation is a first quantum computation, the method further comprising:
   receiving a size parameter of a second quantum computation, wherein the second quantum computation is different from the first quantum computation, wherein the size parameter of the second quantum computation is equal to or less than the size parameter of the first quantum computation; and
   issuing the computational key, wherein the computational key allows performing a simulation of the second quantum computation based on the computational key.
88. The method of item 87, wherein the size parameter of the second quantum computation is received by the second system and/or wherein the computational key is issued by the second system.
89. The method of item 87 or item 88, wherein the size parameter of the second quantum computation is received from the first system or from the third system and/or wherein the computational key is issued to the first system or to the third system.
90. The method according to any of items 83 to 89, wherein the quantum computation includes an input quantum state.
91. The method according to item 90, wherein the input quantum state is not a Pauli stabilizer state.
92. The method according to item 90 or item 91, wherein the input quantum state includes or consists of a tensor product of K first quantum states and a tensor product of N second quantum states, wherein each first quantum state is a Pauli stabilizer state and each second quantum state is not a Pauli stabilizer state.
93. The method according to item 92, wherein the size parameter of the quantum computation depends on at least one of:
   the number N of second quantum states; and
   the total number of qubits of the N second quantum states, particularly wherein each i-th second quantum state is a state of mᵢ qubits, wherein the total number of qubits of the n second quantum states is equal to m₁+ . . . +m_{N}.
94. The method according to item 92 or item 93, wherein K+N equals the total number of qubits of the input quantum state.
95. The method of any of items 92 to 94, wherein the size parameter of the quantum computation increases with the number N of second quantum states.
96. The method according to any of items 90 to 95, wherein the quantum computation includes a sequence of operations applied to the input quantum state, wherein the sequence of operations includes a plurality of Pauli measurements.
97. The method according to item 96, wherein the sequence of operations includes a plurality of Clifford unitary operations.
98. The method according to any of items 83 to 97, wherein all measurements performed in the quantum computation are Pauli measurements, and/or wherein all unitary operations performed in the quantum computation are Clifford unitary operations.
99. The method according to any of items 83 to 98, wherein the input size of the computational problem depends on, or is characteristic of, a number of bits used for representing an input of the computational problem.
100. The method according to any of items 83 to 99, wherein the size parameter of the quantum computation increases as the input size of the computational problem increases.
101. The method according to any of items 83 to 100, wherein the computational key depends only on the size parameter of the quantum computation, such that two quantum computations which are different from each other but which have the same size parameter result in the same computational key.
102. The method according to any of items 83 to 101, wherein the computational key is associated with the input quantum state of the quantum computation.
103. The method according to any of items 83 to 102, wherein the input quantum state is representable, particularly approximately representable, as a probability distribution Pᵢₙₚᵤₜ, wherein the computational key contains information allowing a system to obtain at least one sample of the probability distribution Pᵢₙₚᵤₜ.
104. The method according to item 103, wherein the computational key contains information allowing a system to obtain a plurality of samples of the probability distribution Pᵢₙₚᵤₜ.
105. The method according to item 103 or item 104, wherein the probability distribution Pᵢₙₚᵤₜ is a probability distribution over a plurality of extreme points of a convex operator set Δ.
106. The method according to item 105, wherein the plurality of extreme points is a finite set of extreme points.
107. The method according to item 105 or item 106, wherein the convex operator set Δ consists of all Hermitian n-qubit operators X such that Tr (X)=1 and Tr (|σ><σ|X)≥0 for all n-qubit Pauli stabilizer states |σ>.
108. The method according to any of items 105 to 107, wherein the plurality of extreme points includes all extreme points of the set Δ or includes some of the extreme points of the set Δ.
109. The method according to any of items 83 to 108, wherein the simulation of the quantum computation is a classical simulation performed by a non-quantum computing system.
110. The method according to any of items 83 to 109, wherein the computational key includes a sample of the probability distribution Pᵢₙₚᵤₜ or wherein the computational key allows a sample of the probability distribution Pᵢₙₚᵤₜ to be generated using the computational key.
111. The method according to item 110, wherein the sample yields, as an outcome of the sample, an extreme point of the convex operator set Δ.
112. The method according to any items 83 to 111, the method further comprising:
   determining the computational key from the size parameter, particularly wherein the computational key is determined by the second system.
113. The method according to item 112, wherein the computational key is determined using a linear programming algorithm.
114. The method according to item 112 or item 113, wherein the computational key is determined by a non-quantum computing system or by a quantum computing system.
115. The method according to any of items 83 to 114, further comprising:
   storing the computational key, particularly by the second system.
116. The method of any of items 83 to 115, further comprising:
   performing the simulation of the quantum computation based on the computational key, particularly wherein the simulation is performed by the second system.
117. A system for issuing a computational key, comprising:
   one or more processing units, wherein the one or more processing units are configured for
      receiving a size parameter of a quantum computation, wherein the quantum computation is configured for solving a computational problem, wherein the size parameter is characteristic of an input size of the computational problem;
      issuing a computational key, wherein the computational key is based on the size parameter of the quantum computation, wherein the computational key allows performing a simulation of the quantum computation based on the computational key.
118. The system according to item 117, wherein the system is configured for performing the method according to any of items 83 to 116.
119. A method of simulating a quantum computation, comprising:
   determining a size parameter of a quantum computation, wherein the quantum computation is configured for solving a computational problem, wherein the size parameter is characteristic of an input size of the computational problem; and
   performing a simulation of the quantum computation based on a computational key, wherein the computational key is based on the size parameter of the quantum computation.
120. The method according to item 119, further comprising:
   receiving the computational key.
121. The method according to item 119 or 120, wherein the determining and/or the performing are carried out by a first system comprising one or more processing units.
122. The method according to any of items 119 to 121, wherein performing the simulation of the quantum computation based on the computational key includes computing a solution to the computational problem based on the computational key.
123. The method according to any of items 119 to 122, wherein the quantum computation is a first quantum computation, the method further comprising:
   performing a simulation of a second quantum computation based on the computational key, wherein the second quantum computation is different from the first quantum computation, wherein the second quantum computation has a size parameter which is equal to or less than the size parameter of the first quantum computation.
124. The method according to item 123, wherein the second quantum computation is configured to solve a second computational problem different from the first computational problem, wherein performing a simulation of the second quantum computation based on the computational key includes computing a solution to the second computational problem based on the computational key.
125. The method according to any of items 119 to 124, wherein the quantum computation is a first quantum computation, the method further comprising:
   performing a simulation of a plurality of quantum computations based on the computational key, wherein each quantum computation of the plurality of quantum computations has a size parameter which is equal to or less than the size parameter of the first quantum computation, wherein the plurality of quantum computations includes 3, 4, 5, 6, 7, 8, 9, 10 or more quantum computations.
126. The method according to any of items 119 to 125, wherein the quantum computation includes an input quantum state.
127. The method according to item 126, wherein the input quantum state is not a Pauli stabilizer state.
128. The method according to item 126 or item 127, wherein the input quantum state includes or consists of a tensor product of K first quantum states and a tensor product of N second quantum states, wherein each first quantum state is a Pauli stabilizer state and each second quantum state is not a Pauli stabilizer state.
129. The method according to item 128, wherein the size parameter of the quantum computation depends on at least one of:
   the number N of second quantum states; and
   the total number of qubits of the N second quantum states, particularly wherein each i-th second quantum state is a state of mᵢ qubits, wherein the total number of qubits of the n second quantum states is equal to m₁+ . . . +m_{N}.
130. The method according to item 128 or item 129, wherein K+N equals the total number of qubits of the input quantum state.
131. The method of any of items 128 to 130, wherein the size parameter of the quantum computation increases with the number N of second quantum states.
132. The method according to any of items 126 to 131, wherein the quantum computation includes a sequence of operations applied to the input quantum state, wherein the sequence of operations includes a plurality of Pauli measurements.
133. The method according to item 132, wherein the sequence of operations includes a plurality of Clifford unitary operations.
134. The method according to any of items 119 to 133, wherein all measurements performed in the quantum computation are Pauli measurements, and/or wherein all unitary operations performed in the quantum computation are Clifford unitary operations.
135. The method according to any of items 119 to 134, wherein the input size of the computational problem depends on, or is characteristic of, a number of bits used for representing an input of the computational problem.
136. The method according to any of items 119 to 135, wherein the size parameter of the quantum computation increases as the input size of the computational problem increases.
137. The method according to any of items 119 to 136, wherein the computational key depends only on the size parameter of the quantum computation, such that two quantum computations which are different from each other but which have the same size parameter result in the same computational key.
138. The method according to any of items 119 to 137, wherein the computational key is associated with the input quantum state of the quantum computation.
139. The method according to any of items 119 to 138, wherein the input quantum state is representable, particularly approximately representable, as a probability distribution Pᵢₙₚᵤₜ, wherein the computational key contains information which allows obtaining at least one sample of the probability distribution Pᵢₙₚᵤₜ.
140. The method according to item 139, wherein the computational key contains information which allows obtaining a plurality of samples of the probability distribution Pᵢₙₚᵤₜ.
141. The method according to item 139 or item 140, wherein the probability distribution Pᵢₙₚᵤₜ is a probability distribution over a plurality of extreme points of a convex operator set Δ.
142. The method according to item 141, wherein the plurality of extreme points is a finite set of extreme points.
143. The method according to item 141 or item 142, wherein the convex operator set Δ consists of all Hermitian n-qubit operators X such that Tr (X)=1 and Tr (|σ><σ|X)≥0 for all n-qubit Pauli stabilizer states |σ>.
144. The method according to any of items 141 to 143, wherein the plurality of extreme points includes all extreme points of the set Δ or includes some of the extreme points of the set Δ.
145. The method according to any of items 119 to 144, wherein the simulation of the quantum computation is a classical simulation performed by a non-quantum computing system.
146. The method according to any of items 119 to 145, wherein the method further comprises:
   providing a sample of the probability distribution Pᵢₙₚᵤₜ, wherein the sample is generated using the computational key or wherein the sample is included in the computational key.
147. The method according to item 146, wherein the sample yields, as an outcome of the sample, an extreme point of the convex operator set Δ.
148. The method according to any of items 119 to 147, wherein the quantum computation includes a first measurement, particularly a Pauli measurement, wherein the first measurement is representable as a probability distribution P₁.
149. The method according to item 148, wherein the simulation of the quantum computation includes:
   based on the sample of the probability distribution Pᵢₙₚᵤₜ, providing a sample of the probability distribution P₁, wherein the sample of the probability distribution P₁ yields, as an outcome of the sample, an extreme point of the convex operator set Δ and a simulated measurement outcome of the first measurement.
150. The method according to item 148 or item 149, wherein the quantum computation includes a second measurement, particularly a Pauli measurement, wherein the second measurement is performed after the first measurement, wherein the second measurement is representable as a probability distribution P₂.
151. The method according to item 150, wherein the simulation of the quantum computation includes:
   based on the sample of the probability distribution P₁, providing a sample of the probability distribution P₂, wherein the sample of the probability distribution P₂ yields, as an outcome of the sample, an extreme point of the convex operator set Δ and a simulated measurement outcome of the second measurement.
152. The method according to any of items 119 to 151, wherein the quantum computation includes 5 or more, 10 or more, or 100 or more measurements, particularly Pauli measurements, wherein each i-th measurement is representable as a probability distribution P.
153. The method according to item 152, wherein the simulation of the quantum computation includes, for each i-th measurement:
   based on the sample of the probability distribution Pᵢ₋₁, providing a sample of the probability distribution Pᵢ, wherein the sample of the probability distribution Pᵢ yields, as an outcome of the sample, an extreme point of the convex operator set Δ and a simulated measurement outcome of the i-th measurement.
154. The method according to any of items 119 to 153, wherein the simulation of the quantum computation is performed in parallel by a plurality of processing units.
155. A system for simulating a quantum computation, comprising:
   one or more processing units, wherein the one or more processing units are configured for:
      determining a size parameter of a quantum computation, wherein the quantum computation is configured for solving a computational problem, wherein the size parameter is characteristic of an input size of the computational problem; and
      performing a simulation of the quantum computation based on a computational key, wherein the computational key is based on the size parameter of the quantum computation.
156. The system according to item 155, wherein the system is configured for performing the method according to any of items 119 to 154.

Detailed Technical Discussion and Mathematical Proofs

### 1. Introduction

The present disclosure is concerned with the classical simulation of quantum computation. It is based on a novel probability function over generalized multi-qubit phase space. This probability function is used to represent all n-qubit quantum states, for any integer n. It generalizes the notion of the Wigner function, but in marked contrast to the latter it never assumes negative values. Further, positivity is preserved under Pauli measurement, which is the only dynamical element in the model of quantum computation under consideration (quantum computation with magic states). It is indeed the central element in our construction that negativity doesn't show up anywhere.

All known classical simulation methods that are based on sampling over phase space, insofar as they describe universal quantum computation, have to deal with negativity in the quasiprobability distribution they try to sample from, and this leads to computational inefficiency [13]. The method of the present disclosure does not have this issue.

In one aspect, embodiments described herein involve a classical simulation method for quantum systems in finite-dimensional Hilbert spaces, and in particular of quantum computations in the magic state model. The method is related to the classical simulation of quantum computation using Wigner functions. However, the latter have to deal with negativity in the Wigner function which can—and generally will—slow down the simulation [13], often exponentially. As the probability function replacing the Wigner function in our construction never turns negative, that source of inefficiency is eliminated. In another aspect, embodiments described herein allow to simulate arbitrary quantum computations up to a given size using a classical key K(n), with n representing a size parameter of the computational problem (for example, the number of magic states available for the quantum computation), on classical computer hardware (e.g. a laptop, a smart watch). The key K(n) is completely universal: it can be used to classically simulate any quantum algorithm that fits into the size constraints specified by the key. The key unlocks quantum computing power and makes it available to classical computing hardware. For sufficiently large n, the runtime for computing the key K(n) may be long.

An envisioned application of this is the following: build a centralized computing power plant, quantum or otherwise, that churns out computational keys K(n), for as large an n as possible—perhaps for different types of magic states, and for combinations of them. Those computational keys (again, that's classical data) may be sold or otherwise distributed. It may be software which can be used on classical computer hardware to simulate quantum computations of bounded size.

The classical simulation method provided herein can be understood as a nested sampling algorithm. For every run of the simulation (simulating a single run of the actual quantum computation), first a point in phase space is drawn from the probability distribution representing the initial magic state, and subsequently, for any operation in the quantum computation, the phase point is updated according to a corresponding probability distribution.

### 2. Summary of the Method

The present disclosure regards a method or protocol for delivering universal quantum computational power to a classical computing device (the first system as described herein) by way of a classical key i.e. the computational key as described herein. The computational key can be understood as classical data which may be computed classically or with quantum resources by a second system (if only classical resources are used the runtime for computing the computational key may be long). Once the computational key is obtained, the computational key can be used (by the first system or any other system, such as the third system) to perform any quantum computation up to a fixed input size (or problem size) using classical post-processing on the computational key. The input size is characterized in the form of a size parameter as described herein. As described herein, the method may include the following operations:
a) A description of the quantum computation to be performed may be provided or determined. The description may take the form of classical data specifying, for example, which quantum gates and measurements are to be performed on which input state(s). The quantum computation may solve a computational problem, for example Shor's algorithm for factoring integers.
b) The description of the quantum computation may be mapped, or converted, into a computationally equivalent magic state computation (see e.g. [22]), particularly a magic state quantum computation in standard form, as described for example in relation to FIG. 5. A classical algorithm for converting a description of a quantum computation in the standard circuit model to an equivalent magic state quantum computation is known (see e.g. [35, § 10.6.2]). As described herein, an example of a possible size parameter is the number of magic states, for example the number of states |T>, that are included in the input state of the magic state quantum computation.
c) Once a description of the magic state quantum computation has been obtained, the technical result described below in section 4 may be applied. Said result allows representing the input quantum state of the magic state quantum computation as a probability distribution Pᵢₙₚᵤₜ over a convex operator set Δ. The probability distribution Pᵢₙₚᵤₜ as well as the convex operator set Δ are described in sections 4.1 and 4.2. The probability distribution Pᵢₙₚᵤₜ can be determined classically, for example, by solving a linear programming problem (the details of this problem are described in section 5.3.2). There are many open source and commercial software packages for solving linear programming problems, which may be used for this task, for example GLPK (www.gnu.org/software/glpk) and Gurobi (www.gurobi.org).
d) Thereafter, the computational key for simulating the quantum computation in question can be determined. As described herein, the computational key can include a sample or samples from the probability distribution Pᵢₙₚᵤₜ. If the quantum computation being simulated is deterministic (i.e. the quantum computation provides a solution to the computational problem with probability equal to 1), then a single sample of the probability distribution Pᵢₙₚᵤₜ suffices. If the quantum computation is probabilistic, then many samples may be required wherein the accuracy of the computation may generally depend on the number of samples obtained.
e) Once the computational key is obtained, the quantum computation can be simulated through classical post-processing on the computational key, i.e. classical computational operations which are performed (e.g. by the first system) based on the computational key. A description of the kind of post-processing that may be performed on the computational key is provided in section 5.4.

It shall be understood that the processing performed before and after the computational key is obtained (particularly operations b) and e) shown above) can all be done classically. The step of determining the key can also be done classically, though the classical algorithm for this may have a long runtime.

Further, with some additional classical preprocessing, the key can be made generic. That is, with some additional classical processing, any magic state quantum computation can be transformed into a computationally magic state quantum computation in which the input does not depend on the specific computation being performed (as described above, for example in relation to FIG. 5), only on the size parameter of the computational problem. This additional preprocessing step may include, for example, quantum gate synthesis (see e.g. [35, § 4.5]). Software packages for gate synthesis exist, for example newsynth (hackage.haskell.org/package/newsynth). Accordingly, the computational key may depend only on the size parameter of the problem, not on the specific quantum computation being performed. Therefore, computational keys can be reused for simulating different quantum computations.

In an exemplary application, a central server (for example the second system as described herein) may computes a computational key to unlock quantum computational power for classical clients (for example the first system or the third system as described herein). The operations a) through e) listed above may be split between the server and the client. The client may have the computational problem to be solved and so the first two operations a) and b) may be performed by the client. After the operation b), the client will be able to determine the size parameter for the computational problem. The client may send this information to the server.

Operation c) may be performed by the server. Since the computational key can be a generic key, this operation does not need to be repeated for each quantum computation, but may be performed once by the server for each input size (problem size), as characterized by the size parameter. Operation d) may also be performed by the server. Given the size parameter, the server may compute the computational key (e.g. one key or a set of keys) which depend on the input size. The computational key may then be transmitted back to the client. Again, since the computational key is generic, the computational keys computed by the server can be reused for different computations.

After the server transmits the computational key to the client, the client can perform operation e), namely performing post-processing on the computational key to simulate the quantum computation.

Example: Here we give an example of the simulation procedure above. The example is a simple example provided for facilitating the reader's understanding of the embodiments described herein, and the disclosure shall not be limited thereto. The example operates on two copies of the magic state |T [symbol] as described herein, where |T [symbol] =(|0 [symbol] +e^{iπ/4}|1 [symbol] ))/\sqrt{2}. Here only an overview of the simulation procedure is provided. The technical details are deferred to the discussion in Section 5.5.
a) Representing the quantum circuit. The quantum computation (or quantum circuit) to be simulated is

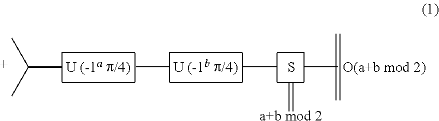

Therein, the quantum computation includes measurements of the following Pauli operators

O(0):=−Y,O(1):=X,
wherein X and Y denote the Pauli matrices (spin matrices) associated with the x- and y-direction, respectively, and the 1-qubit unitary rotations U are about the Z-axis with the angle shown; S=U(π/2). The computational problem solved by the circuit is to compute the Boolean function ƒ(a, b)=ab.
b) Conversion of the quantum computation into a magic state quantum computation (performed for example by the first system or client). Using the general identity (see e.g. [35]) for the injection of magic states,

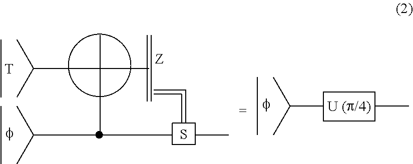

The above circuit Eq. (1) may be converted into a Clifford circuit (namely a circuit consisting of Clifford unitary operations only) acting on two magic states |T [symbol] =U(π/4)|+ [symbol] ),

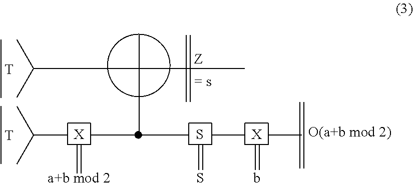

This provides a magic state quantum computation in standard form. It thereby also becomes apparent that the number of magic states needed for the computation is N=2. The size parameter may be set to be equal to this number, in other words the size parameter may be set to be equal N=2. The size parameter N=2 may be transmitted to the second system (server).
The first system (client) may proceeds further by removing all Clifford unitary gates through forward-propagation, conjugating the Pauli measurements in the passing. This may proceed in two stages. First, all unconditional Clifford gates may be removed, and second, the remaining Clifford gates conditioned on classical input and earlier measurement outcomes may be removed. In both cases, the propagation of Clifford gates and corresponding conjugation of Pauli measurements into other Pauli measurements proceeds by the rules of the stabilizer formalism (see e.g. [35]),

Tg=gT′,
with g any Clifford unitary operator and T, T′ Pauli operators. The result is a sequence of Pauli measurement outcomes.
To be specific, here we show the outcomes of this procedure for the input a=b=0, where the outcomes of the first measurement was s=1,

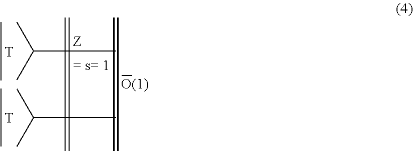

Therein, the observable Ō(⋅) is Ō(1)=X₁⊗X₂. The eigenvalue measured in the final measurement is +1 with certainty; hence the computational outcome is 0. The details of how to transform the circuit of Eq. (3) into the circuit of Eq. (4) are given below in Section 5.5, the technical version of this example.
c) The probability distribution associated with the input quantum state of the magic state quantum computation (performed by the second system or server). The server may determine the probability distribution Pᵢₙₚᵤₜ to represent the magic state |T [symbol] [symbol] T|^{⊗2}, and may provide a means to sample from that the probability distribution Pᵢₙₚᵤₜ.
d) Constructing the computational key (performed for example by the second system or server). The present example of a quantum computation is deterministic. In such cases, as shown in Section 4.3, it suffices for the computational key to consist of a single non-zero element of the probability distribution Pᵢₙₚᵤₜ representing the magic state |T [symbol] [symbol] T|^{⊗2}. Each such element is called an extreme point or vertex. Indeed, those elements form vertices of the convex polytope (convex operator set) introduced in Eq. (5) below.
   The server may pick one such vertex α₀ with nonzero probability weight and sends it to the client (first system). In this case the computational key may be given by the vertex α₀.
e) Classical simulation in Δ (performed by the first system or client). The client may receive the description of the vertex α₀ from the server. It turns out that all vertices appearing with non-zero weight in the expansion of |T [symbol] [symbol] T|^{⊗2} have a simple geometric description. For the single vertex we pick, which we subsequently denote as α₀, this simple description is

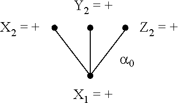

The description of this vertex is given by a graph. The sites of the graph represent Pauli observables and the corresponding expectation values given the vertex α₀. For example, X₁=+means that the expectation value of the Pauli observable X₁ in the vertex α₀ is [symbol] X₁ [symbol] _{α}_{₀}=+1, i.e., the vertex α₀ assigns the value +1 to the measurement of the observable X₁. The edges in the graph represent the commutation structure. If two Pauli observables A and B shown in the graph commute, then there is an edge between the corresponding sites, and if they anti-commute then there is none.
For a number of Pauli operators there is no vertex in the above graph. Here the following rule applies: if a Pauli observable A is a nested product of commuting Pauli observables all shown in the graph (that is, if the Pauli observable can be constructed by iteratively taking products of commuting Pauli observables in the set {X₁, X₂, Y₂, Z₂}) then the expectation value of A is definite, [symbol] A [symbol] _{α}_{₀}=±1, the vertex assigns a definite value ±1 to the measurement of that observable, and the sign is implied by the stabilizer formalism. For example, [symbol] X₁⊗X₂ [symbol] _{α}_{₀}=1. If a Pauli observable B cannot be written as such a product, then [symbol] B [symbol] _{α}_{₀}=0, the vertex does not assign a definite value to that measurement, the outcome corresponding to that measurement is random, +1 or −1 with equal probability. For example [symbol] Z₁⊗Z₂ [symbol] _{α}_{₀}=0. A more detailed discussion of this graphical representation and calculus is provided in Section 4.4.
A starting point of the classical simulation now performed by the first system (client) may be the circuit of Eq. (4). The magic state |T [symbol] [symbol] T|^{⊗2} therein is now represented by α₀. A first operation in the simulation may be the simulation of the measurement of Z₁⊗Z₂. As described above, the corresponding measurement outcome s is random. In accordance with the above, we assume (for the sake of concreteness, but without involving a limitation) for the present case that the outcome of the ZZ-measurement is s=1.
The graph representing α₀ may now be updated as follows. First, all sites whose corresponding observables commute with the measured observable Z₁⊗Z₂ persist. Second, all sites corresponding to Pauli observables that fail to commute with the measured observable Z₁⊗Z₂ disappear. Third, each pair of sites for which the corresponding Pauli observables, call them A and B, commute, but both anti-commute with the measured observable Z₁⊗Z₂ give rise to a new site with corresponding observable AB. The corresponding expectation value is given by the Pauli stabilizer formalism. For example, under the present measurement of Z₁⊗Z₂, the vertices corresponding to X₁ and to X₂ individually disappear, but give rise to a new vertex corresponding to X₁⊗X₂, with expectation value +1. The vertex corresponding to Z₁ persists. In sum, the update is as follows:

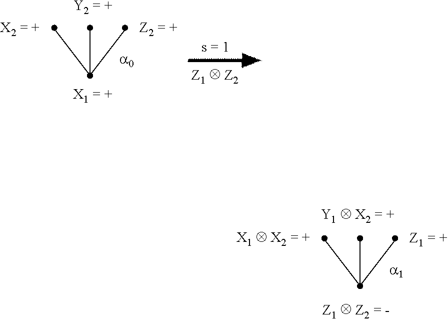

Now comes the simulation of the second measurement, of the operator Ō(1)=X₁⊗X₂. The outcome of this measurement, X₁⊗X₂=+ can be directly inferred from the above diagram for the updated vertex α₁. This simulated measurement outcome is 0 (corresponding to the eigenvalue +1=(−1)⁰), and agrees with the actual measurement outcome described above.
   3. Quantum Computation with Magic States

The model of quantum computation that our classical simulation method addresses is so called “Quantum computation with magic states” (see e.g. [22]), denoted herein as QCM. A magic state quantum computation may consist of a sequence of Clifford unitary operations interspersed with Pauli measurements, applied to an initial magic state. A magic quantum state (or magic state for short) can be understood as a quantum state that is not a Pauli stabilizer state. A magic state can be a pure or mixed quantum state that is not a probabilistic mixture of pure Pauli stabilizer states. For example, a tensor product ρ_{n×T}=|T [symbol] [symbol] T|^{⊗n} of 1-qubit magic states, where |T [symbol] =(|0 [symbol] +e^{iπ/4}1 [symbol] )/\sqrt{2}, can be used. If the Clifford unitaries and Pauli measurements acted on stabilizer states only, then the whole quantum computation would be classically efficiently simulable (Gottesman-Knill theorem). This is where the magic states come in. They are not Pauli stabilizer states, and by invoking them quantum computational universality is restored. The input quantum state of a magic state quantum computation will sometimes be denoted herein as pₘ.

It turns out that the Clifford unitaries are redundant in the model of magic state quantum computation. No computational power is lost if we consider sequences of Pauli measurements only. The reason is that the Clifford unitaries may be propagated past all measurements, thereby conjugating the Pauli measurements into (other) Pauli measurements. After forward-propagation, the unitaries can be dropped, since they do not affect the statistics of the (now earlier) measurements; see e.g. [5], [6].

### 4. Technical Results

4.1. Definitions

We consider systems of n qubits, for any n∈ [symbol] . Apart from qubit systems, the statement below applies to qudits (odd-dimensional systems) in an analogous manner. We further assume it is understood that the Clifford unitaries can be dispensed with, since no generality is lost if the magic state quantum computation involves a sequence of Pauli measurements only (see e.g. [5], [6]).

Denote by O(2ⁿ) the set of Hermitian operators on n-qubit Hilbert space H= [symbol] ²^{ⁿ} with the property that Tr(X)=1, and by [symbol] ₙ the set of all n-qubit stabilizer states. Then, we define the convex operator set, or polytope, Δₙ as

Δₙ:={X∈O(2ⁿ)|Tr(|σ [symbol] [symbol] σ|X)≥0,∀|σ [symbol] ∈ [symbol] ₙ}. (5)

The convex operator set Δₙ is also denoted herein as Δ(n), or simply as Δ if the number of qubits need not be highlighted. Denote by [symbol] ₙ the set of vertices of Δₙ, and the individual vertices, or extreme points, by Δ_{α}∈ [symbol] ₙ (generalized phase point operators, or phase point operators for short). Eₙ is the corresponding index set, so that α∈Eₙ⇔A_{α}∈ [symbol] ₙ.

Further, for the sake of concreteness (but without involving a limitation), a specific phase convention is chosen for the Pauli operators, namely Tₐ=i^{(a}^{_{Z}}^{,a}^{_{X}}⁾X(a_{X})Z(a_{Z}),∀ₐ∈ [symbol] ₂ⁿ× [symbol] ₂ⁿ=:Vₙ. The operators Tₐ are all Hermitian. The projectors on the eigenspaces of Pauli observables Tₐ with eigenvalues (−1)^{s} are

$${P}_{a , s} := \frac{I + {( - 1 )}^{s} {T}_{a}}{2} .$$

4.2. Positivity and Positivity Preservation Under Pauli Measurement

We now have the following results (the corresponding proofs are provided in Appendix A).

Theorem 1 For all n∈ [symbol] , each n-qubit quantum state p can be represented by a probability function p_{ρ}:Eₙ→ [symbol] _{≥0}.

$$ρ = {\sum }_{α ∈ {E}_{n}} {p}_{ρ} ( α ) {A}_{α} , \qquad ( 6 )$$

such that, for all Pauli measurements, the Born rule takes the form

$$Tr ( {P}_{a , s} ρ ) = {\sum }_{α ∈ {E}_{n}} {p}_{ρ} ( α ) q ( a , s \vert α ) , \qquad ( 7 )$$

with 0≤q (a, s|α)≤1, for all a, s, α. Furthermore, for the state update under Pauli measurements it holds that

$${P}_{a , s} {A}_{α} {P}_{a , s} = {\sum }_{β ∈ {E}_{n}} {q}_{α , a} ( β , s ) {A}_{β} . \qquad ( 8 )$$

Therein, for all a∈Vₙ, a∈Eₙ, the q_{a,α}:Eₙ× [symbol] ₂→ [symbol] _{≥0} are probability functions, and they satisfy the constraints Σ_{β∈E}_{ₙ}q_{a,α}(β,s)=q(a, s|α).

The above theorem describes a hidden variable model (HVM). For any fixed number of qubits, any quantum state—however strongly entangled—can be described by a probability function pₚ with finitely many elements, and furthermore, this property is inherited by any state produced from the former by Pauli measurement. In particular, the input quantum state of any magic state quantum computation can be represented as a probability distribution p_{ρ}, denoted herein as Pᵢₙₚᵤₜ. In an equivalent notation, where ρₘ denotes the input quantum state of the magic state quantum computation, the probability distribution p_{ρ} can be denoted herein by p_{μM}.

Since Pauli measurements may be the only essential dynamical element in a magic state quantum computation (since the Clifford unitary operators can be dispensed with), magic state quantum computation matches the setting described in Theorem 1. This leads to the following result.

Theorem 2 For any n∈ [symbol] and all n-qubit quantum states ρ, the classical algorithm of Table 1 for sampling the outcomes of any sequence of Pauli measurements on ρ agrees with the predictions of quantum mechanics.
Thus, the HVM of Theorem 1 describes all of universal quantum computation, and hence arbitrarily closely approximates all quantum mechanical dynamics in finite-dimensional Hilbert spaces. Through the above two theorems, classical simulation of universal quantum computation has been reduced entirely to sampling from finitely many probability distributions with finitely many elements. The classical simulation algorithm is displayed in Table 1.

TABLE 1
Classical procedure to simulate a single run of a magic state quantum computation.

| | |
|---|---|
| 1. | Sample from the probability distribution p_{ρ} (also denoted by Pᵢₙₚᵤₜ). Obtain a phase |
| | space point (or extreme point) α₀ ∈ E. |
| 2. | For all Pauli measurements Tₐ_{ₜ}, aₜ ∈ V, from t = 1 to t = tₘₐₓ, sample from qₐ_{_{t−1}}_{,a=a}_{ₜ} |
| | to obtain the new phase space point (or extreme point) αₜ ∈ E and measurement |
| | outcome s. Output s as the outcome (simulated measurement outcome) for the |
| | measurement of Tₐ_{ₜ}, update the phase space point αₜ₋₁ → αₜ, and increment t → t + |
| | 1. |

That is, the magic state quantum computation may include first measurement, a Pauli
measurement, the effect of which is classically simulated by sampling from a probability
distribution q_{α}_{₀}_{,a=a}_{₁} = P₁, and a second measurement, also a Pauli measurement and
performed after the first measurement, whose effect is classically simulated by sampling
from a probability distribution q_{α}_{₁}_{,a=a}_{₂} = P₂. Similarly, further measurements, such as
a 3^{rd} measurement, 4^{th} measurement, etc., may be classically simulated by sampling from
corresponding probability distributions P₃, P₄, etc.

4.3. Updating Phase Points

Scaling arguments as well as numerical results suggest that the number of vertices of Δ₁, grows rapidly with n. Do we need an efficient description and update rules for all of them? This turns out to be not the case. It may suffice to consider an update of small subsets of vertices, especially when the quantum algorithm to be simulated has a high probability of success.

Denote by A₀ a set of phase point labels α₀ which are all efficiently representable and updatable (a phase point label can be understood as a label, index or other classical information representing an extreme point of the convex operator set Δ). P(A₀) denotes the total probability weight concentrated A₀, and P_{S} the success probability of the quantum computation under consideration. Finally, P(S∩A₀) is the probability of an α₀∈A₀ drawn as a random sample from p_{ρ}_{_{M}} in a single round, and the subsequent classical simulation based on α₀ leading to success. That is,

$$P ( {A}_{0} ) := {\sum }_{α ∈ {A}_{0}} {p}_{{ρ}_{M}} ( α ) , P ( S ⋂ {A}_{0} ) := {\sum }_{α ∈ {A}_{0}} {p}_{{ρ}_{M}} ( α ) p ( S \vert α ) .$$

We may then define the conditional probability

$$P ( S \vert {A}_{0} ) := \frac{P ( S ⋂ {A}_{0} )}{P ( {A}_{0} )} .$$

The operational meaning of P(S|A₀) is the following. If we renormalize the probabilities in the set Δ₀ to p_{ρ}_{_{M}}(α)/P(A₀) (such that the renormalized total probability is 1), then P(S|A₀) is the probability of achieving success in a single round of classical simulation, based on a sample drawn from A₀ according to the renormalized probabilities.
Theorem 3 Consider a set A₀ of phase point labels which occur with non-zero probability in the expansion of the magic state ρ_{M} (input quantum state), and the capability to draw samples from A₀ according to the probability distribution p_{ρM}(⋅)/P(A₀). Then,

$$P ( S \vert {A}_{0} ) \geq 1 - \frac{1 - {P}_{s}}{P ( {A}_{0} )} . \qquad ( 9 )$$

Theorem 3 gives a performance guarantee for the simulation whenever the total probability of the set Δ₀ is larger than the failure probability 1−P_{S} of the quantum computation in question. In the limit of A₀=Eₙ, Theorem 3 reproduces (in slightly weakened form) the earlier Theorem 2. A limit of particular interest is P_{S}=1 (the quantum computation/algorithm simulated succeeds with probability 1). In that case, the success probability P(S|A₀) of classical simulation by sampling is also 1, for any non-empty set A₀ of phase point labels. In this case, it suffices to choose a set A₀ containing a single phase point label a, and it is of advantage to choose a label that is particularly easy to update under Pauli measurement (subject to the constraint that A₀={α} must be in the support of a P_{ρ}_{_{M}} representing ρ_{M}).

The result extends from deterministic quantum algorithms to quantum algorithms with high success probability. As long as the failure probability is smaller (by a factor >1) than the probability weight P(A₀) concentrated in the set A₀, then a substantial probability of success can be guaranteed for the simulation by sampling.

Thereby, the question “Can we efficiently classically update all vertices of Δₙ under Pauli measurement?” can be transformed into a simpler question “Can we efficiently classically update some vertices of Δₙ under Pauli measurement?” (namely those in an admissible set Δ₀).

4.4. The Phase Point Operators of Ref [10]

Regarding the last question and ignoring the constraint in the bracket for a moment, we observe that efficiently updatable vertices do indeed exist. Namely, the phase point operators of [10] are precisely of this kind. Recall from [10] a couple of definitions. The vector space Vₙ= [symbol] ₂²ⁿ comes with a symplectic form [⋅,⋅]:Vₙ×Vₙ→ [symbol] ₂ defined by [a, b]:=a_{Z}^{T}b_{X}+a_{X}^{T}b_{Z}, ∀a=(a_{Z}, a_{X}), b=(b_{Z}, b_{X})∈ [symbol] ₂ⁿ× [symbol] ₂ⁿ. This symplectic form tracks the commutator of the Pauli observables in the sense that two Pauli operators, Tₐ and T_{b}, commute if and only if [a, b]=0. Because of this relation, we will say that a, b∈Vₙ commute when [a, b]=0. An isotropic subspace Ĩ of Vₙ is a subspace with the property that [a, b]=0 ∀a, b∈Ĩ.

We call a set Ω⊂Vₙ closed under inference if for all a, b∈Ω with the property that [a, b]=0 it holds that a+b∈Ω. We call a set Ω⊂Vₙ non-contextual if it supports a non-contextual value assignment. Sets Ω which are both closed under inference and non-contextual are called “cnc”. Of particular interest in [10] are maximal cnc sets, which are cnc sets that are not strictly contained in any other cnc set. They give rise to the following multi-qubit phase point operators

$${A}_{Ω}^{γ} = \frac{1}{{2}^{n}} {\sum }_{a ∈ Ω} {( - 1 )}^{γ ( a )} {T}_{a} , \qquad ( 10 )$$

where Ω is a maximal cnc set, and γ: Ω→ [symbol] ₂.

We now have the following result.

Theorem 4 For any number n of qubits, the phase point operators A_{Ω}^{γ} of Eq. (10) are vertices (extreme points) of Δₙ.

For n qubits, consider an isotropic subspace Ĩ⊂Vₙ of dimension n−m, with m≤n, and ξ≤2m+1 elements aₖ∈Vₙ that pairwise anti-commute but all commute with Ĩ. Denote Iₖ:= [symbol] aₖ, Ĩ [symbol] for k=1, . . . , ξ. As demonstrated in Lemma 3 of [10], for any number n of qubits, the sets

$$Ω = {⋃}_{k = 1}^{ξ} {I}_{k} \qquad ( 11 )$$

are non-contextual and closed under inference (cnc). Furthermore, we have the following result (see Theorem 1 of [10]).
Theorem 5 All maximal cnc sets Ω are of the form Eq. (11), with ξ=2m+1 and 1≤m≤n.

To describe the dynamics under measurement, we set up some further notation. For every set Ω we introduce the derived set Ω×a. Denoting Comm(a) {b∈Vₙ|[a, b]=0} and Ωₐ:=Ω∩Comm(a),

Ω×a:=Ωₐ∪{a+b|b∈Ωₐ},∀a∉Ω. (12)

Likewise, we define an update on functions γ invoking the measurement outcome sₐ of an observable Tₐ, namely (⋅)×sₐ:(γ:Ω→ [symbol] ₂) [symbol] (γ×sₐ:Ω×a→ [symbol] ₂). We define this update only for (Ω,γ)∈ [symbol] , and only for a∉Ω. The updated function γ×sₐ:Ω×a→ [symbol] ₂ is given by

γ×sₐ(b):=y(b),∀b∈Ωₐ, (13a)

γ×sₐ(b):=γ(a+b)+sₐ+β(a,b),∀a+b∉Ωₐ. (13b)

For the phase point operators of Eq. (10) we then have the following update rules (see Lemma 5 of [10]).
Lemma 1 Denote the projectors Pₐ(sₐ):=(I+(−1)^{s}^{ₐ})/2, and be A_{Ω}^{γ} a phase point operator defined through Eq. (10), with Ω being cnc and γ a consistent value assignment. Then, the effect of a measurement of the Pauli observable Tₐ with outcome sₐ on A_{Ω}^{γ} is

$${P}_{a} ( {s}_{a} ) {A}_{Ω}^{γ} {P}_{a} ( {s}_{a} ) = {δ}_{{s}_{a} , γ ( a )} \frac{{A}_{Ω}^{γ} + {A}_{Ω}^{γ + [ a , \cdot ]}}{2} , \qquad ( 14 a )$$

$$if a ∈ Ω ,$$

$${P}_{a} ( {s}_{a} ) {A}_{Ω}^{γ} {P}_{a} ( {s}_{a} ) = \frac{1}{2} {A}_{Ω \times a}^{γ \times {s}_{a}} , \qquad ( 14 b )$$

$$if a ∉ Ω .$$

This update is computationally efficient, cf. Theorem 3 of [10].

4.5. Constraints on Admissible Sets A_{Ω}

As described above, it suffices to be able to update some phase points under measurement rather than all, and we have further shown that efficiently updatable vertices exist for all n. Another question is: are there any constraints on admissible sets A₀ in Theorem 3? It turns out that there are indeed some. They derive from the fact that A₀ must be in the support of p_{ρ}, for some p_{ρ} representing ρ. While there are many such probability functions, that doesn't eliminate all constraints. Specifically, we have the following result for the magic state ρ_{n×T}=|T [symbol] [symbol] T|^{⊗n} (with |T [symbol] =(|0 [symbol] +e^{iπ/4}|1 [symbol] ))/\sqrt{2}),

Theorem 6 For all integers n≥2, it holds that ρ_{n×T}∈∂(Δₙ), where ∂(Δₙ) is the boundary of the convex operator set Δₙ.

That is, the magic state ρ_{n×T} is an element of one or numerous walls of the polytope Δₙ (upon further inspection, the latter is found to be the case), and thus lives inside a sub-polytope in the boundary of Δₙ. The only vertices that can appear with non-zero probability weight in any expansion p_{ρ}_{_{n×T}} are the vertices of that sub-polytope. This imposes some conditions on the set of vertices that we can choose for the classical simulation of deterministic quantum algorithms.

4.6. The Size Parameter

As discussed in section 2, the input size of a computational problem can be characterized by a size parameter. The form of the size parameter can depend on the description of the computational problem to be solved.

For example, the computational problem could be described as a magic state quantum computation, that is, as a quantum circuit where the input quantum state contains a first quantum state, a K-qubit Pauli stabilizer state ρ₀, and a second quantum state, a N-qubit magic state ρ_{M}. In this case, the size parameter could be related to N, the size of the second quantum state. If the second quantum state is the tensor product of N states |T> (denoted above as the state ρ_{N×T}) then the number N of states |T> in the input quantum state could serve as the size parameter. Different magic states could also be used which could give different size parameters.

Another example is if the computation is described as a quantum circuit in the circuit model using the Clifford+T gate set. In this case, the number of T gates in the circuit could serve as the size parameter for the problem. Again, different gate sets could be used with different non-Clifford gates which could lead to different size parameters.

The size parameter could also come from a higher-level description of the computational problem to be solved. For example, in the case of Shor's algorithm for factoring integers, the size parameter could be related to the size (number of bits) of the integer to be factored.

4.7. The Computational Key

We now describe the computational key. The computational key may be understood as classical data which unlocks quantum computational power. That is, the computational key allows the simulation of one or more quantum computations through post-processing on the data contained in the computational key. These quantum computations could be used to solve computational problems. The computational key depends on a size parameter which is characteristic of the input size of the computational problem.

For example, a computational key can be based on the family of probability distributions described in section 4.2. An example of a possible key is described as follows: suppose we have a computational problem to be solved which can be described as a magic state quantum computation where the input quantum state contains a first quantum state, namely a K-qubit Pauli stabilizer state ρ₀, and a second quantum state, namely a N-qubit magic state ρ_{M}, for example the state ρ_{N×T} described above. In this example, the size parameter of the computational problem could be the number N of magic states, i.e., the number N of single-qubit states included in the state ρₘ. The computational key could include samples, or a procedure (quantum or otherwise) to sample, from a probability distribution pᵢₙₚᵤₜ(⋅)/P(A₀):A₀→ [symbol] _{≥0}, support for a suitable set A₀ that is in the of Pᵢₙₚᵤₜ:Eₙ→ [symbol] _{≥0}. Here Pᵢₙₚᵤₜ is a probability distribution over the labels Eₙ of the extreme points of the convex operator set Δₙ describing the magic second quantum state above. The set Δ₀ could contain only a single vertex, A₀={α}. This suffices for the simulation of all deterministic quantum algorithms describable as magic state quantum computations up to a given input size. The set Δ₀ could also contain of a plurality of the extreme points of Δₙ. With Theorem 3, the larger the total probability weight P(A₀) the lower the threshold in the success probability of the simulated quantum algorithms for which a performance guarantee can be given. On the other hand, the larger A₀ the more complicated (a priori) the sampling from Pᵢₙₚᵤₜ/P(A₀) can be, and the more likely it becomes to encounter a sample for which the post-processing has a long runtime. In the opposite limit, the set A₀ could be the full support of the probability distribution Pᵢₙₚᵤₜ. In this case P(A₀)=P(Eₙ)=1 and the probability distribution to be sampled is Pᵢₙₚᵤₜ(⋅):Eₙ→ [symbol] _{≥0}.

In addition to containing samples from the probability distribution describing the input quantum state, the computational key could also contain the probability weight of each sample and/or instructions for how to update the extreme points of the convex operator set Δₙ after a measurement.

Note that in the example above the computational key depends only on the size parameter of the computational problem, not on the specific computational problem being solved. Because of this property, this same computational key can be reused for different computational problems as long as the size parameter of each is less than or equal to the size parameter of the initial computational problem. This can be useful in multiple ways.

For example, consider, as an application, a scheme in which a first system communicates a size parameter S1 of a computational problem to a second system, the second system returns a computational key, and the first system simulates the quantum computation through post-processing on the computational key. Then the first system does not need to request a new computational key for each computational problem it encounters.

The first system can reuse the same computational key to solve multiple computational problems. If the second system subsequently receives a request for a computational key from a third system for a size parameter S2 which is less than or equal to S1, the second system does not need to compute another key. The second system could send to the third system the same key that was sent to the first system. Also, since the first system also now has access to the computational key the third system could instead request the computational key from the first system and the first system could send the computational key. Alternatively, the second system could issue the key directly to the third system upon receiving the size parameter S1 from the first system.

4.8. Probability Distribution Representing the Magic State

Related to the above discussion, we now turn to the problem of determining the probability distribution p_{ρ} (also denoted as Pᵢₙₚᵤₜ) representing the initial magic state ρ, i.e. the quantum input state. Given a quantum state ρ, a valid probability distribution pₚ:Eₙ→ [symbol] _{≥0} can be found by solving the linear program

$${min}_{p , u , v} \{ {\sum }_{b ∈ {V}_{n}} {u}_{b} + {v}_{b} \vert ρ = {\sum }_{b ∈ {V}_{n}} ( {u}_{b} - {v}_{b} ) {T}_{b} + {\sum }_{α ∈ {E}_{n}} p ( α ) {A}_{α} , {u}_{b} , {v}_{b} \geq 0 ∀ b ∈ {V}_{n} , p ( α ) \geq 0 ∀ α ∈ {E}_{n} \} . \qquad ( 15 )$$

This is known as the auxiliary problem in linear programming [34], or phase 1 of the two phase simplex method.

If among the vertices of Δₙ there is a subset of preferred vertices Eₙ*⊂Eₙ, we can find a probability distribution p_{ρ} which maximizes the weight of vertices in this set by instead solving the linear program

$${max}_{p} \{ {\sum }_{α ∈ {E}_{n}^{*}} p ( α ) \vert ρ = {\sum }_{α ∈ {E}_{n}} p ( α ) {A}_{α} , p ( α ) \geq 0 ∀ α ∈ {E}_{n} \} . \qquad ( 16 )$$

In these two linear programs there is a variable for each phase point a∈Eₙ. The number of variables needed for the problems can be reduced (and hence the complexity of finding p_{ρ} can be reduced) if the state ρ lies on the boundary of Δₙ. To see why, note that if we have an expansion of a state ρ in terms of the vertices of Δₙ

$$ρ = {\sum }_{α ∈ {E}_{n}} p ( α ) {A}_{α} ,$$

then multiplying this equation by a Pauli stabilizer state |σ [symbol] [symbol] σ| and taking a trace we have

$$Tr ( \vert σ 〉 〈 σ \vert ρ ) = {\sum }_{α ∈ {E}_{n}} p ( α ) Tr ( \vert σ 〉 〈 σ \vert {A}_{α} ) .$$

Since the coefficients p(α) are all nonnegative, if the left hand side of this equation is zero then for any a∈Eₙ with p(α)>0 we must have Tr(|σ [symbol] [symbol] σ|A_{α})=0. That is, any vertex A_{α} that can appear with nonzero weight in the expansion of a state ρ must be orthogonal to any stabilizer state that is orthogonal to ρ. If ρ is on the boundary of Δₙ then there is a nonempty set of stabilizer states orthogonal to ρ and so in looking for an expansion of ρ in the vertices of Δₙ we can restrict our attention to vertices in the set {α∈Eₙ|Tr(|σ [symbol] [symbol] σ|A_{α})=0 ∀|σ [symbol] ∈S_{ρ}} [symbol] Eₙ where S_{ρ} is the set of stabilizer states orthogonal to ρ.

### 5. Procedures

5.1. Overview of the Scheme

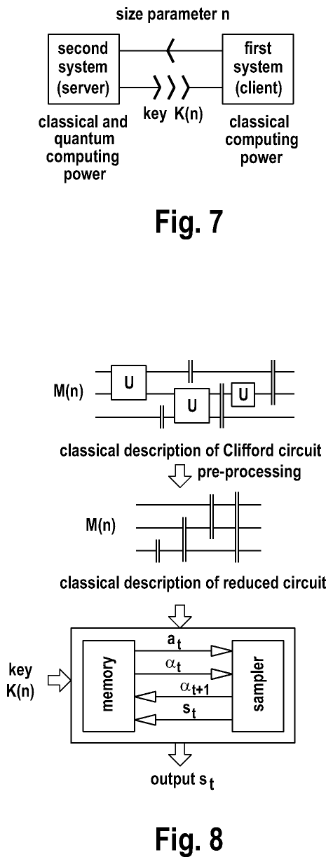

Embodiments of the present disclosure are illustrated in FIGS. 7 and 8. FIG. 7 represents the overall architecture, in which a classical computational key unlocks the quantum computing power of n magic states. The first system (client) determines the size parameter of the quantum computation, and sends it to the second system (server). The server generates the computational key which unlocks quantum computational capability for classical hardware, up to size n in terms of the number of magic states used, and sends it to the client. The client uses the computational key to classically simulate the quantum computation at hand.

FIG. 8 describes the information flow of the described simulation technique. A classical description of a Clifford circuit using M (n), i.e., n copies of magic states is inputted, along with the computational key K(n), a classical message generated by the server. The classical description of the quantum circuit is first processed to produce an equivalent circuit in which all Clifford unitaries have been eliminated, and only Pauli measurements remain. This circuit description, along with the key K(n) is now inputted into the central processing unit executing the classical simulation, consisting of a memory to hold a phase space point αₜ∈E at any given moment, as well as the sequence of Pauli measurements constituting the computation.

5.2. Quantum Computation Description Conversion

The method as described herein is based on the framework of quantum computation with magic states (QCM). Most quantum algorithms in the literature are described in the circuit model of quantum computation. Given a description of a computation to be performed in the circuit model, a first phase involves converting the description of the computation into an equivalent description in the QCM framework.

A description of a quantum computation in the circuit model may consist of a specification of which quantum gates and measurements are to be performed on which qubits. If the gate set of the circuit is the universal Clifford+T set, where T=exp (iπ/8 Z), then the conversion can be done directly, for example using the state injection circuit FIG. 10.25 of [35] to substitute a magic state of the form |T [symbol] =T|+ [symbol] for each T gate in the circuit.

If a different gate set is used then the circuit can first be converted into one using the Clifford+T gate set, a process known as quantum gate synthesis. There exist open source software packages for quantum gate synthesis, for example newsynth (hackage.haskell.org/package/newsynth). This software can be used to trade any non-Clifford gate for a combination of Clifford gates and T gates. The T gates can then be traded for |T [symbol] states to obtain a magic state quantum computation. (Note that converting to the Clifford+T gate set is not necessary to perform the method of the present disclosure. Different magic states could be used to implement any non-Clifford gate directly and a probability distribution of the form eq. (6) could be defined for these states as well. This is merely an example of how to apply the results of section 4 to a model of universal quantum computation.) If a different gate set is used, then it may come with its own magic states that are different from T-states. Then, the system 2 (server) may also provide key based on those different magic states.

5.3. Finding the Vertices [symbol] ₙ and the Probability Distribution p_{ρ}

A systematic way to determine the vertices of the polytope Δₙ and then to find a nonnegative decomposition of the magic state ρ in terms of the vertices of Δₙ is provided in the following.

5.3.1. Finding Vertices

The polytope Δₙ is defined as the intersection of a set of half spaces:

Δₙ:={X∈O(2ⁿ)|Tr(|σ [symbol] [symbol] σ|X)≥0,∀|σ [symbol] ∉ [symbol] ₙ}.

This is known as the H-representation of the polytope. By the Weyl-Minkowski theorem, this polytope has an equivalent description as the convex hull of its vertices, Δₙ=Conv( [symbol] ₙ). This is known as the V-representation. Converting between these representations for bounded convex polytopes can be achieved by software packages devoted to this problem, including lrslib (cgm.cs.mcgill.ca/—avis/C/lrs.html), cddlib (github.com/cddlib/cddlib), and polymake (www.polymake.org). Given as input the inequalities that define the polytope, these packages can compute the vertices (extreme points) of the polytope.

5.3.2. Finding Probability Representations

When the vertices of the polytope Δₙ have been determined, the probability distribution p_{ρ} over the vertices that represents the magic state ρ can be determined This is achieved by solving one of the linear programs eq. (15) or eq. (16). Classical linear programming algorithms tend to be efficient in the number of variables in practice. For the two problems above, the number of variables may be large. Linear programming is also addressed in mathematical optimization with many highly optimized software packages, including open source software like GLPK (www.gnu.org/software/glpk) as well as commercial software such as Gurobi (www.gurobi.com).

5.4. Update of Vertices Under Measurement

Below we describe the update of vertices under Pauli measurement.

5.4.1. The Vertices from [10]

Here we describe the efficient update of phase point operators of type [10] under Pauli measurement. This amounts to the simulation algorithm displayed in Table 1 for the case when the computational key used in step 1 corresponds to a phase point operator of this type. Ref [10] established that the polytope spanned by these vertices is closed under Pauli measurement (Theorem 2 therein), the update rules were given (Lemma 5 in [10]), and the phase points were classified (Theorem 1 in [10]). However, it was not explicated in [10] how the vertex description, after measurement, is brought back into the normal form provided by the classification. This is provided here.

A vertex of the type discussed in Section 4.4 is described by
Two integer parameters, m and n, with m≤n.
An isotropic subspace Ĩ⊂ [symbol] ₂²ⁿ,

Ĩ= [symbol] i₁,i₂, . . . ,iₙ₋ₘ [symbol] .
A set {a₁, a₂ₘ₊₁} with the properties that (i) [aᵢ, aⱼ]≠0 for all i≠j, and (ii) [aᵢ, Ĩ]=0 for all i. The set Ω in the definition of the vertex A_{Ω}^{γ}, is then given by Eq. (11).
A consistent value assignment γ:Ω→ [symbol] ₂. Because of consistency, it suffices to store {γ(i₁), . . . γ(iₙ₋ₘ); γ(a₁), . . . , γ(a₂ₘ₊₁)}. The other values follow from consistency, and are efficiently computable.

An efficient procedure for update under the measurement of a Pauli observable Tₓ is provided in the following.
1. If x∈Ω (efficiently testable) then the measurement output is deterministic, sₓ=γ(x), and the update of the phase point operators proceeds according to Eq. (14a). That is, the set Ω doesn't change at all, and the function γ is updated probabilistically (50/50 coin flip). Either it remains unchanged, or is updated to γ+[x,⋅], with [⋅,⋅] the symplectic form defined herein. In the latter case, the update is accomplished by

γ(iₗ)→γ(iₗ)+[x,iₗ]mod 2,γ(aₖ)→γ(aₖ)+[x,aₖ] mod 2,∀k,l.
2. If x∉Ω, then the outcome sₓ is completely random (50/50). Then both Ω and γ need to be updated. There are two subcases:
   a. [x, Ĩ]=0 (x commutes with each element of the isotropic subspace Ĩ). Then, (i) Ĩ remains unchanged, (ii) all aᵢ are dumped and replaced by x, {a₁, . . . a₂ₘ₊₁}→{x}, (iii) m→0, and (iv) the description of γ is updated

{γ(i₁), . . . γ(iₙ₋ₘ);γ(a₁), . . . γ(aₙ₋ₘ)}→{γ(i₁), . . . γ(iₙ₋ₘ);γ(x):=sₓ}.
b. [x,Ĩ]≠0. Then, (i) Ĩ→Ĩ∩Comm(x). In terms of the generators of Ĩ, there must be one that does not commute with x; denote it by y. Then,
   i. Ĩ is updated according to

Ĩ= [symbol] i₁, . . . ,iₙ₋ₘ [symbol] → [symbol] iₖ+y[iₖ,x],∀k [symbol] ,
eliminating the “0” from the generators.
ii. The aᵢ are updated according to

aᵢ→aᵢ+y[aᵢ,x] mod 2.
iii. m→m.
iv. The update of γ proceeds as follows. If iₖ commutes with x then γ(iₖ) remains in the generating set. If iₖ does not commute with x, then γ(iₖ) is replaced by

γ(iₖ+y)=γ(iₖ)+γ(y)+β(iₖ,y)mod 2;
see [10], Eq. (5) for the definition of the function β.

5.4.2. Vertices for 2-Qubit Case and their Update Under Measurement

The analysis in this section regards the case of 2 qubits. Let [symbol] (V) denote the collection of maximal isotropic subspaces of V=V₂. A vertex can be constructed using the following recipe:
Fix a maximal isotropic subspace

I= [symbol] i₁,i₂ [symbol] .
Construct a collection [symbol] ⊂ [symbol] (V) of maximal isotropics according to the rule
   [symbol] contains I,
   for each J∈ [symbol] and 0≠v∈J exactly one of the subspaces in {J′∈ [symbol] (V)−{J}|v∈J′} is contained in [symbol] .
Compute the union of the subspaces in [symbol] and omit 0

$${Ω}^{⊥} = ( {⋃}_{I ∈ C} J ) - \{ 0 \} .$$

Set Ω to be the difference V−Ω^{⊥}.
Choose a value assignment γ′:I→ [symbol] ₂ by specifying {γ(i₁), γ(i₂)}.
Construct the unique value assignment γ′:I→ [symbol] ₂ with the property that

γ′(v)+γ′(w)+β(v,w)=γ(v+w)
for all v, w∈Ω such that v+w∈I.
Construct another value assignment γ″:Ω→ [symbol] ₂ by setting γ″(v)=γ′(v)+1 for all v∈Ω−{0} and y″(0)=0.
   Bringing these components together the vertex is defined by

$${A}_{I , Ω}^{γ} = {A}_{I}^{γ} + \frac{1}{4} ( {A}_{Ω}^{{γ}^{′}} - {A}_{Ω}^{{γ}^{″}} ) .$$

In summary, the vertex is specified by (I,γ, [symbol] ). Counting these: 15 maximal isotropics, 2² value assignments, 2⁵ collections [symbol] gives a total of 1920=15×2⁷ vertices.

Let us describe update under a measurement corresponding to the projector P_{a,s}_{ₐ}. We write pₐ(sₐ)=Tr(A_{l,Ω}^{γ}P_{a,s}_{ₐ}) for the probability of obtaining outcome sₐ. We begin with the following preliminary steps:
Construct the subspace

[symbol]

a [symbol] ^{⊥}= [symbol] a,\tilde{v},\tilde{w} [symbol] .
Construct \tilde{Ω} from Ω by adding elements of the form v+w where v·w∈Ω−{0}.
Construct \tilde{γ}′:\tilde{Ω}→ [symbol] ₂ by extending γ′ to elements of the form v+w where v,w∈Ω−{0} by setting

\tilde{γ}(v+w)=γ′(v)+γ′(w)+β(v,w).
Similarly extend γ″ to obtain \tilde{γ}″:\tilde{Ω}→ [symbol] ₂.
   There are essentially three cases to consider. In each case under update the result is a vertex of type [10] where (m, n)=(1,2).
1. a∈I and a∉Ω.

$$γ ( a ) \neq {s}_{a} {p}_{a} ( {s}_{a} ) = 0 \qquad a .$$

$$since$$

$${P}_{a , s} {A}_{I , Ω}^{γ} {P}_{a , s} = 0.$$

$$γ ( a ) = {s}_{a} {p}_{a} ( {s}_{a} ) = 1 , \qquad b .$$

$$\frac{{P}_{a , s} {A}_{I , Ω}^{γ} {P}_{a , s}}{Tr ( {A}_{I , Ω}^{γ} {P}_{a , s} )} = \frac{2 {A}_{{〈 a 〉}^{⊥}}^{{\tilde{α}}_{0}} + {A}_{{〈 a 〉}^{⊥}}^{{\tilde{α}}_{1}} + {A}_{{〈 a 〉}^{⊥}}^{{\tilde{α}}_{2}}}{4}$$

$${\tilde{α}}_{0} ( a ) = {\tilde{α}}_{1} ( a ) = {\tilde{α}}_{2} ( a ) = {s}_{a}$$

$${\tilde{α}}_{0} ( \tilde{v} ) = {\tilde{α}}_{1} ( \tilde{v} ) = {\tilde{α}}_{2} ( \tilde{v} ) = γ ( \tilde{v} )$$

$${\tilde{α}}_{0} ( \tilde{w} ) = {\tilde{α}}_{1} ( \tilde{w} ) = 1 + {\tilde{α}}_{2} ( \tilde{w} ) = {\tilde{γ}}^{′} ( \tilde{w} )$$

$$1 + {\tilde{α}}_{0} ( \tilde{v} + \tilde{w} ) = {\tilde{α}}_{1} ( \tilde{v} + \tilde{w} ) = {\tilde{α}}_{2} ( \tilde{v} + \tilde{w} )$$

2. a∉I and a∈Ω.

$${\tilde{γ}}^{′} ( a ) \neq {s}_{a} {p}_{a} ( {s}_{a} ) = 1 / 4 , \qquad a .$$

$$\frac{{P}_{a , s} {A}_{I , Ω}^{γ} {P}_{a , s}}{Tr ( {A}_{I , Ω}^{γ} {P}_{a , s} )} = {A}_{{〈 a 〉}^{⊥}}^{{\tilde{α}}^{′}}$$

$${\tilde{α}}^{′} ( a ) = {s}_{a}$$

$${\tilde{α}}^{′} ( \tilde{v} ) = {\tilde{γ}}^{″} ( \tilde{v} )$$

$${\tilde{α}}^{′} ( \tilde{w} ) = 1 + {\tilde{γ}}^{″} ( \tilde{v} )$$

$${\tilde{α}}^{′} ( \tilde{v} + \tilde{w} ) = 1 + {\tilde{γ}}^{″} ( \tilde{v} + \tilde{w} )$$

$${\tilde{γ}}^{′} ( a ) = {s}_{a} {p}_{a} ( {s}_{a} ) = 3 / 4 , \qquad b .$$

$$\frac{{P}_{a , s} {A}_{I , Ω}^{γ} {P}_{a , s}}{Tr ( {A}_{I , Ω}^{γ} {P}_{a , s} )} = \frac{2 {A}_{{〈 a 〉}^{⊥}}^{\tilde{α}} + {A}_{{〈 a 〉}^{⊥}}^{{\tilde{α}}^{′}}}{2}$$

$$\tilde{α} = {\tilde{γ}}^{′}$$

$${\tilde{α}}^{′} ( a ) = {s}_{a}$$

$${\tilde{α}}^{′} ( \tilde{v} ) = {\tilde{γ}}^{′} ( \tilde{v} )$$

$${\tilde{α}}^{′} ( \tilde{w} ) = 1 + {\tilde{γ}}^{′} ( \tilde{v} )$$

$${\tilde{α}}^{′} ( \tilde{v} + \tilde{w} ) = 1 + {\tilde{γ}}^{′} ( \tilde{v} + \tilde{w} )$$

3. a∉I and a∈Ω.

$${\tilde{γ}}^{′} ( a ) \neq {s}_{a} {p}_{a} ( {s}_{a} ) = 1 / 2 , \qquad a .$$

$$\frac{{P}_{a , s} {A}_{I , Ω}^{γ} {P}_{a , s}}{Tr ( {A}_{I , Ω}^{γ} {P}_{a , s} )} = \frac{{A}_{{〈 a 〉}^{⊥}}^{{\tilde{α}}_{0}} + {A}_{{〈 a 〉}^{⊥}}^{{\tilde{α}}_{1}}}{2}$$

$${\tilde{α}}_{0} ( a ) = {\tilde{α}}_{1} ( a ) = {s}_{a}$$

$${\tilde{α}}_{0} ( \tilde{v} ) = {\tilde{α}}_{1} ( \tilde{v} ) = γ ( \tilde{v} )$$

$${\tilde{α}}_{1} ( \tilde{w} ) = 1 + {\tilde{α}}_{0} ( \tilde{w} )$$

$${\tilde{α}}_{1} ( \tilde{v} + \tilde{w} ) = 1 + {\tilde{α}}_{0} ( \tilde{v} + \tilde{w} ) .$$

$${\tilde{γ}}^{′} ( a ) = {s}_{a} {p}_{a} ( {s}_{a} ) = 1 / 2 , \qquad b .$$

$$\frac{{P}_{a , s} {A}_{I , Ω}^{γ} {P}_{a , s}}{Tr ( {A}_{I , Ω}^{γ} {P}_{a , s} )} = \frac{{A}_{{〈 a 〉}^{⊥}}^{{\tilde{α}}_{0}} + {A}_{{〈 a 〉}^{⊥}}^{{\tilde{α}}_{1}}}{2}$$

$${\tilde{α}}_{0} ( a ) = {\tilde{α}}_{1} ( a ) = {s}_{a}$$

$${\tilde{α}}_{0} ( \tilde{v} ) = {\tilde{α}}_{1} ( \tilde{v} ) = γ ( \tilde{v} )$$

$${\tilde{α}}_{0} ( \tilde{w} ) = {\tilde{α}}_{1} ( \tilde{w} ) = {\tilde{γ}}^{′} ( \tilde{w} )$$

$$1 + {\tilde{α}}_{0} ( \tilde{v} + \tilde{w} ) = {\tilde{α}}_{1} ( \tilde{v} + \tilde{w} ) .$$

Note that a∈I and a∈Ω does not occur since I∩Ω=0.

5.4.3 A General Algorithm for Updating Vertices Under Measurement

Here we describe a procedure for updating any vertex of Δₙ under Pauli measurements for any n∈ [symbol] . Suppose the current phase space point in the simulation is a and the measurement to be simulated is Tₐ. We represent the phase space point by its corresponding phase point operator A_{α}∈ [symbol] ₙ—a vertex of the convex operator set Δₙ. To update the phase point under the measurement, perform the following steps:
1. Compute the value pₐ(1):=Tr(P_{a,1}A_{α}) where P_{a,1}=(I−Tₐ)/2 is the projector onto the eigenspace of the operator Tₐ with eigenvalue −1.
2. Sample from the Bernoulli distribution with parameter pₐ(1) to obtain a measurement outcome s=1 with probability pₐ(1) or s=0 with probability pₐ(0)=1−pₐ(1). Return s as the simulated measurement outcome.
3. Compute the operator X_{a,s}′:=P_{a,s}AₐP_{a,s}/pₐ(s)
4. By Lemma 5 in Appendix A, X_{a,s}′∈Δₙ. Therefore, there exists a probability function p_{x′}_{_{a,s}}:Eₙ→ [symbol] _{≥0} representing X_{a,s}′. I.e.

$${X}_{a , s}^{′} = {\sum }_{β ∈ {E}_{n}} {p}_{{X}_{a , s}^{′}} ( β ) {A}_{β} .$$

Such a probability distribution can be found using linear programming as demonstrated in section 4.8. Find such a probability distribution and sample from it to obtain a new phase space point β.
5. Update the phase space point as a α [symbol] β.

5.5. Example, Technical Version

The example given in Section 2 is revisited here, and a more detailed description thereof is provided. This simple example is given for the sake of illustration, but the present disclosure applies to quantum computations of arbitrary complexity.
a) Representing the quantum circuit. Denote U_{z}(α):=exp(iα Z), S:=U_{z}(π/4), T:=U_{z}(π/8) and |T [symbol] =T|+ [symbol] . Further, we define the two Pauli observables

O(0):=−Y,O(1):=X.

Then, the circuit considered is the following.

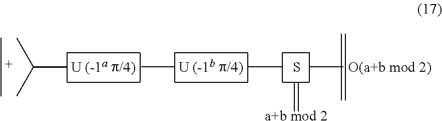

It computes the Boolean function ƒ(a, b)=ab.
b) Conversion of the quantum computation into a magic state quantum computation. We use the identity U_{z}((−1)^{a}π/8)|+ [symbol] =X^{a}|T [symbol] , and the general identity [35] for the injection of magic states,

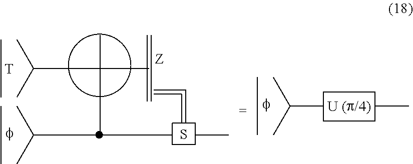

Using these identities in the circuit of Eq. (17), we obtain

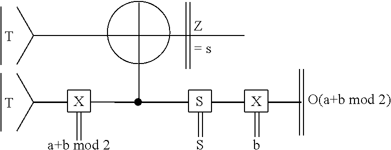

For now we apply one further modification to this circuit, namely we propagate out the non-conditional Clifford gates; in this case the CNOT. The result is

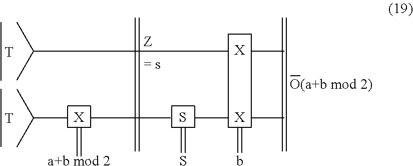

Therein, the observable Ō(⋅) is

Ō(0)=−X₁⊗Y₂,Ō(1)=X₁⊗X₂.
The remaining conditional Clifford gates are propagated out at runtime of the algorithm, i.e., once the input is known and the measurement outcomes become known.
To continue this example, we assume the input is a=b=0. In this case, the circuit specializes to

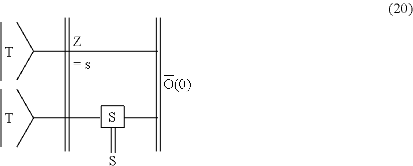

The outcome of the Z₁⊗Z₂ measurement is random. Assume for this example that the outcome obtained is s=1. Then, using the identity S^{†}YS=−X, we obtain the measurement sequence

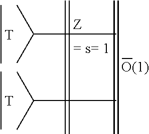

The eigenvalue measured in the final measurement is +1 with certainty; hence the computational outcome is 0, as it should.
c) The probability distribution associated with the input quantum state of the magic state quantum computation. One vertex that occurs with non-zero probability in the expansion of the magic state |T [symbol] [symbol] T|^{⊗2}. One such vertex, in the notation of Section 5.4.1, is given by the isotropic subspace Ĩ= [symbol] a_{X}_{₂} [symbol] , the generators of the cosets {a_{X}_{₁}, a_{Y}_{₁}, a_{Z}_{₁}}, and the value assignment y specified by

γ(a_{X}_{₂})=γ(a_{X}_{₁})=γ(a_{Y}_{₁})=γ(a_{Z}_{₁})=0.
We denote the phase point specified by this information as α₀.
d) Constructing the computational key. As the present computation is deterministic, with Theorem 3, the vertex α₀ presented in step 3 may constitute the full key for all deterministic MQCs on two magic states |T [symbol] .
e) Classical simulation in A. The starting point is the circuit Eq. (20). The magic state |T [symbol] [symbol] T|^{⊗2} therein is now represented by α₀. The first step in the simulation is the simulation of the measurement of Z⊗Z. Since a_{Z}_{₁}_{Z}_{₂}∉Ω(α₀), the measurement outcome s is random, as we also observed above. Keeping in sync with the corresponding assumption made earlier, here too we assume that the outcome of the ZZ-measurement is s=1.
   Also because of a_{Z}_{₁}_{Z}_{₂}∉Ω(α₀), the update relation Eq. (14b) kicks in. We have discussed this update in general in Section 5.4.1. We now apply it to the present situation (which falls under case 2(b) in Section 5.4.1).
      (i) The isotropic subspace is updated to Ĩ= [symbol] a_{Z}_{₁}_{Z}_{₂} [symbol] .
      (ii) The coset labels are updated to {a_{X}_{₁}_{X}_{₂}, a_{Y}_{₁}_{X}_{₂}, a_{Z}_{₁}}.
      (iii) The description of the function y is updated to

γ(a_{Z}_{₁}_{Z}_{₂})=1,γ(a_{X}_{₁}_{X}_{₂})=γ(a_{Y}_{₁}_{X}_{₂})=γ(a_{Z}_{₁})=0. (21)
Now comes the simulation of the second measurement, the operator Ō(1)=X₁⊗X₂. As can be directly inferred from Eq. (21), the outcome of this measurement, γ(a_{X}_{₁}_{X}_{₂}) is zero. This measurement outcome represents the computational output, and agrees with the quantum mechanical value obtained above.
   6. The Φ-Map: Mapping Vertices of Δ_{n-d} to Δₙ

Theorem 7 of this section states that vertices of the Δ-polytope on larger numbers of qubits can be obtained from vertices of Δ-polytopes corresponding to smaller numbers of qubits, by tensoring on stabilizer states.

### 6.1. Basic Definitions

Let Herm(2ⁿ) denote the set of Hermitian operators on the n-qubit Hilbert space H= [symbol] ²^{ⁿ}. We recall the definition of the polytope Δₙ from Eq. (5):

Δₙ={X∈Herm₁(2ⁿ)|Tr(X|σ [symbol] [symbol] σ|)≥0,∀|σ [symbol] ∈ [symbol] ₙ}

where Herm, (2ⁿ)⊂Herm(2ⁿ) denotes the subset of Hermitian matrices of trace 1 and [symbol] ₙ denotes the set of (pure) n-qubit stabilizer states. The set of vertices of Aₙ is denoted by {A_{α}|α∈Vₙ}.

We write Eₙ for the vector space ( [symbol] ₂)²ⁿ which comes with a symplectic form defined by

[v,w]=v_{Z}^{T}w_{X}+v_{X}^{T}w_{Z},∀v,w∈Eₙ.

We denote the canonical symplectic basis of Eₙ by {x₁, . . . , xₙ, z₁, . . . , zₙ}. We write Sp₂ₙ( [symbol] ₂) for the group of symplectic transformations. For a subspace W⊂Eₙ let W^{⊥} denote {v∈Eₙ|[v, w]=0, ∀w∈W}. A subspace J⊂Eₙ is called isotropic if J⊂J^{⊥}. For the definition of Pauli operators we may make the convention

Tᵥ=i^{v}^{^{x}}^{·v}^{^{z}}Z(v_{z})X(vₓ),

where vₓ·v_{z} is computed mod 2. In fact, any choice would work as long as (Tᵥ)²= [symbol] ₂_{ⁿ}, ∀v∈Eₙ, and in TᵤTᵥ=(−1)^{β(u,v)}T_{u±v} we have that β(u,v)=0 for all u∈J and v∈J^{⊥} for any isotropic subspace J⊂Eₙ. We write Π_{J,s} for the projector corresponding to an isotropic subspace J⊂Eₙ and a value assignment s:J→ [symbol] ₂.

6.2. The Φ-Map

In this section it is shown that each vertex of Δ_{n-d} gives rise to a vertex of Δₙ. This will be achieved by constructing a map between the polytopes Δ_{n-d} and Δₙ such that [symbol] _{n-d} maps injectively into [symbol] ₙ.

Theorem 7 Let J⊂Eₙ be an isotropic subspace of dimension d and S∈Sp₂ₙ ( [symbol] ₂) such that S(J₀)=J where J₀= [symbol] x_{n-d+1}, . . . , xₙ [symbol] . Given value assignments r₀:J₀→ [symbol] ₂ and r:J→ [symbol] ₂ define a linear map

$${Φ}_{J , r , S {\vert}_{{E}_{n - d}}} : Her m ( {2}^{n - d} ) \to H e r m ( {2}^{n} )$$

by the formula

$${Φ}_{J , r , S {\vert}_{{E}_{n - d}}} ( X ) = U ( X ⊗ {\prod }_{{J}_{0} , {r}_{0}} ) {U}^{†} \qquad ( 22 )$$

where U is a Clifford unitary that implements S and satisfies UΠ_{J}_{₀}_{,r}_{₀}U^{†}. Then the map
satisfies the following properties:
6. The image of Φ_{J,r} is given by {(Π_{J,r}YΠ_{j,r})/Tr(YΠ_{J,r})|Y∈Δₙ and Tr(YΠ_{J,r})≠0}.
7. Φ_{J,r} is injective and maps a vertex X∈Δ_{n-d} to a vertex of Aₙ.
8. A vertex X is of cnc type if and only if Φ_{J,r} (X) is of cnc type.
   We first consider the case (J,r)=(J₀, r₀) so that S is the identity matrix. Also the Clifford unitary U is chosen to be the identity matrix. For X∈Herm_{n-d} we can write

$$X = \frac{1}{{2}^{n - d}} {\sum }_{v ∈ {E}_{n - d}} {α}_{v} {T}_{v}$$

and Eq. (2) implies that

$${Φ}_{J , r} ( X ) = X ⊗ {Π}_{J , r} = \frac{1}{{2}^{n}} {\sum }_{v + u ∈ {E}_{n - d} + J} {( - 1 )}^{r ( u )} {α}_{v} {T}_{v + u} \qquad ( 23 )$$

The first step is to show that Φ_{J,r} maps Δ_{n-d} into Δₙ.
Lemma 2 Let I be a maximal isotropic subspace of Eₙ. Then

$$Tr ( {Φ}_{J , r} ( X ) {Π}_{I , s} ) = {δ}_{{r {\vert}_{I ⋂ J} , s \vert}_{I ⋂ J}} \frac{\vert I ⋂ {J}^{⊥} \vert}{{2}^{n}} Tr ( {X Π}_{I ⋂ {E}_{n - d} , s {\vert}_{I ⋂ {E}_{n - d}}} ) .$$

In particular, if X∈Δ_{n-d} then Φ_{J,r}(X)∈Δₙ.
Proof of Lemma 2. We have Tr(Φ_{J,r}(X))=1 since Tr(X)=1. We calculate

$$Tr ( {Φ}_{J , r} ( X ) {Π}_{I , s} ) = \frac{1}{{2}^{n}} {\sum }_{v + u ∈ {E}_{n - d} + J} {( - 1 )}^{r ( u )} {α}_{v} Tr ( {T}_{v + u} {Π}_{I , s} ) = \frac{\vert I ⋂ J \vert}{{2}^{n}} {\sum }_{v ∈ I ⋂ {E}_{n - d}} {{α}_{v} ( - 1 )}^{s ( v )} \frac{1}{\vert I ⋂ J \vert} {\sum }_{u ∈ I ⋂ J} {( - 1 )}^{r ( u )} {( - 1 )}^{s ( u )} = {δ}_{{r {\vert}_{I ⋂ J} , s \vert}_{I ⋂ J}} \frac{\vert I ⋂ J \vert}{{2}^{n}} {\sum }_{v ∈ I ⋂ {E}_{n - d}} {{α}_{v} ( - 1 )}^{s ( v )} = {δ}_{{r {\vert}_{I ⋂ J} , s \vert}_{I ⋂ J}} \frac{\vert I ⋂ J \vert \vert I ⋂ {E}_{n - d} \vert}{{2}^{n}} Tr ( {X Π}_{I ⋂ {E}_{n - d} , s {\vert}_{I ⋂ {E}_{n - d}}} ) = {δ}_{{r {\vert}_{I ⋂ J} , s \vert}_{I ⋂ J}} \frac{\vert I ⋂ {J}^{⊥} \vert}{{2}^{n}} Tr ( {X Π}_{I ⋂ {E}_{n - d} , s {\vert}_{I ⋂ {E}_{n - d}}} ) \geq 0.$$

As a consequence of this calculation and the definition of Δₙ the image of Φ_{J,r}(X) belongs to Δₙ for any X∈Δ_{n-d}. ▪

Next we show that if X [symbol] Δ_{n-d} is a vertex then Φ_{J,r}(X) is a vertex of Δₙ. To achieve this we will use the following characterization of vertices of a polytope: Let P be a polytope in [symbol] ^{d}. Then a point p∈P is a vertex if and only if there exists no non-zero x∈ [symbol] such that p±x∈P [38, page 18]. Our polytope Δₙ lives inside Herm₁(2ⁿ). We can identify Herm₁(2ⁿ) with [symbol] ²^{²ⁿ}⁻¹ by choosing [symbol] ₂_{ⁿ}/2ⁿ to be the origin. Therefore to prove that Φ_{J,r}(X)∈Δₙ is a vertex we need to show that {Φ_{J,r}(X)±Y}∉Δₙ for any Y∈Herm₁(2ⁿ). Let us write

$$Y = \frac{1}{{2}^{n}} {\sum }_{0 \neq v ∈ {E}_{n}} {β}_{v} {T}_{v} ∈ {Herm}_{0} ( {2}^{n} )$$

and define another trace zero operator

$$\tilde{Y} = \frac{1}{{2}^{n - d}} {\sum }_{0 \neq v ∈ {E}_{n - d}} {\tilde{β}}_{v} {T}_{v} ∈ {Herm}_{0} ( {2}^{n - d} ) . \qquad ( 24 )$$

The coefficients \tilde{β}ᵥ are given by Tr(YᵥΠ_{j,r}) where Yᵥ=½ⁿΣ_{u∈j}βᵤ₊ᵥTᵤ∈Herm(2ⁿ). Furthermore, we have the relation

$${\tilde{β}}_{v} = \frac{1}{\vert J \vert} {\sum }_{u ∈ J} {{β}_{u + v} ( - 1 )}^{r ( u )} \qquad ( 25 )$$

where |J| stands for the number of elements.
Lemma 3 Let I′⊂E_{n-d} be a maximal isotropic subspace and s′:I′→ [symbol] ₂ be a value assignment. Then

Tr(YΠ_{J+I′,r+s′})=Tr(Y̅Π_{I′,s′}) (26)

where r*s′:(J+I′)→ [symbol] ₂ is the value assignment defined by r*s′(u+v)=r(u)+s′(v).
Proof of Lemma 3. We calculate

$$Tr ( {Y Π}_{J + {I}^{′} , r * {s}^{′}} ) = \frac{1}{\vert J \vert \vert {I}^{′} \vert} {\sum }_{v ∈ {I}^{′}} {\sum }_{u ∈ J} {{β}_{u + v} ( - 1 )}^{r ( u ) + s ( v )} = \frac{1}{\vert {I}^{′} \vert} {\sum }_{v ∈ {I}^{′}} {( - 1 )}^{s ( v )} \frac{1}{\vert J \vert} {\sum }_{u ∈ J} {{β}_{u + v} ( - 1 )}^{r ( u )} = \frac{1}{\vert {I}^{′} \vert} {\sum }_{v ∈ {I}^{′}} {( - 1 )}^{s ( v )} {\tilde{β}}_{v} = Tr ( \tilde{Y} {Π}_{{I}^{′} {•s}^{′}} ) .$$

For the third equality we use Eq. (5). ▪
Proof of Theorem 7. We begin by proving Theorem 7 for (J, r)=(J₀, r₀) in which case the map is given by Eq. (23). Part (1) follows immediately from comparing Π_{J}_{₀}_{,r}_{₀}YΠ_{J}_{₀}_{,r}_{₀} after normalization with Eq. (23). For part (2) note that Lemma 2 says that Φ_{J,r} (Δ_{n-d})⊂Δₙ. Let X be a vertex of Δ_{n-d}. We will show that {Φ_{J,r}(X)±Y}∉Δₙ for any Y∈Herm₀(2ⁿ). Since X is a vertex either X+\tilde{Y} or X−\tilde{Y} lies outside of Δ_{n-d}, where \tilde{Y}∈Herm₀(2^{n-d}) is defined in Eq. (24). WLOG assume that X+\tilde{Y}∉Δ_{n-d}. This means that there is a pair (I′, s′) such that Tr((X+\tilde{Y})Π_{I′,s′})<0. Lemma 2 with I=J+I′ and s=r*s′ gives

Tr(Φ_{J,r}(X)Π_{J+I′,r+s′})=Tr(XΠI′,s′). (27)

Using Eq. (27) and Eq. (26) we obtain

Tr((Φ_{J,r}(X)+Y)Π_{J+I′,r+s′})=Tr((X+\tilde{Y})Π_{I′,s′})<0,

thus X+Y lies outside of Δₙ. This completes the proof of part (2). Next we prove part (3). If X=A_{Ω}^{γ} for some cnc set (Ω, γ) where Ω⊂E_{n-d} then Eq. (3) implies that

$${Φ}_{J , r} ( {A}_{Ω}^{γ} ) = \frac{1}{{2}^{n}} {\sum }_{u + v ∈ J + {E}_{n - d}} {( - 1 )}^{r ( u ) + γ ( v )} {T}_{u + v} = {A}_{J + Ω}^{r * γ} .$$

Therefore, we obtain a vertex of cnc type. Conversely, if Φ_{J,r}(X) is a vertex of cnc type given by A_{\tilde{Ω}}^{\tilde{γ}} for some cnc set (\tilde{Ω},\tilde{γ}) then again from Eq. (23) we see that X=A_{Ω}^{γ}, where Ω=\tilde{Ω}∩E_{n-d} and γ=\tilde{γ}|_{Ω}.
For the general case let J⊂Eₙ be an arbitrary isotropic subspace and r:J→ [symbol] ₂ be a value assignment. We will write J₀ for [symbol] x_{n-d+1}, . . . , x [symbol] and r₀:J→ [symbol] ₂ for the value assignment defined by r₀(v)=0 for all v∈J. Let U be a Clifford unitary as described in the statement of the Theorem. We think of Φ_{J,r} as the composite of two maps:

Φ_{J,r}(X)=UΦ_{J}_{₀}_{,r}_{₀}(X)U^{†}.

Part (1) follows from the relation UΠ_{J}_{₀}_{,r}_{₀}U^{†}=Π_{J,r}. Part (2) holds since U acts on Δₙ by permuting its vertices [36]. Also this action maps a cnc type vertex to a cnc type vertex, which implies part (3). ▪

Theorem 7 can be used to obtain two variations of the classical simulation algorithm: (1) the reduced classical algorithm described in section 8 below, and (2) the refined simulation algorithm described in Appendix D. In the first case, if the vertex at a given time step of the simulation is of the form U(A_{α}⊗Π_{σ})U^{†} for some d-qubit stabilizer state |σ [symbol] then the original measurement sequence can be replace by an equivalent measurement sequence acting on (n−d)-qubits and the sampling can be done over the smaller polytope Δ_{n-d} as explained in the proof of Theorem 10 below. By a more detailed analysis as done in Theorem 12 it is possible to refine this procedure into a sampling that takes place over successively smaller polytopes Δₙ, Δₙ₋₁, . . . , Δ₁ as described in Algorithm 2 in Appendix D.

### 7. Vertices (Extreme Points) of Δₙ

The convex operator set Δₗ is simply a cube in three dimensions, so the vertices are known. In this section we explicitly provide the extreme points of the polytope Δₙ for n=2, i.e. the 2-qubit case.

For any n, the vertices of Δₙ form orbits under the Clifford group Clₙ. For n=2, we give a list of vertex representatives from each Clifford orbit in Appendix B. Theorem 9 employs graph theory to explain which value assignments, or equivalently the stabilizer states |σ [symbol] , can vanish at a given vertex, that is Tr(X|σ [symbol] [symbol] σ|)=0 in Eq. (5). The possible sets of such value assignments are controlled by a combinatorial data, namely a graph [symbol] (S) associated to a collection S of value assignments of size 15. It is proved that, if S specifies a vertex, then [symbol] (S) has full perrank. Conversely, if [symbol] (S) has full perrank we can find another set S′ of value assignments that specifies a vertex with the property that [symbol] (S′)≅ [symbol] (S). The full perrank condition is easy to verify for Δ₂ as we show in Appendix C. This provides a rigorous proof that the list in Appendix B indeed consists of vertices of Δ₂. Application of the Φ-map from Section 6 to Δ₂ produces new vertices for the polytopes Δₙ where n>2.

7.1. Graph Theoretic Description of Vertices

The polytope Δₙ lives inside [symbol] ⁴^{ⁿ}⁻¹ and the inequalities in Eq. (5) defining the polytope can be written as

a(s_{I})^{T}·x≥−1 (28)

where s_{I} runs over value assignments over maximal isotropic subspaces I⊂Eₙ and a(s_{I}) is the column vector whose v-th entry is given by (−1)^{s(v)} for v∈Eₙ−{0}. In this section we introduce a graph-theoretic approach to study the vertices of Δₙ.

Let Valₙ denote the set s_{I}:I→ [symbol] ₂ of all value assignments as I runs over the maximal isotropic subspaces in Eₙ. Given a subset S⊂Valₙ we define a signed bipartite graph [symbol] (S)^{σ}:
the set V( [symbol] ) of vertices consists of two types: (i) value assignments in S and (ii) non-zero elements in Eₙ,
the set E( [symbol] ) of edges consists of pairs (v,s_{I}) where s_{I}∈S and v∈I−{0},
the sign function σ:E( [symbol] )→{±1} is defined by σ(e)=(−1)^{s}^{_{I}}^{(v)} where e is the edge specified by the pair (v,s_{I}).

The adjacency matrix A of this graph is given by

$$A = ( \begin{matrix}0 & B \\ {B}^{T} & 0\end{matrix} ) \qquad ( 29 )$$

where B is the matrix whose rows are labeled by v∈Eₙ−{0} and columns by S with B_{v,s}_{_{I}}=(−1)^{s}^{_{I}}^{(v)} if v∈I and B_{v,s}_{_{I}}=0 otherwise.

A signed graph is said to have full rank if its adjacency matrix has full rank. Let [symbol] denote the underlying graph (without signs) of a signed graph [symbol] ^{σ}. A Sachs graph is a graph that is a disjoint union of 1-regular (edges) and 2-regular (cycles) graphs. The perrank of a graph is the maximal |V( [symbol] )| as [symbol] runs over subgraphs of [symbol] that are Sachs graphs.

Theorem 8 [39] There exists a choice a of signs for the edges of [symbol] such that [symbol] ^{σ} has full rank if and only if [symbol] has full perrank.

This can be applied to the vertex discussion:

Corollary 1 If S specifies a vertex then [symbol] (S) has full perrank.
Proof of Corollary 1. A point X∈Δₙ is a vertex if and only if there are 4ⁿ−1 inequalities among Eq. (28) that are tight at X. The set S specifies a vertex if and only if in Eq. (29) rank(B)=4ⁿ−1. Therefore A has full rank and with the choice a of signs induced by the value assignments the graph [symbol] (S)^{σ} has full rank. In this case Theorem 8 implies that the underlying graph [symbol] (S) has full perrank. ▪

This implies that |S|≥4ⁿ−1, but we know that |S|=4ⁿ−1 suffices. So we will assume that |S|=4ⁿ−1 for the rest, hence B will be a square matrix.

7.2. Vertices of Δ₂

We specialize to the 2-qubit case (see FIG. 10 for the set of isotropic subspaces). We write [symbol] (S)≅ [symbol] (S′) to mean that the two graphs are isomorphic as bipartite graphs that is the isomorphism respects the partitioning of the set of vertices. Corollary 1 can be strengthened in this case:

Theorem 9 Let S be a subset of Val₂.

(i) If S specifies a vertex then [symbol] (S) has full perrank.

(ii) If [symbol] (S) has full perrank then there exists a set S′ of value assignments with [symbol] (S)≅ [symbol] (S) that specifies a vertex.

Proof of Theorem 9. Part(i) follows from Corollary 1 applied to n=2. For Part (ii) observe that Theorem 8 implies that there is a sign σ such that [symbol] (S)^{σ} has full rank. Consider the non-trivial block B in the adjacency matrix A (Eq. 29) of [symbol] (S)^{σ}. The columns of this matrix consist of σ(v) for v∈I−{0} and 0 for v∈E₂−I. Suppose I= [symbol] a, b [symbol] . The three non-zero entries σ(a), σ(b), σ(a+b) defines a value assignment s:I→ [symbol] ₂ if and only if their product satisfies σ(a)σ(b)σ(a+b)=(−1)^{β(a,b)}. If the product fails to be (−1)^{β(a,b)}. We can multiply this column by −1 so that the sign of the product flips making it equal to (−1)^{β(a,b)}. We do this for each column which fails to satisfy this product requirement. After this modification the rank of B does not change. Let σ′ denote the modified sign choice. Then we define S′ to be the set of value assignments given by the columns of the B matrix. Since B has full rank B specifies a vertex. ▪

Our approach will be to use Theorem 9 to describe all the vertices of Δ₂. For this we perform the following steps:
1. Choose a subset S⊂Val₂ and construct the graph [symbol] (S).
2. Check whether [symbol] (S) has full perrank by considering its Sachs subgraphs.
3. If [symbol] (S) has full perrank then Theorem 9 implies that there is a set S′ of value assignments that specify a vertex.

The last step can be described more explicitly: Order the elements of E₂−{0} as v₁, v₂, . . . , v₁₅. Then the vertex X=(Σᵢ₌₁¹⁵xᵢTᵥᵢ)/4 for which Eq. (28) is tight for all s∈S′ is given by

$${x}_{i} = - {\sum }_{j = 1}^{15} {( {B}^{- 1} )}_{ij} . \qquad ( 30 )$$

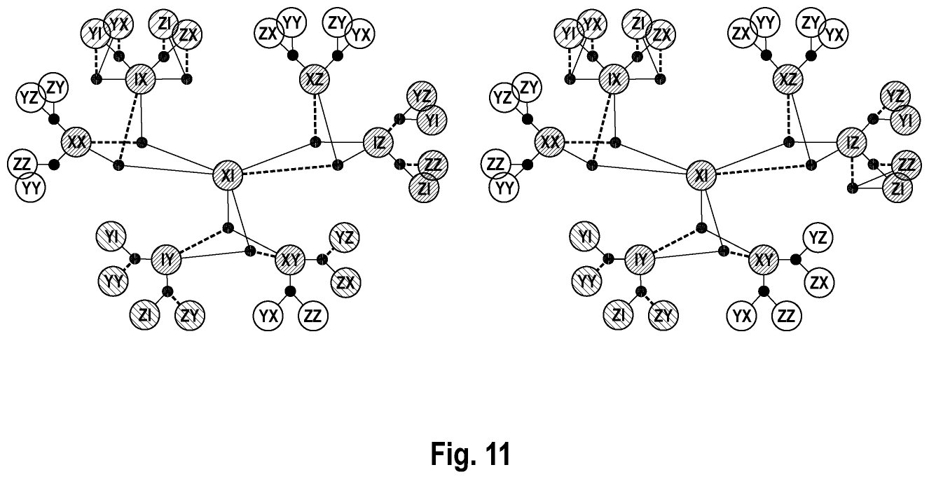

Since the Clifford group acts on the set of vertices of Δ₂ up to Clifford unitaries it suffices to understand a representative vertex from each orbit. In total there are 8 such orbits (verified numerically). In Appendix B a list of 8 vertices from each orbit is given. We refer to them as Type 1-8. Below we give a list of sets Sᵢ of value assignments and in Appendix C.1 we show that the corresponding graphs [symbol] (Sᵢ) have full perrank. The set S: that exists by part (ii) of Theorem 9 is given by Sᵢ′=Sᵢ. There are 6 types of graphs as illustrated in FIGS. 11, 12, 13.
Type 1 The collection S₁ consists of the following value assignments:

| XI, IX | XI, IY | XI, IZ | YI, IX | YI, IY | YI, IZ | ZI, IX | ZI, IY | ZI, IZ | XY, YX | XZ, ZX | YZ, ZY | XY, ZX | XZ, YX | XX, YY |
|---|---|---|---|---|---|---|---|---|---|---|---|---|---|---|
| s₋₁₁ | s₁₁ | s₁₁ | s₁₁ | s₁₁ | s₁₁ | s₁₁ | s₁₁ | s₁₁ | ∅ | ∅ | ∅ | s₁₁ | ∅ | ∅ |
| & | & | & | & | | | & | | | | | | | | |
| s₁₋₁ | s₋₁₁ | s₋₁₁ | s₋₁₋₁ | | | s₋₁₋₁ | | | | | | | | |

Type 2 The collection S₂ consists of the following value assignments:

| XI, IX | XI, IY | XI, IZ | YI, IX | YI, IY | YI, IZ | ZI, IX | ZI, IY | ZI, IZ | XY, YX | XZ, ZX | YZ, ZY | XY, ZX | XZ, YX | XX, YY |
|---|---|---|---|---|---|---|---|---|---|---|---|---|---|---|
| s₋₁₁ | s₁₁ | s₁₁ | s₁₁ | s₁₁ | s₁₁ | s₁₁ | s₁₁ | s₁₁ | ∅ | ∅ | ∅ | ∅ | ∅ | ∅ |
| & | & | & | & | | | & | | & | | | | | | |
| s₁₋₁ | s₋₁₁ | s₋₁₋₁ | s₁₋₁ | | | s₋₁₋₁ | | s₋₁₋₁ | | | | | | |

Type 3 The collection S₃ consists of the following value assignments:

| XI, IX | XI, IY | XI, IZ | YI, IX | YI, IY | YI, IZ | ZI, IX | ZI, IY | ZI, IZ | XY, YX | XZ, ZX | YZ, ZY | XY, ZX | XZ, YX | XX, YY |
|---|---|---|---|---|---|---|---|---|---|---|---|---|---|---|
| s₋₁₁ | s₋₁₁ | s₁₁ | s₁₁ | s₋₁₁ | s₁₁ | s₁₁ | s₋₁₁ | s₋₁₁ | ∅ | ∅ | ∅ | s₁₁ | s₁₁ | s₁₋₁ |
| | | & | | & | | & | | | | | | | | |
| | | s₋₁₋₁ | | s₁₋₁ | | s₋₁₋₁ | | | | | | | | |

Type 4 The collection S₄ consists of the following value assignments:

| XI, IX | XI, IY | XI, IZ | YI, IX | YI, IY | YI, IZ | ZI, IX | ZI, IY | ZI, IZ | XY, YX | XZ, ZX | YZ, ZY | XY, ZX | XZ, YX | XX, YY |
|---|---|---|---|---|---|---|---|---|---|---|---|---|---|---|
| s₋₁₁ | s₋₁₁ | s₋₁₁ | s₁₁ | s₁₁ | s₁₋₁ | s₁₁ | s₁₋₁ | ₛ₁₋₁ | s₋₁₁ | s₋₁₋₁ | s₋₁₋₁ | s₋₁₋₁ | s₋₁₋₁ | s₁₁ |

Type 5 The collection S₅ consists of the following value assignments:

| XI, IX | XI, IY | XI, IZ | YI, IX | YI, IY | YI, IZ | ZI, IX | ZI, IY | ZI, IZ | XY, YX | XZ, ZX | YZ, ZY | XY, ZX | XZ, YX | XX, YY |
|---|---|---|---|---|---|---|---|---|---|---|---|---|---|---|
| s₋₁₁ | ∅ | s₁₁ | s₁₁ | s₋₁₁ | s₁₁ | s₁₁ | s₁₁ | s₁₁ | s₁₁ | s₁₋₁ | s₁₁ | s₋₁₁ | s₁₁ | s₋₁₋₁ |
| | | | | | | | | | | | | & | | |
| | | | | | | | | | | | | s₁₋₁ | | |

Type 6 The collection S₆ consists of the following value assignments:

| XI, IX | XI, IY | XI, IZ | YI, IX | YI, IY | YI, IZ | ZI, IX | ZI, IY | ZI, IZ | XY, YX | XZ, ZX | YZ, ZY | XY, ZX | XZ, YX | XX, YY |
|---|---|---|---|---|---|---|---|---|---|---|---|---|---|---|
| s₋₁₁ | s₁₁ | s₁₁ | s₁₁ | s₁₁ | s₁₁ | s₁₁ | s₋₁₁ | s₁₁ | s₋₁₋₁ | s₋₁₁ | ∅ | s₁₁ | s₋₁₋₁ | ∅ |
| & | | | & | | | | | | | | | | | |
| s₁₋₁ | | | s₁₋₁ | | | | | | | | | | | |

Type 7 The collection S₇ consists of the following value assignments:

| XI, IX | XI, IY | XI, IZ | YI, IX | YI, IY | YI, IZ | ZI, IX | ZI, IY | ZI, IZ | XY, YX | XZ, ZX | YZ, ZY | XY, ZX | XZ, YX | XX, YY |
|---|---|---|---|---|---|---|---|---|---|---|---|---|---|---|
| s₋₁₁ | s₁₁ | s₁₁ | s₁₁ | s₋₁₁ | ∅ | s₁₁ | s₋₁₋₁ | s₋₁₋₁ | s₁₁ | s₋₁₁ | s₋₁₁ | s₁₁ | s₁₋₁ | s₋₁₋₁ |
| | | | | | | & | | | | | | | | |
| | | | | | | s₋₁₋₁ | | | | | | | | |

Type 8 The collection S₈ consists of the following value assignments:

| XI, IX | XI, IY | XI, IZ | YI, IX | YI, IY | YI, IZ | ZI, IX | ZI, IY | ZI, IZ | XY, YX | XZ, ZX | YZ, ZY | XY, ZX | XZ, YX | XX, YY |
|---|---|---|---|---|---|---|---|---|---|---|---|---|---|---|
| s₋₁₋₁ | s₋₁₋₁ | s₋₁₁ | s₁₁ | s₋₁₁ | s₋₁₋₁ | s₁₁ | s₋₁₁ | s₁₋₁ | s₁₁ | s₋₁₁ | s₋₁₋₁ | s₁₋₁ | s₁₁ | s₁₁ |

Remark: A vertex can be described by two different sets S and S′ such that the corresponding graphs are not isomorphic. For example, the Type 2 vertex representative can also be described using the set

| XI, IX | XI, IY | XI, IZ | YI, IX | YI, IY | YI, IZ | ZI, IX | ZI, IY | ZI, IZ | XY, YX | XZ, ZX | YZ, ZY | XY, ZX | XZ, YX | XX, YY |
|---|---|---|---|---|---|---|---|---|---|---|---|---|---|---|
| s₋₁₁ | ∅ | ∅ | ∅ | s₁₁ | s₁₁ | s₁₁ | s₁₁ | s₁₁ | s₁₁ | s₁₁ | s₋₁₁ | s₁₁ | ∅ | ∅ |
| | | | | & | | & | | & | | | & | | | |
| | | | | s₋₁₁ | | s₋₁₋₁ | | s₋₁₋₁ | | | s₁₋₁ | | | |
| | | | | & | | | | | | | | | | |
| | | | | s₁₋₁ | | | | | | | | | | |

We have [symbol] (S₂) [symbol] [symbol] g(SD since the latter contains 3 value assignments associated to {YI,IY} whereas the first one has at most 2 for each maximal isotropic subspace.

### 8. Reduction of the Classical Simulation

In this section we show that, from the perspective of classical simulation of quantum computation with magic states, the Φ-map does not increase complexity. Namely the images under the Φ-map are as easy or hard to simulate as the pre-images.

Theorem 10 Any QCM (quantum computation in the magic state model) that operates on an initial phase point operator U(X_{A}⊗(Π_{σ})_{B})U^{†}, where X∈Δₙ, is an n-qubit vertex and Π_{σ}=|σ [symbol] [symbol] σ| is the projector on an m-qubit stabilizer state |σ [symbol] and U is an n+m-qubit Clifford unitary, can be efficiently reduced to a QCM on initial state X alone.
The theorem says that supplementing a vertex X with a stabilizer state does not (exponentially) increase the computational power of QCM.
Proof of Theorem 10. We start from the version of QCM where the quantum computation consists of a sequence of Pauli measurements. All Clifford unitaries can be propagated forward past the last measurement (conjugating the measured observables in the passing), and then discarded. Thus, WLOG we consider initial states of form \tilde{X}=X_{A}⊗(Π_{σ})_{B}.
We can give an explicit procedure to replace the sequence [symbol] on A⊗B by an equivalent sequence [symbol] ^{(A)} of observables that act only on the subsystem A. The proof is by induction, and the induction hypothesis is that, at time t, the sequence [symbol] _{≤t} of measurements has been replaced by a computationally equivalent sequence [symbol] of Pauli measurements on the register A only. This statement is true for t=0, i.e., the empty measurement sequence. We now show that the above statement for time t implies the analogous statement for time t+1.
At time t, the state of the quantum register evolved under the computationally equivalent measurement sequence [symbol] is \tilde{Y}(t)=Y(t)_{A}⊗(Π_{σ})_{B}. We now consider the Pauli observable T(t+1)∈ [symbol] to be measured next, and write T(t+1)=R_{A} (t+1)⊗S_{B}(t+1). There are two cases:

Case I: T(t+1) commutes with the entire stabilizer [symbol] of |σ [symbol] . Hence, also S_{B}(t+1) commutes with [symbol] . But then, either S_{B}(t+1) or −S_{B}(t+1) is in [symbol] , and S_{B}(t+1) may be replaced by its eigenvalue ±1 in the measurement. Hence, the measurement of T(t+1) is equivalent to the measurement of ±R_{A}(t+1).

Case II: T (t+1) does not commute with the entire stabilizer [symbol] of |σ [symbol] . Then, the measurement outcome sₜ₊₁ is completely random. Further, there exists a Clifford unitary V such that

V [symbol] (t+1)V^{†}= [symbol] =Z_{B:1},X_{B:2}, . . . ,X_{B:m} [symbol] ,VT(t+1)V^{†}=Z_{B:1}.

Therefore, the state resulting from the measurement of T(t+1), with outcome sₜ₊₁ on the state \tilde{Y}(t) is the same state as the one resulting from the following procedure:
1. Apply the Clifford unitary V to \tilde{Y}(t)=Y(t)_{A}⊗(Π_{σ})_{B}, leading to

V\tilde{Y}(t)V^{†}=Y′(t)⊗|∓ [symbol] ∓|_{B},
where |∓ [symbol] _{B}:=⊗_{i∈B}|+ [symbol] _{B:i}.
2. Measure Z_{B:1} on Y′(t)⊗|± [symbol] ∓|_{B}, with outcome sₜ₊₁.
3. Apply V^{†}.
   Now, note that the measurement in Step 2, of the Pauli observable Z_{B:1} is applied to the stabilizer state |+ [symbol] . The result is |σ′(t+1))=|sₜ₊₁ [symbol] _{B:1}⊗ⱼ₌₂^{m}|+ [symbol] _{B:j}; that is the first qubit of subsystem B is now in a Z-eigenstate, and the other qubits are unchanged. Therefore, after normalization, the effect of the measurement can be replaced by the unitary (X_{B:1})^{s}^{ₜ₊₁}H_{B:1}.
   Thus, the whole procedure may be replaced by the Clifford unitary V^{†}(X_{B:1})^{s}^{ₜ₊₁}H_{B:1}V. But Clifford unitaries don't need to be implemented. They are just propagated past the last measurement, thereby affecting the measured observables by conjugation whereby their Pauli-ness is preserved. In result, in Case II, the measurement of T(t+1) doesn't need to be performed at all. It is replaced by a coin flip, and efficient classical post-processing of the subsequent measurement sequence.
   We conclude that in both the cases I and II, given the induction assumption, the original measurement sequence [symbol] can be replaced by a computationally equivalent measurement sequence [symbol] acting on register A only. By induction, the complete measurement sequence [symbol] can be replaced by a computationally equivalent sequence [symbol] acting on A only.
   Since the measurements [symbol] are applied to an unentangled initial state X_{A}⊗(Π_{σ})_{B}, the register B may be dropped without loss of information. Thus, any sequence of Pauli measurements on the initial state X_{A}⊗(Π_{σ})_{B} is efficiently reduced to a Pauli measurement sequence of at most the same length on X alone. ▪

### 9. Size of the Relevant Phase Space Corner

The above simulation procedure can be used to show that the part of phase space that can be travelled starting from a fixed magic state is actually quite small (small enough). We may want log₂ (#phase space points) to be polynomial in the number of qubits, so that the vertices may have efficient classical descriptions. We have two bounds. Denoting by #stab(n) the number of stabilizer states on n qubits,

n²/2≤log₂(#phase space points)≤log₂((4ⁿ−1)!#stab(n))≈2²ⁿ⁻¹n².

The lower bound may be obtained based on Karanjai, Wallman and Bartlett, and the upper bound comes from counting the choices of 4ⁿ−1 stabilizer states out of the whole set. Such (4ⁿ−1)-tuples of stabilizer states can define vertices, but not each tuple does indeed produce a vertex (or even an intersection); hence counting the tuples provides an upper bound only, not the exact number of vertices. We observe that the gap between the bounds is wide.
However, from the viewpoint of classical simulation of QCM, what matters particularly is the set of vertices that need to be reached in all QCMs starting from a fixed magic state. In this regard, the simulation algorithm described herein (see also [0036]) can be used to show that the number of those vertices is rather small, namely we have the following result.
Theorem 11 Given a quantum computation which starts in the magic state |T [symbol] ^{⊗n}, the phase points α(t)∈ [symbol] , being the notion of state in the classical simulation Algorithm 1 for universal quantum computation (see Table 2), can each be described by 4n²+O(n) bits.

TABLE 2
Algorithm 1: Classical procedure to simulate a single run of a given QCM. The
algorithm has the restriction that the Pauli measurements are pairwise commuting.

| | |
|---|---|
| 1. | Sample from the probability distribution p_{ρ}. Obtain a phase space point α₀ ∈ [symbol] . |
| 2. | For all Pauli measurements Tₐ_{ₜ}, aₜ ∈ Eₙ, from t = l to t = tₘₐₓ, sample from q_{a,a=a}_{ₜ} |
| | to obtain the new phase space point β ∈ Vₙ and measurement outcome s. Output s as |
| | the outcome for the measurement of Tₐ_{ₜ}, update the phase space point αₜ₋₁ → αₜ = β, |
| | and increment t → t + 1. |

To prove Theorem 11, we start with a lemma.

Lemma 4 Measurement of sequences of commuting Pauli observables on magic states, with the observables possibly depending on earlier measurement outcomes, is sufficient for universal quantum computation.
Proof of Lemma 4. We prove this result in the model of quantum computation with magic states (QCM), which is universal. The set of operations in QCM is Pauli measurements and Clifford gates. We have already shown that the Clifford gates add nothing to the computational power and can be eliminated without loss; see e.g. [36]. What remains to prove that commuting Pauli measurements suffice. We can reuse the proof of Theorem 10 to make that case.
The phase point operator Ã_{α}(t) after every sampling step takes the form

Ã_{α}(t)=W(t)(A_{α′}(t)_{A(t)}⊗(Π⁺)_{B(t)})W(t)^{†},

where W∈Clₙ, Π⁺:=⊗_{i∈B(t)}|+ [symbol] ᵢ [symbol] 30 |, and {1, . . . , n}=Δ(t)∪B(t), A(t)∩B(t)=ø for all t. Denote K(t):=|A(t)|. The Ã_{α}(t) are indeed phase point operators, by Theorem 1. We denote

W(t)^{†}ₐ₍ₜ₎W(t)=:R(t)_{A(t)}⊗S(t)_{B(t)}.

Let the Pauli observable for the next measurement be denoted as Tₐ₍ₜ₎. The corresponding two post-measurement states are (not normalized)

$${\tilde{B}}_{α , a , \pm } ( t + 1 ) = \frac{I \pm {T}_{a ( t )}}{2} {\tilde{A}}_{α ( t )} \frac{I \pm {T}_{a ( t )}}{2} = W ( t ) \frac{I \pm R ( t ) ⊗ S ( t )}{2} ( {A}_{{α}^{′}} ( t ) ⊗ {Π}^{+} ) \frac{I \pm R ( t ) ⊗ S ( t )}{2} {W ( t )}^{†} . \qquad ( 31 )$$

Now we have the same case distinction as in Theorem 10. We start with case II.

Case II: [S(t),Π⁺]≠0. Then, as demonstrated in the proof of Theorem 10, the measurement is algorithmically unnecessary. It can be replaced by a Clifford unitary, which we have already shown has no algorithmic function. No computational power is lost when restricting to measurement sequences where Case II never occurs. This leaves us with

Case I: [S(t),Π⁺]=0. Since Π⁺ is of rank 1, this means that s(t)Π⁺=±Π⁺. Thus, the measurement of R(t)⊗S(t) is equivalent to the measurement of ±R(t). Now there are two subcases.

Case Ia: R(t)=±I. This is again an algorithmically unnecessary measurement, and WLOG we may assume that case Ia never occurs in the admitted measurement procedures. This leaves us with

Case Ib:

$$R ( t ) \neq \pm I .$$

$$Then$$

$${\tilde{B}}_{α , a , \pm } ( t + 1 ) = W ( t ) ( \frac{I \pm {R ( t )}_{A ( t )}}{2} {{A}_{{α}^{′}} ( t )}_{A ( t )} \frac{I \pm {R ( t )}_{A ( t )}}{2} ) ⊗ {( {Π}^{+} )}_{B ( t )} {W ( t )}^{†} .$$

We can now find a Clifford unitary V(t)∈Cl_{|A(t)|} with the property

±R(t)=V(t)X_{A(t):K(t)}V(t)^{†}, (32)

and define

$$\frac{I \pm {X}_{A ( t ) : K ( t )}}{2} {V ( t )}^{†} {{A}_{{α}^{′}} ( t )}_{A ( t )} V ( t ) \frac{I \pm {X}_{A ( t ) : K ( t )}}{2} = : {{B}_{{α}^{′} , α , \pm } ( t + 1 )}_{A ( t + 1 )} ⊗ {( {Π}^{+} )}_{B ( t + 1 )} , \qquad ( 33 )$$

$$with$$

$$A ( t + 1 ) = A ( t ) \backslash K ( t )$$

$$and$$

$$B ( t + 1 ) = B ( t ) ⋃ \{ K ( t ) \} ;$$

$$hence ,$$

$$K ( t + 1 ) = K ( t ) - 1.$$

With those definitions,

\tilde{B}_{α,α,±}(t+1)=W(t)V(t)B_{α′,α,±}(t+1)_{A(t+1)}⊗(Π⁺)_{B(t+1)}V(t)⁺W(t)^{†}.

That is, under measurement we have the update

A_{α′}(t)_{A(t)} [symbol] B_{α,α,±}(t+1)_{A(t+1)},W(t) [symbol] W(t+1)=W(t)V(t). (34)

Next we show that all measurements that pass through case Ib, which is the only applicable case, pairwise commute. With the above definitions we have, for all times t, that

Tₐ₍ₜ₎=W(t)R(t)_{A(t)}⊗S(t)_{B(t)}W(t)^{†}=(W(t)R(t)_{A(t)}W(t)^{†})(W(t)S(t)_{B(t)}W(t)^{†}).

Therein,

W(t)R(t)_{A(t)}W((t)^{†}=W(t+1)X_{A(t):K(t)}W(t+1)^{†}, (35)

S(t)_{B(t)}=X[r(t)]_{B(t)}. (36)

Therein, X[r(t)]_{B(t)} is some X-type Pauli operator with support on B(t) only. Eq. (15b) follows from the case I condition of [S, Π⁺]=0.
Now assume WLOG that t′≥t. Then we further have

W(t)R(t)_{A(t)}W(t)^{†}=W(t′)X_{A(t):K(t)}W(t′)^{†}, (16a)

W(t)S(t)_{B(t)}W(t)^{†}=W(t′)X[r(t)]_{B(t)}W(t′)^{†}. (16b)

Those equations follow from Eq. (15) because, by Eq. (14), W(t′)=W(t)Π_{τ=t}^{t′-1}V(τ), and the V(τ) only act on A(τ). Therefore,

$${T}_{a ( t )} {T}_{a ( {t}^{′} )} = W ( {t}^{′} ) ( {X}_{A ( t ) : K ( t )} ⊗ {X [ r ( t ) ]}_{B ( t )} ) {W ( {t}^{′} )}^{†} W ( {t}^{′} ) ( {X}_{A ( {t}^{′} ) : K ( {t}^{′} )} ⊗ {X [ r ( {t}^{′} ) ]}_{B ( {t}^{′} )} ) {W ( {t}^{′} )}^{†} = W ( {t}^{′} ) ( {X}_{A ( t ) : K ( t )} ⊗ {X [ r ( t ) ]}_{B ( t )} ) ( {X}_{A ( {t}^{′} ) : K ( {t}^{′} )} ⊗ {X [ r ( {t}^{′} ) ]}_{B ( {t}^{′} )} ) {W ( {t}^{′} )}^{†} = W ( {t}^{′} ) ( {X}_{A ( {t}^{′} ) : K ( {t}^{′} )} ⊗ {X [ r ( {t}^{′} ) ]}_{B ( {t}^{′} )} ) ( {X}_{A ( t ) : K ( t )} ⊗ {X [ r ( t ) ]}_{B ( t )} ) {W ( {t}^{′} )}^{†} = W ( {t}^{′} ) ( {X}_{A ( {t}^{′} ) : K ( {t}^{′} )} ⊗ {X [ r ( {t}^{′} ) ]}_{B ( {t}^{′} )} ) {W ( {t}^{′} )}^{†} W ( {t}^{′} ) ( {X}_{A ( t ) : K ( t )} ⊗ {X [ r ( t ) ]}_{B ( t )} ) {W ( {t}^{′} )}^{†} = {T}_{a ( {t}^{′} )} {T}_{a ( t )} .$$

Hence all measurements that do some computational lifting (Case Ib) commute. ▪

We now turn to the proof of Theorem 11.

Proof of Theorem 11. First we observe that Δₙ is a polytope embedded in dimension 4ⁿ−1, and, by Caratheodory's theorem, every point in it can be represented as a probabilistic mixture of 4ⁿ vertices, or less. Given any operator B∈Δₙ, it is possible to single out a definite support Supp(B) for such a probability distribution, and order the elements in it. With respect to that choice and ordering, every vertex label β appearing in the expansion can be described by 2n bits. It is important to remember that Supp(B) is a function of B.
We now specify the labels α(s) of A_{α}(s) as the result of a sequence of sampling processes. Denote by α₀ is the result of sampling from the distribution corresponding to the initial state |T [symbol] ^{⊗n}, and by v(t) the result of sampling in step t, i.e., the measurement of the t-th observable; v∈ [symbol] ₂²ⁿ. The sampling history b(s) of a(s) is defined as

$$𝔟 ( s ) = [ {α}_{0} ] ⋃ {⋃}_{1 \leq t \leq s} [ a ( t ) , {s}_{a ( t )} , v ( t ) ] . \qquad ( 37 )$$

We now prove by induction that for all times s the phase point label a(s) is fully specified by the sampling history [symbol] (s). This is true for t=0, where [symbol] (0)=α₀.
Suppose the label α(t) of A_{α}(t) is fully specified by [symbol] (t) (induction assumption). There is one bit worth of outcome s_{α(t)} that needs to be stored. Conditioned on it, there is a definite support Supp (\tilde{B}_{α,α,±}(t+1)) for a probability distribution q_{α,α,±} for sampling from \tilde{B}_{α,α,±}(t+1). As per Eq. (31), first line, the observable \tilde{B}_{α,α,±}(t+1), and therefore also Supp (\tilde{B}_{α,α,±}(t+1)), are specified by α(t), α(t) and s_{α(t)}.

The phase space point α(t+1) is fully specified by Supp (\tilde{B}_{α,α,±}(t+1)) and v(t+1). With the above, α(t+1) is fully specified by α(t), a(t) and sₐ₍ₜ₎, and v(t+1). With Eq. (37), it holds that a(t),sₐ₍ₜ₎∈ [symbol] (t), and by the induction assumption, α(t) is specified by [symbol] (t). Since [symbol] (t)⊂ [symbol] (t+1), a(t), sₐ₍ₜ₎, α(t) are specified by [symbol] (t+1). With Eq. (37), v(t+1) is also specified by [symbol] (t+1). Hence, α(t+1) is specified by [symbol] (t+1). This concludes the induction step. The conclusion is that for any time s, the phase point α(s) is fully specified by the sampling history [symbol] (s).

The remaining task is to count the memory requirements of [symbol] (s). We have

mem[α₀]=mem[α(t)]=mem[v(t)]=2n bits,∀t,

and

mem[sₐ₍ₜ₎]=1 bit,∀t.

Furthermore, there are at most n rounds of measurement, since there are only n commuting and independent Pauli observables on n qubits. Therefore, mem[b(n)]=4n²+3n. ▪

### APPENDIX A: PROOFS

In this section we prove the theorems stated in Section 4.

1. Proof of Theorems 1 and 2

Lemma 5 The set Δₙ has the following properties.
1. Δₙ is convex, i.e., for all p∈[0,1] it holds that

X,Y∈Δₙ⇒pX+(1−p)Y∈Δₙ
2. Δₙ contains all n-qubit quantum states; i.e., for all n-qubit density operators ρ it holds that ρ∈Δₙ.
3. Δₙ is closed under Pauli measurement; i.e., for all P_{a,s} it holds that

$$X ∈ {Δ}_{n} ∧ Tr ( {P}_{a , s} X ) > 0 ⟹ \frac{{P}_{a , s} {XP}_{a , s}}{Tr ( {P}_{a , s} X )} ∈ {Δ}_{n} .$$

Proof of Lemma 5. Property 1 follows directly from the definition Eq. (5). Also, all quantum states ρ satisfy the conditions Tr(|σ [symbol] σ|ρ)≥0, for all n-qubit stabilizer states |σ [symbol] , and Tr(ρ)=1; hence are in Δₙ.

Regarding Property 3, we observe that for all stabilizer states |σ [symbol] ∈ [symbol] ₙ and all Pauli observables Tₐ it holds that

P_{a,s}|σ [symbol] σ|P_{a,s}=c|σ′ [symbol] σ′|, where |σ′ [symbol] ∈ [symbol] ₙ,c≥0. (38)

Namely, c=1 if (−1)^{s}^{_{α}}Tₐ|σ)=|σ), c=0 if (−1)^{s}^{ₐ}Tₐ|σ [symbol] =−|σ [symbol] , and c=½ otherwise. Then,

$$Tr ( \vert σ 〉 〈 σ \vert {P}_{a , s} {XP}_{a , s} ) = Tr ( ( {P}_{a , s} \vert σ 〉 〈 σ \vert {P}_{a , s} ) X ) = cTr ( \vert {σ}^{′} 〉 〈 {σ}^{′} \vert X ) \geq 0.$$

Therein, in the second line we have used Eq. (38), and in the third line the definition of Δₙ, Eq. (5). Therefore, whenever Tr(P_{a,s}X)≥0, the post-measurement state X_{a,s}′:=P_{a,s}XP_{a,s}/Tr(P_{a,s}X) also has the property that

Tr(|σ [symbol] σ|X_{a,s′})≥0,∀a∈Vₙ,∀|σ [symbol] ∈ [symbol] ₙ.

Furthermore, Tr(X_{a,s}′)=1. Therefore, X_{a,s}′∈Δₙ. ▪

Proof of Theorem 1. With Property 2 in Lemma 5, any n-qubit quantum state ρ is in Δₙ. Hence it can be expressed as a linear combination of the vertices A_{α}, as in Eq. (6). Taking the trace of the above equation yields Σₐ p_{ρ}(α)=1, i.e., p_{ρ} is a probability function. This proves the first statement of Theorem 1.

With Property 3 of Lemma 5, for all phase point operators Aₐ and all projectors P_{a,s} with Tr(P_{a,s}X)≥0 it holds that P_{a,s}A_{α}P_{a,s}/Tr(P_{a,s}A_{α})∈Δₙ. Therefore,

$${P}_{a , s} {A}_{α} {P}_{a , s} = {\sum }_{β} {q}_{α , a} ( β , s ) {A}_{β} ,$$

with q_{α,a}(β, s)≥0 for all β∈Eₙ, and s∈ [symbol] ₂. Now fixing α,a and adding the corresponding equations for s=0 and s=1, and then taking a trace, we find

$${\sum }_{s ∈ {ℤ}_{2}} {\sum }_{β ∈ {E}_{n}} {q}_{α , a} ( β , s ) = 1. \qquad ( 39 )$$

Hence, q_{α,a}:Eₙ× [symbol] ₂→ [symbol] _{≥0} is a probability distribution, for all α∈Eₙ, a∈Vₙ. This demonstrates Eq. (8).

We now define

$$q ( a , s \vert α ) := {\sum }_{β} {q}_{α , a} ( β , s ) .$$

Since the q_{α,a}(β, s) are all non-negative, it holds that q (a,s|α)≥0 for all a, s, α. Furthermore, with Eq. (23) it follows that q (a,0|α)+q(a,1|α)=1 for all a, α, and therefore,

0≤q(a,s|α)≤1,∀a,s,α.

Combining Eq. (6) and the already established Eq. (8),

$$Tr ( {P}_{a , s} ρ ) = {\sum }_{α} {p}_{ρ} ( α ) Tr ( {P}_{a , s} {A}_{α} ) = {\sum }_{α} {p}_{ρ} ( α ) Tr ( {P}_{a , s} {A}_{α} {P}_{a , s} ) = {\sum }_{α} {p}_{ρ} ( α ) {\sum }_{β} {q}_{α , a} ( β , s ) = {\sum }_{α} {p}_{ρ} ( α ) q ( a , s \vert α ) .$$

This proves the formulation of Eq. (7) of the Born rule. ▪

Proof of Theorem 2. In this proof we use P_{a,s} (with subscripts) to denote the projector (I+(−1)^{s}Tₐ)/2 and P (without subscripts) to denote general probabilities.

First, we will show that given the input state v and a single Pauli measurement Tₐ, the probability of obtaining the outcome s, P(a, s), predicted by the classical simulation algorithm agrees with the probability obtained via the Born rule. Using the classical simulation algorithm, the conditional probability of obtaining outcome s given the state α∈Eₙ is

$$P ( a , s \vert α ) = {\sum }_{β ∈ {E}_{n}} {q}_{α . a} ( β , s ) = : q ( a , s \vert α ) . \\ Therefore , \\ {P}^{( Sim )} ( a , s ) = {\sum }_{α ∈ {E}_{n}} {p}_{v} ( α ) P ( a , s \vert α ) = {\sum }_{α ∈ {E}_{n}} {p}_{v} ( α ) q ( a , s \vert α ) \qquad ( 40 )$$

The outcome probability predicted by the Born rule is

$${P}^{( QM )} ( a , s ) = Tr ( {P}_{a , s} {vP}_{a , s} ) = {\sum }_{α ∈ {E}_{n}} {p}_{v} ( α ) Tr ( {P}_{a , s} {A}_{α} {P}_{a , s} ) = {\sum }_{α ∈ {E}_{n}} {p}_{v} ( α ) {\sum }_{β ∈ {E}_{n}} {q}_{α , a} ( β , s ) Tr ( {A}_{β} ) = {\sum }_{α ∈ {E}_{n}} {p}_{v} ( α ) q ( a , s \vert α ) \qquad ( 41 )$$

Comparing this expression with eq. (40) above we see that the classical simulation algorithm reproduces the outcome probabilities predicted by the Born rule for a single Pauli measurement.
Now we turn to the post-measurement state v′. The post-measurement state predicted by quantum mechanics is

$${v}^{( QM )} = \frac{{P}_{a , s} {vP}_{a , s}}{Tr ( {P}_{a , s} {vP}_{a , s} )} .$$

Here the numerator is

$${P}_{a , s} {vP}_{a , s} = {\sum }_{α ∈ {E}_{n}} {p}_{v} ( α ) {P}_{a , s} {A}_{α} {P}_{a , s} = {\sum }_{α ∈ {E}_{n}} {p}_{v} ( α ) {\sum }_{β ∈ {E}_{n}} {q}_{α , a} ( β , s ) {A}_{β} ,$$

and the denominator is

$$Tr ( {P}_{a , s} {vP}_{a , s} ) = {\sum }_{α ∈ {E}_{n}} {p}_{v} ( α ) {\sum }_{β ∈ {E}_{n}} {q}_{α , a} ( β , s ) Tr ( {A}_{β} ) {\sum }_{α ∈ {E}_{n}} {p}_{v} ( α ) q ( a , s \vert α ) .$$

Therefore, the post-measurement state predicted by quantum mechanics is

$${v}^{′} = \frac{{\sum }_{α ∈ {E}_{n}} {p}_{v} ( α ) {\sum }_{β ∈ {E}_{n}} {q}_{α , a} ( β , s ) {A}_{β}}{{\sum }_{α ∈ {E}_{n}} {p}_{v} ( α ) q ( a , s \vert α )} \qquad ( 42 )$$

Using the classical simulation algorithm, the probability of obtaining measurement outcome s and state β is P(β∩s)=P(β|s)P(s). But P(β∩s)=Σ_{α∈E}_{ₙ}P(β∩s|α)pᵥ(α)=Σ_{α∈E}_{ₙ}pᵥ(α)q_{α,α}(β,s) and P(β|s)=p_{v′}(β). Therefore, the post-measurement state according to the classical simulation algorithm is

$${v}^{{′}^{( Sim )}} = {\sum }_{β ∈ {E}_{n}} {p}_{{v}^{′}} ( β ) {A}_{β} = {\sum }_{β ∈ {E}_{n}} \frac{P ( β ⋂ s )}{P ( s )} {A}_{β} = {\sum }_{β ∈ {E}_{n}} \frac{{\sum }_{α ∈ {E}_{n}} {p}_{v} ( α ) {q}_{α , a} ( β , s )}{{\sum }_{α ∈ {E}_{n}} {p}_{v} ( α ) q ( a , s \vert α )} {A}_{β} . \qquad ( 43 )$$

This agrees with Eq. (42) above. Therefore, the classical simulation algorithm also reproduces the post-measurement state predicted by quantum mechanics for a single Pauli measurement.
Now let v(t) denote the state before the t^{th} measurement. Then the above shows that the classical simulation algorithm correctly reproduces the Born rule probabilities P(aₜ, sₜ|s₁, s₂, . . . , sₜ₋₁) as well as the post-measurement state v(t+1). Therefore, by induction the simulation algorithm correctly reproduces the outcome probabilities predicted by the Born rule for any sequence of Pauli measurements. ▪

2. Proof of Theorem 3

Proof of Theorem 3. The success probability P_{S} of the quantum algorithm in question can be written as

$${P}_{S} = P ( S ⋂ {A}_{0} ) + P ( S ⋂ \overline{{A}_{0}} ) = P ( S \vert {A}_{0} ) P ( {A}_{0} ) + {\sum }_{α ∈ {A}_{0}} {p}_{{ρ}_{M}} ( α ) p ( S \vert α ) \leq P ( S \vert {A}_{0} ) P ( {A}_{0} ) + {\sum }_{α ∈ {A}_{0}} {p}_{{ρ}_{M}} ( α ) = P ( S \vert {A}_{0} ) P ( {A}_{0} ) + 1 - P ( {A}_{0} ) .$$

Solving this inequality for P(S|A₀) yields Eq. (9). ▪

3. Proof of Theorem 4

Theorem 1 in [10] classifies the maximal cnc sets. For the present purpose it may be rephrased as

Lemma 6 If a subset of Vₙ is closed under inference and does not contain a Mermin square then it is non-contextual.
Proof sketch for Lemma 6. Theorem 1 of [10] classifies the subsets of Vₙ that are closed under inference and do not contain a Mermin square. They all turn out to be non-contextual. ▪

Proof of Theorem 4. Pick an n, any pair (Ω,γ). A_{Ω}^{γ} has unit trace, and, as shown in [10], satisfies Tr(|σ [symbol] σ|_{Ω}^{γ})≥0. Therefore, A_{Ω}^{γ}∈Δₙ, and A_{Ω}^{γ} has an expansion

$${A}_{Ω}^{γ} = {\sum }_{β} {p}_{Ω , γ} ( β ) {A}_{β} , \qquad ( 44 )$$

where p_{Ω,γ}(β)≥0, ∀β, and Σ_{β}p_{Ω,γ}(β)=1. Thus, p_{Ω,γ} is a probability distribution. Henceforth, we consider any A_{β} for which p_{Ω,γ}(β)>0.
Now pick an a∈Ω and consider Tr(TₐA_{Ω}^{γ}). With Eq. (10), it holds that (−1)^{γ(a)}=Σ_{β}p_{Ω,γ}(β)(Tₐ [symbol] _{β}. Since p_{Ω,γ} is a probability distribution and | [symbol] Tₐ [symbol] _{β}|≤1 for all β, it follows that

[symbol]

Tₐ [symbol] _{β}=(−1)^{γ(a)},∀β with p_{Ω,γ}(β)>0.

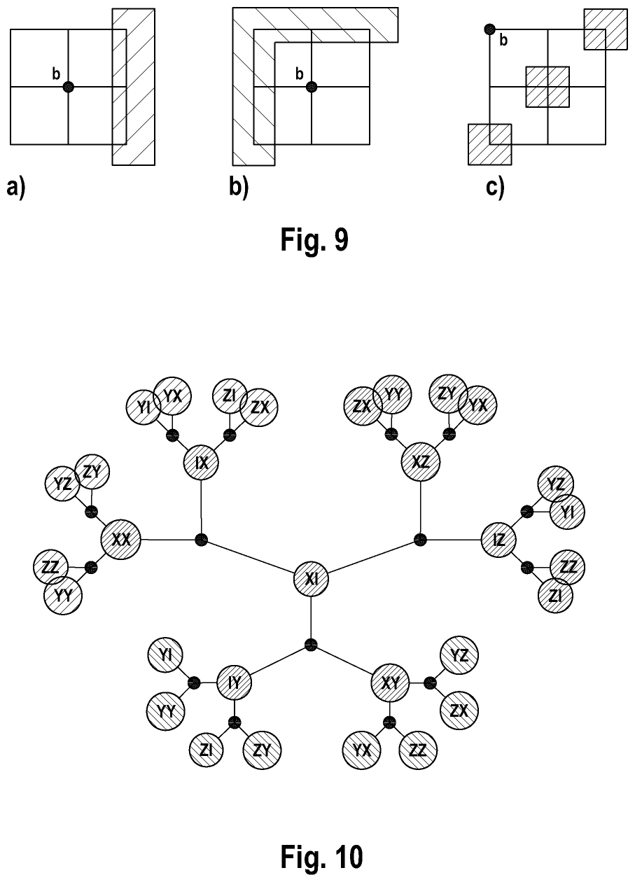

That is, every phase point operator that appears on the rhs. of Eq. (44) with non-zero coefficient agrees with A_{Ω}^{γ} on the expectation values [symbol] Tₐ [symbol] for all a∈Ω.
Now we turn to the expectation values for b∉Ω. Any set \tilde{Ω}⊂Vₙ that is closed under inference and contains both Ω and b is contextual, by the maximality of Ω. By Lemma 6, any such Ω contains a Mermin square M, and furthermore b∈M.
Since M is closed under inference, so is Ω∩M. Up to permutations of rows and columns, there are three possibilities for Ω∩M, which are displayed in FIG. 9. Thereof, possibility (a) can be excluded, since for no choice of b∈M\Ω does a Mermin-type contradiction arise if a value ±1 is associated with T_{b}. This contradicts the assumption. We are thus left with cases (b) and (c).

Case (b). For any b there exists a triple {x, y, z}⊂M\b such that [x, y]=[x, z]=[b, y]=[b, z]=0, [x, b]=[y, z]≠0. We have the following Mermin square:

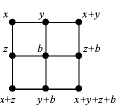

Therein, Mermin's contradiction to the existence of a non-contextual HVM is encapsulated in the operator relation (TₓT_{y}) (T_{z}T_{b})=−(TₓT_{z})(T_{y}T_{b}).
We choose the following phase conventions.

T_{x+y}=TₓT_{y},T_{z+b}=T_{z}T_{b},T_{x+z}=TₓT_{z},T_{y+b}=T_{y}T_{b}, (45)

and

T_{x+y+z+b}=T_{x+z}T_{y+b},T_{x+y+z+b}=−T_{x+y}T_{z+b}. (46)

Recall that with the first part of the proof [symbol] Tⱼ [symbol] _{β}=(−1)^{γ(j)}, for j=x, y, z. Now assume that [symbol] T_{b} [symbol] _{β}=v, with −1≤v≤1. Now, with Eq. (45)

[symbol]

T_{x+y} [symbol] _{β}=(−1)^{γ(x)+γ(y)}, [symbol] T_{x+z} [symbol] _{β}=(−1)^{γ(x)+γ(z)},

[symbol]

T_{y+b} [symbol] _{β},v/(−1)^{γ(y)}, [symbol] T_{z+b} [symbol] =v/(−1)^{γ(z)}.

Therefore, with Eq. (46),

[symbol]

T_{x+y+z+b} [symbol] _{β}=v(−1)^{γ(x)+γ(y)+γ(z)}=−v(−1)^{γ(x)+γ(y)+γ(z)}.

This is satisfiable only if v=0, and hence [symbol] T_{b} [symbol] _{β}=0.

Case (c). The argument is analogous to case (b), and we do not repeat it here. By the above case distinction, for any b∈Vₙ\Ω either case (b) or (c) applies, and each way the consequence is that [symbol] T_{b} [symbol] _{β}=0. Therefore, any phase point operator A_{β} that appears on the rhs of Eq. (44) with nonzero p_{Ω,γ}(β) agrees with A_{Ω}^{γ} on all expectation values of Pauli observables; hence A_{Ω}^{γ}=A_{β} for all such β.

Now assume there exists no such A_{β}. Taking the trace of Eq. (44) yields 1=0; contradiction. Hence, there must exist a β such that A_{Ω}^{γ}=A_{β}, for all (Ω,γ). ▪

4. Proof of Theorem 6

Proof of Theorem 6. Consider a stabilizer state [symbol] ∃|σ [symbol] =|s [symbol] s₁₂⊗|ϕ [symbol] _{3 . . . n}, where

X₁X₂|s [symbol] =−|s [symbol] ,

Z₁Z₂|s [symbol] =−|s [symbol] .

As a consequence of the latter we also have Z₁+Z₂|S [symbol] =0, and hence

e^{iφZ}^{₁}e^{iφZ}^{₂}|s [symbol] =|s [symbol] ,∀φ∈ [symbol] .

### Thus,

[symbol] s|TT [symbol] = [symbol] s|e^{iπ/8Z}^{₁}e^{iπ/8Z}^{₂}|T [symbol] |T [symbol]
= [symbol] s|++ [symbol]
=−( [symbol] s|X₁X₂)|++ [symbol]
=− [symbol] s|++ [symbol]
=0.
   Therefore, [symbol] σ|T^{⊗n} [symbol] =0, for all |ϕ [symbol] ∈ [symbol] ₙ₋₂. Thus, ρ_{n×T} is in the boundary of Δₙ. ▪

### APPENDIX B: VERTEX REPRESENTATIVES IN EACH CLIFFORD ORBIT

Here we provide one representative from each orbit under the action of the Clifford group on the vertices of Δ₂. Below we write [(x, y), . . . ] for the type of a vertex, where x is the absolute value of the expectation value with respect to a Pauli observable and y is the number of its occurrence. We write # for the number of vertices in an orbit. For each vertex we list the expectation value for each of the two qubit Pauli observables, II, IX, IY, etc. These values uniquely identify a vertex. The tables below give the probabilities associated with the projectors onto the 60 two-qubit stabilizer states. The first row of each table gives the generators of the corresponding stabilizer groups and the first column gives their signs. For example, the element in the third row, second column of each table is the value Tr(|σ [symbol] [symbol] σ|A_{α}) where A_{α} is the vertex is question, and |σ [symbol] is the stabilizer state with the stabilizer group [symbol] −XI, IX [symbol] .

1. Type 1 [(0,10), (1.6)]. #192

| | IX | IY | IZ | XI | XX | XY | XZ | YI | YX | YY | YZ | ZI | ZX | ZY | ZZ |
|---|---|---|---|---|---|---|---|---|---|---|---|---|---|---|---|
| II | 0 | −1 | −1 | 0 | 1 | 0 | 0 | 0 | −1 | 0 | 0 | 0 | −1 | 0 | 0 |
| 1 | XI, | XI, | XI, | YI, | YI, | YI, | ZI, | ZI, | ZI, | XY, | XZ, | YZ, | XY, | XZ, | XX, |
| s\I | IX | IY | IZ | IX | IY | IZ | IX | IY | IZ | YX | ZX | ZY | ZX | YX | YY |
| 11 | 1/2 | 0 | 0 | 0 | 0 | 0 | 0 | 0 | 0 | 0 | 0 | 1/2 | 0 | 0 | 1/2 |
| −11 | 0 | 0 | 0 | 1/2 | 0 | 0 | 1/2 | 0 | 0 | 0 | 0 | 0 | 0 | 0 | 0 |
| 1-1 | 0 | 1/2 | 1/2 | 1/2 | 1/2 | 1/2 | 1/2 | 1/2 | 1/2 | 1/2 | 1/2 | 0 | 1/2 | 1/2 | 1/2 |
| −1-1 | 1/2 | 1/2 | 1/2 | 0 | 1/2 | 1/2 | 0 | 1/2 | 1/2 | 1/2 | 1/2 | 1/2 | 1/2 | 1/2 | 0 |

2. Type 2 [(0,8), (1,8)], #240

| | IX | IY | IZ | XI | XX | XY | XZ | YI | YX | YY | YZ | ZI | ZX | ZY | ZZ |
|---|---|---|---|---|---|---|---|---|---|---|---|---|---|---|---|
| II | 0 | −1 | 0 | 0 | 1 | 0 | −1 | −1 | 0 | 1 | 0 | 0 | −1 | 0 | −1 |
| 1 | XI, | XI, | XI, | YI, | YI, | YI, | ZI, | ZI, | ZI, | XY, | XZ, | YZ, | XY, | XZ, | XX, |
| s\I | IX | IY | IZ | IX | IY | IZ | IX | IY | IZ | YX | ZX | ZY | ZX | YX | YY |
| 11 | 1/2 | 0 | 0 | 0 | 0 | 0 | 0 | 0 | 0 | 0 | 0 | 1/2 | 0 | 0 | 1 |
| −11 | 0 | 0 | 1/2 | 1/2 | 0 | 1/2 | 1/2 | 0 | 1/2 | 1/2 | 0 | 0 | 0 | 1/2 | 0 |
| 1-1 | 0 | 1/2 | 1/2 | 0 | 0 | 0 | 1/2 | 1/2 | 1/2 | 1/2 | 0 | 0 | 1/2 | 0 | 0 |
| −1-1 | 1/2 | 1/2 | 0 | 1/2 | 1 | 1/2 | 0 | 1/2 | 0 | 0 | 1 | 1/2 | 1/2 | 1/2 | 0 |

3. Type 3 [(0,6), (½, 6), (1,4)],1920

| | IX | IY | IZ | XI | XX | XY | XZ | YI | YX | YY | YZ | ZI | ZX | ZY | ZZ |
|---|---|---|---|---|---|---|---|---|---|---|---|---|---|---|---|
| II | −1/2 | −1/2 | −1/2 | 1/2 | 0 | 0 | −1 | −1/2 | 0 | 1 | 0 | 1/2 | −1 | 0 | 0 |
| 1 | XI, | XI, | XI, | YI, | YI, | YI, | ZI, | ZI, | ZI, | XY, | XZ, | YZ, | XY, | XZ, | XX, |
| s\I | IX | IY | IZ | IX | IY | IZ | IX | IY | IZ | YX | ZX | ZY | ZX | YX | YY |
| 11 | 1/4 | 1/4 | 0 | 0 | 1/4 | 0 | 0 | 1/4 | 1/4 | 1/4 | 0 | 1/4 | 0 | 0 | 1/2 |
| −11 | 0 | 0 | 1/4 | 1/4 | 0 | 1/4 | 1/4 | 0 | 0 | 1/4 | 0 | 1/4 | 0 | 1/2 | 1/2 |
| 1-1 | 1/2 | 1/2 | 3/4 | 1/4 | 0 | 1/4 | 3/4 | 1/2 | 1/2 | 1/4 | 0 | 1/4 | 1/2 | 0 | 0 |
| −1-1 | 1/4 | 1/4 | 0 | 1/2 | 3/4 | 1/2 | 0 | 1/4 | 1/4 | 1/4 | 1 | 1/4 | 1/2 | 1/2 | 0 |

4. Type 4 [(0.5), (½,10), (1,1)], 2304

| | IX | IY | IZ | XI | XX | XY | XZ | YI | YX | YY | YZ | ZI | ZX | ZY | ZZ |
|---|---|---|---|---|---|---|---|---|---|---|---|---|---|---|---|
| II | −1/2 | 0 | 0 | 1/2 | 0 | 1/2 | 1/2 | −1/2 | 0 | −1/2 | 1/2 | −1/2 | 0 | 1/2 | 1/2 |
| 1 | XI, | XI, | XI, | YI, | YI, | YI, | ZI, | ZI, | ZI, | XY, | XZ, | YZ, | XY, | XZ, | XX, |
| s\I | IX | IY | IZ | IX | IY | IZ | IX | IY | IZ | YX | ZX | ZY | ZX | YX | YY |
| 11 | 1/4 | 1/2 | 1/2 | 0 | 0 | 1/4 | 0 | 1/4 | 1/4 | 1/2 | 1/4 | 1/2 | 1/4 | 1/4 | 0 |
| −11 | 0 | 0 | 0 | 1/4 | 1/2 | 1/4 | 1/4 | 1/4 | 1/4 | 0 | 1/4 | 1/4 | 1/4 | 1/4 | 1/4 |
| 1-1 | 1/2 | 1/4 | 1/4 | 1/4 | 1/4 | 0 | 1/4 | 0 | 0 | 1/4 | 1/2 | 1/4 | 1/2 | 1/2 | 1/2 |
| −1-1 | 1/4 | 1/4 | 1/4 | 1/2 | 1/4 | 1/2 | 1/2 | 1/2 | 1/2 | 1/4 | 0 | 0 | 0 | 0 | 1/4 |

5. Type 5 [(0,5), (½, 8), (1,3)], 5760

| | IX | IY | IZ | XI | XX | XY | XZ | YI | YX | YY | YZ | ZI | ZX | ZY | ZZ |
|---|---|---|---|---|---|---|---|---|---|---|---|---|---|---|---|
| II | −1/2 | 0 | −1/2 | 0 | 1/2 | 0 | −1/2 | 1/2 | −1 | 1/2 | −1 | −1/2 | 0 | −1/2 | 0 |
| 1 | XI, | XI, | XI, | YI, | YI, | YI, | ZI, | ZI, | ZI, | XY, | XZ, | YZ, | XY, | XZ, | XX, |
| s\I | IX | IY | IZ | IX | IY | IZ | IX | IY | IZ | YX | ZX | ZY | ZX | YX | YY |
| 11 | 1/4 | 1/4 | 0 | 0 | 1/2 | 0 | 0 | 0 | 0 | 0 | 1/4 | 0 | 1/2 | 0 | 1/2 |
| −11 | 0 | 1/4 | 1/4 | 1/4 | 0 | 1/4 | 1/4 | 1/2 | 1/4 | 0 | 1/4 | 1/4 | 0 | 0 | 1/4 |
| 1-1 | 1/4 | 1/4 | 1/2 | 3/4 | 1/4 | 3/4 | 1/4 | 1/4 | 1/4 | 1/2 | 0 | 0 | 0 | 1/4 | 1/4 |
| −1-1 | 1/2 | 1/4 | 1/4 | 0 | 1/4 | 0 | 1/2 | 1/4 | 1/2 | 1/2 | 1/2 | 3/4 | 1/2 | 3/4 | 0 |

6. Type 6 [(0,3), (½,10), (1,3)], #3840

| | IX | IY | IZ | XI | XX | XY | XZ | YI | YX | YY | YZ | ZI | ZX | ZY | ZZ |
|---|---|---|---|---|---|---|---|---|---|---|---|---|---|---|---|
| II | −1/2 | −1/2 | −1/2 | −1/2 | 1 | 0 | 0 | −1 | 1/2 | 1/2 | 1/2 | 0 | −1/2 | 1/2 | −1/2 |
| 1 | XI, | XI, | XI, | YI, | YI, | YI, | ZI, | ZI, | ZI, | XY, | XZ, | YZ, | XY, | XZ, | XX, |
| s\I | IX | IY | IZ | IX | IY | IZ | IX | IY | IZ | YX | ZX | ZY | ZX | YX | YY |
| 11 | 1/4 | 0 | 0 | 0 | 0 | 0 | 0 | 1/4 | 0 | 1/4 | 1/4 | 3/4 | 0 | 1/4 | 3/4 |
| −11 | 0 | 1/4 | 1/4 | 1/4 | 1/4 | 1/4 | 1/4 | 0 | 1/4 | 1/2 | 0 | 0 | 1/4 | 1/2 | 0 |
| 1-1 | 0 | 1/4 | 1/4 | 0 | 0 | 0 | 1/2 | 1/4 | 1/2 | 1/4 | 1/4 | 0 | 1/2 | 1/4 | 1/4 |
| −1-1 | 3/4 | 1/2 | 1/2 | 3/4 | 3/4 | 3/4 | 1/4 | 1/2 | 1/4 | 0 | 1/2 | 1/4 | 1/4 | 0 | 0 |

7. Type 7 [(0,2), (⅓, 6), (⅔, 6), (1,2)], #5760

| | IX | IY | IZ | XI | XX | XY | XZ | YI | YX | YY | YZ | ZI | ZX | ZY | ZZ |
|---|---|---|---|---|---|---|---|---|---|---|---|---|---|---|---|
| II | −2/3 | −1/3 | 0 | −1/3 | 2/3 | −1/3 | −2/3 | 0 | −1/3 | 2/3 | −1/3 | 2/3 | −1 | −2/3 | −1/3 |
| 1 | XI, | XI, | XI, | YI, | YI, | YI, | ZI, | ZI, | ZI, | XY, | XZ, | YZ, | XY, | XZ, | XX, |
| s\I | IX | IY | IZ | IX | IY | IZ | IX | IY | IZ | YX | ZX | ZY | ZX | YX | YY |
| 11 | 1/6 | 0 | 0 | 0 | 1/3 | 1/6 | 0 | 1/6 | 1/3 | 0 | 0 | 1/6 | 0 | 1/6 | 2/3 |
| −11 | 0 | 1/3 | 1/2 | 1/6 | 0 | 1/3 | 1/6 | 1/6 | 1/6 | 1/3 | 0 | 0 | 0 | 1/6 | 1/6 |
| 1-1 | 1/6 | 1/3 | 1/3 | 1/2 | 1/6 | 1/3 | 5/6 | 2/3 | 1/2 | 1/3 | 1/6 | 1/6 | 1/3 | 0 | 1/6 |
| −1-1 | 2/3 | 1/3 | 1/6 | 1/3 | 1/2 | 1/6 | 0 | 0 | 0 | 1/3 | 5/6 | 2/3 | 2/3 | 2/3 | 0 |

8. Type 8 [(¼, 5), (½, 5), (¾, 5), (1,1)], #2304

| | IX | IY | IZ | XI | XX | XY | XZ | YI | YX | YY | YZ | ZI | ZX | ZY | ZZ |
|---|---|---|---|---|---|---|---|---|---|---|---|---|---|---|---|
| II | −1/2 | −1/2 | 1/4 | 3/4 | −3/4 | −3/4 | 1/2 | 1/4 | −3/4 | 1/4 | −1/2 | −1/4 | −1/4 | 3/4 | 1/2 |
| 1 | XI, | XI, | XI, | YI, | YI, | YI, | ZI, | ZI, | ZI, | XY, | XZ, | YZ, | XY, | XZ, | XX, |
| s\I | IX | IY | IZ | IX | IY | IZ | IX | IY | IZ | YX | ZX | ZY | ZX | YX | YY |
| 11 | 1/8 | 1/8 | 5/8 | 0 | 1/4 | 1/4 | 0 | 1/4 | 3/8 | 0 | 3/8 | 1/8 | 1/8 | 0 | 0 |
| −11 | 1/8 | 1/8 | 0 | 1/4 | 0 | 3/8 | 1/4 | 0 | 1/4 | 1/8 | 0 | 3/4 | 1/4 | 1/8 | 5/8 |
| 1-1 | 3/4 | 3/4 | 1/4 | 5/8 | 3/8 | 3/8 | 3/8 | 1/8 | 0 | 1/8 | 3/8 | 1/8 | 0 | 3/4 | 1/8 |
| −1-1 | 0 | 0 | 1/8 | 1/8 | 3/8 | 0 | 3/8 | 5/8 | 3/8 | 3/4 | 1/4 | 0 | 5/8 | 1/8 | 1/4 |

### APPENDIX C: ISOTROPIC SUBSPACES OF E₂ AND SACHS SUBGRAPHS

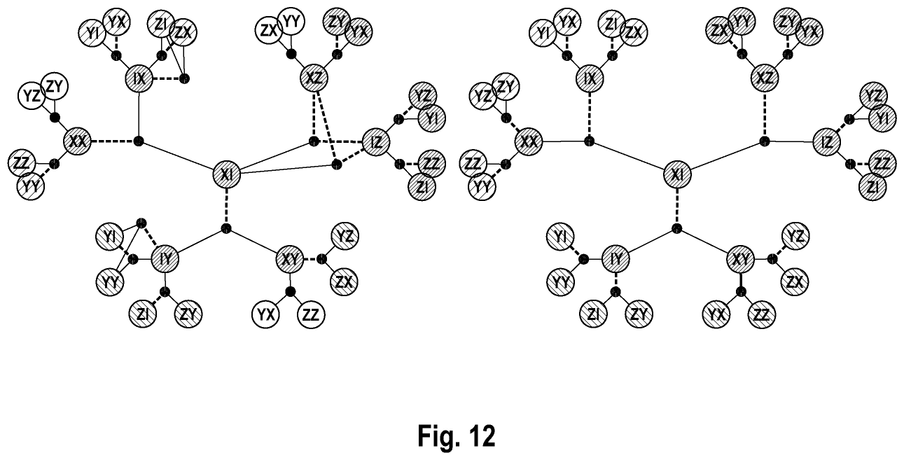

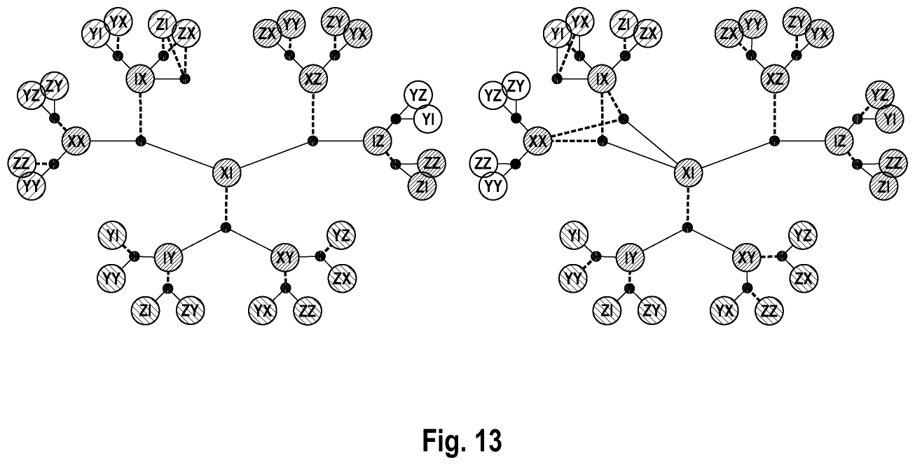

In FIG. 10 the isotropic subspaces of E₂ of dimension 1 and 2 are listed. FIG. 10 shows the poset of isotropic subspaces of E₂. The vertices which include Pauli operator symbols “IX”, “YZ” and the like correspond to the isotropic subspaces of dimension 1. Solid black vertices correspond to the isotropic subspaces of dimension 2. Each vertex at the boundary repeats 3 times which are identified. In FIGS. 11, 12 and 13 it is shown that [symbol] (Sᵢ) for i=1, 2, . . . , 8 has full perrank. The corresponding Sachs subgraph is demonstrated by the dashed lines. FIG. 11 shows g on the left and [symbol] (S₂) on the right. FIG. 12 shows [symbol] (S₃) on the left and [symbol] (S₄)≈ [symbol] (S₈) on the right. FIG. 13 shows [symbol] (S₇)≈g(S₅) on the left and [symbol] (S₆) on the right.

### APPENDIX D: A REFINED CLASSICAL SIMULATION ALGORITHM

This section describes a refined sampling algorithm. It can be used to make a similar point as Theorem 11, but without the restriction to sequences of commuting measurements. This leads to Theorem 13.

1. An Algorithm for Sampling on Successively Smaller Δₙ

As described herein, a classical simulation algorithm for universal quantum computation in the magic state model is provided. This algorithm is based on recursive sampling from the set of extremal vertices of the state polytope Δₙ, where n may be the number of magic states involved (or, in a simpler version, the number of magic states plus size of initial quantum register with all qubits in 10)).

Now, we describe a variant of this algorithm where the sampling is from the extremal vertices of successively smaller polytopes,

Δₙ→Δₙ₋₁→Δₙ₋₂→ . . . →Δ₂→Δ₁

This modified algorithm naturally incorporates as limiting cases several ad-hoc observations that we can make about QCM:
If one measures an observable Tₐ in time step t with outcome sₐ, and the same observable again in time step t+1, then the outcome of this second measurement has to be s_{ci} with certainty.
If one measures an observable Tₐ in time step t with any outcome, and in step t+1 an observable T_{b} that does not commute with Tₐ, then the outcome s_{b}∈ [symbol] ₂ of the second measurement is guaranteed to be completely random.
After a sufficiently long sequence of Pauli measurements, the initial magic state configuration may have been reduced to a stabilizer state. From that point onwards, the classical simulation of further Pauli measurements is efficient.

All the above is phenomenology covered by the Gottesman-Knill theorem, and below we unify our classical simulation method with the stabilizer formalism underlying that theorem.

To begin, we set up some notation. The total number of qubits is n, and we denote by t the number of the time step. The state operator Ã_{α}(t) (our generalization of the density matrix) at time t takes the form

Ã_{α}(t)=W(t)(A_{α}(t)⊗Π⁺(t))W(t)^{†}, (47)

where W(t) is an n-qubit Clifford unitary, W(t)∈Clₙ, for all times t. Further, α∈ [symbol] _{K(t)}, with α∈ [symbol] _{K(t)} the generalized phase space (=set of labels for the extremal vertices of Δ_{K(t)}).

The size of the factors in the tensor product between A_{α}(t) and Π⁺(t) is changing in time. The first subset of the n qubits, where A_{α}(t) is supported on is denoted by A(t), A(t)={1, 2, . . . , K(t)} K(t)=|A(t)|), and Π⁺(t) is supported on B(t)={K(t)+1, . . . , n}. Furthermore, A(t) is an extremal vertex of the polytope Δ_{K(t)} (We observe that, by Theorem 1, Ã(t) is a vertex of Δₙ. However, we will not invoke that fact below), and

Π⁺(t):=⊗_{i∈B(t)}|+ [symbol] ᵢ [symbol] +|.

We denote the Pauli observable measured in step t by Tₐ₍ₜ₎. Finally, for subsequent use, we set

W(t)^{†}Tₐ₍ₜ₎W(t)=:R_{A(t)}(t)⊗S_{B(t)}(t), (48)

subject to the additional constraint both R_{A(t)}(t) and S_{B(t)}(t) are Hermitian Pauli operators. This condition constrains either factor up to a sign. We specify this sign below, where needed.
Theorem 12 The classical simulation Algorithm 2 (see Table 3) reproduces the predictions of quantum mechanics.

TABLE 3
Algorithm 2: Refined classical simulation algorithm that involves sampling from
successively smaller state polytopes Δₙ, Δₙ₋₁, ... , Δ₁.

| 1. | Sample from the probability distribution p_{ρ} of the initial state ρ. Obtain a phase | | |
|---|---|---|---|
| | space point α₀. | | |
| 2. | Initialize W(t) = I, K(1) = n. | | |
| 3. | For all measurements of Pauli observables Tₐ₍ₜ₎, t = 1, ... , tₘₐₓ, update the triple | | |
| | (K(t), α(t), W(t)), starting with t = 1, as follows: | | |
| | a. | Obtain the Pauli operators R(t) and S(t) (up to sign for now) through Eq. | |
| | | (48). | |
| | b. | Determine which case of the case distinction applies, and act accordingly. | |
| | | | Case Ia: [S(t), Π⁺(t)] = 0 and R(t) = ±I. Choose S(t) such that |
| | | | S(t)Π⁺(t) = +Π⁺(t). Output the measurement outcome sₐ₍ₜ₎ = |
| | | | 0 if R(t) = +I, and sₐ₍ₜ₎ = 1 if R(t) = −I. The update of A_{α}, W |
| | | | and K is given by Eq. (54), i.e. no update at all. |
| | | | Case Ib: [S(t), Π⁺(t)] = 0 and R(t) ≠ ±I. The measurement |
| | | | outcome sₐ₍ₜ₎ and the new phase point α(t + 1) are obtained from |
| | | | sampling the probability distribution q_{a(t),a(t)} of Eq. (58). The |
| | | | update of W and K are according to Eq. (57). |
| | | | Case II: [S(t), Π⁺(t)] ≠ 0. The measurement outcome sₐ₍ₜ₎ is |
| | | | the result of an unbiased coin flip. The update of A_{α}, W and K is |
| | | | according to Eq. (60). |

Proof of Theorem 12. The update under Pauli measurement is as follows. First, the measurement outcome probabilities.

$${p}_{a ( t ) , \pm } = T r ( \frac{I \pm {T}_{a ( t )}}{2} \tilde{A} ( t ) ) = Tr ( \frac{I \pm {W ( t )}^{†} {T}_{a ( t )} W ( t )}{2} {A}_{α} ( t ) ⊗ {Π}^{+} ( t ) ) .$$

With Eq. (48) this gives

$${p}_{a ( t ) , \pm } = \frac{1}{2} ( 1 \pm T {r}_{A ( t )} ( R ( t ) {A}_{α} ( t ) ) T {r}_{B ( t )} ( S ( t ) {Π}^{+} ( t ) ) ) \qquad ( 49 )$$

We need to distinguish between two cases.

Case I: [S(t), Π⁺(t)]=0. If this holds, then since Π⁺(t) is rank 1, we further have

S(t)Π⁺=±Π⁺.

We now choose the sign S(t) such that the above relation holds with sign “+”. This also affects the choice of the sign for R(t). Eq. (49) thus simplifies to

$${p}_{a ( t ) , \pm } = \frac{1}{2} ( 1 \pm T {r}_{A ( t )} ( R ( t ) {A}_{α} ( t ) ) ) . \qquad ( 50 )$$

Case II. [S(t), Π⁺(t)]≠0. If this holds, since S(t) is a Pauli operator, it follows e.g. by the stabilizer formalism that Tr_{B(t)}(S(t)Π⁺(0)=0. Therefore, Eq. (49) simplifies to

$${p}_{a ( t ) , \pm } = \frac{1}{2} . \qquad ( 51 )$$

Second, we examine the post-measurement state of the t-th measurement. For the unnormalized post-measurement states we have

$${p}_{a ( t ) , \pm } \tilde{A} ( t + 1 ) = \frac{I \pm {T}_{a ( t )}}{2} \tilde{A} ( t ) \frac{I \pm {T}_{a ( t )}}{2} ,$$

and hence

$${p}_{a ( t ) , \pm } \tilde{A} ( t + 1 ) = W ( t ) \frac{I \pm R ( t ) ⊗ S ( t )}{2} {A}_{α} ( t ) ⊗ {Π}^{+} ( t ) \frac{I \pm R ( t ) ⊗ S ( t )}{2} {W ( t )}^{†} . \qquad ( 52 )$$

To proceed, we need to distinguish the same two cases as before.

Case I: [S(t), Π⁺(0]=0. With the same reasoning and the same phase convention for S(t) as above, Eq. (52) simplifies to

$${p}_{a ( t ) , \pm } \tilde{A} ( t + 1 ) = W ( t ) ( \frac{I \pm R ( t )}{2} {A}_{α} ( t ) \frac{I \pm R ( t )}{2} ⊗ {Π}^{+} ( t ) ) {W ( t )}^{†} .$$

Subcase Ia: R(t)=±I. With the above we have Ã(t+1)=W(t)(A_{α}(t)⊗Π⁺(t))w(t)^{†}. Further, p_{a(t),+}=1, p_{a(t),-}=0 for R(t)=+I, and the other way around for R(t)=−I. The measurement outcome is therefore, with certainty,

s_{α(t)}=0,if R(t)=+I,

sₐ₍ₜ₎=1,if R(t)=−I. (53)

This is the output provided by Algorithm 2 for case Ia. We may further write Ã(t+1)=W(t+1)(A_{α}(t+1)⊗Π(t+1))W(t+1)^{†}, which is the required form, based on the update rules

A_{α}(t) [symbol] A_{α}(t+1)=A_{α}(t),

W(t) [symbol] W(t+1)=W(t),

K(t) [symbol] K(t+1)=K(t). (54)

I.e. the update is trivial. In particular, the phase point α doesn't change. No sampling is involved in the update.

Subcase Ib: R(t)≠±I (main subcase). Denoting the last qubit in A(t) by A(t):K(t), we find a Clifford unitary V(t)∈Cl_{K(t)} with the property that

R(t)=V(t)X_{A(t):K(t)}V(t)^{†}. (55)

### Thus,

$${p}_{a ( t ) , \pm } \tilde{A} ( t + 1 ) = W ( t ) V ( t ) ( \frac{I \pm {X}_{A ( t ) : K ( t )}}{2} {V ( t )}^{†} {A}_{α} ( t ) V ( t ) \frac{I \pm {X}_{A ( t ) : K ( t )}}{2} ⊗ {Π}^{+} ( t ) ) {V ( t )}^{†} {W ( t )}^{†} .$$

Therein, we define B_{α,+}(t+1) through the relation

$$\frac{I \pm {X}_{A ( t ) : K ( t )}}{2} {V ( t )}^{†} {A}_{α} ( t ) V ( t ) \frac{I \pm {X}_{A ( t ) : K ( t )}}{2} = : {B}_{α , \pm } ( t + 1 ) ⊗ \frac{I \pm {X}_{A ( t ) : K ( t )}}{2} . \qquad ( 56 )$$

The operator B_{α,±}(t+1) lives on A(t+1) defined, in the present case, by K(t+1)=K(t)−1. Further,

$$\frac{I \pm {X}_{A ( t ) : K ( t )}}{2} ⊗ {Π}^{+} ( t ) = {Π}^{+} ( t + 1 ) .$$

$$Thus ,$$

$${p}_{a ( t ) , \pm } \tilde{A} ( t + 1 ) = W ( t ) V ( t ) ( {B}_{α , \pm } ( t + 1 ) ⊗ {Π}^{+} ( t + 1 ) ) {V ( t )}^{†} {W ( t )}^{†} .$$

The update therefore is

A_{α}(t) [symbol] B_{α,±}(t+1),

W(t) [symbol] W(t+1)=W(t)V(t),

K(t) [symbol] K(t+1)=K(t)−1, (57)

with B_{α,±}(t+1) given by Eq. (56), and V(t)∈Cl_{K(t)} (constrained by Eq. (55).
We now show that B_{α,±}(t+1)/p_{a(t),±}∈Δ_{K(t+1)} (which immediately follows from Part (1) of Theorem 7, but we provide a more direct proof). For this, we return to the defining relation of B, Eq. (56). On both sides, we multiply with the projector |σ [symbol] _{A(t)\K(t)} [symbol] σ|⊗|0 [symbol] _{A(t):K(t)} [symbol] 0|, and then take the trace. Denoting |σ_{±}′ [symbol] :=V(t)(|σ)⊗|± [symbol] ) we obtain¹ ¹ Note that the trace on the left is over A(t) and the trace on the right is over A(t+1)=A(t)\K(t).

Tr(A_{α}(t)|σ_{±}′ [symbol] σ_{±}′|)=Tr(B_{α,±}(t+1)|σ [symbol] σ|)

For any stabilizer state |σ [symbol] , |σ_{±}′ [symbol] is also a stabilizer state, and since A_{α}(t)∈A_{K(t)}, it holds that Tr(A_{α}(t)|σ_{±′} [symbol] _{σ}_{±}′)≥0. Therefore,

Tr(B_{α,±}(t+1)|σ [symbol] σ|)≥0,

for all stabilizer states |σ [symbol] . Furthermore, B_{α,±}(t+1)/p_{a(t),±} has unit trace and is Hermitian.
Therefore, B_{α,±}(t+1)/p_{a(t),±}∈Δ_{K(t+1)} as claimed. And thus,

$${B}_{\pm } ( t + 1 ) = {\sum }_{β ∈ {V}_{K ( t + 1 )}} {q}_{α , a} ( β , {s}_{a ( t )} ) {A}_{β} , \qquad ( 58 )$$

with q_{α,a} a probability function for all α and a. Thus, the update of the phase point α in step t to phase point β in step t+1, along with obtaining the outcome sₐ₍ₜ₎, is by sampling from q_{α,a}. We have already shown the correctness of this sampling procedure in Theorem 2 of [36].

Case II: [S(t),Π⁺(t)]≠0. We find a Clifford unitary V∈Clₙ with the properties

R(t)⊗S(t)=V(t)(I_{A(t)}⊗Z_{B(t):1})V(t)^{†}, (59a)

I⊗Π⁺(t)=V(t)^{†}(I⊗Π⁺(t))V(t). (59b)

Therein, B(t): 1 is the first qubit of the set B(t), i.e., qubit number K(t)+1 overall. A unitary V(t) satisfying Eq. (59) always exists. Using this in Eq. (52) we find

$$\begin{matrix}{p}_{a ( t ) , \pm } \tilde{A} ( t + 1 ) = W ( t ) V ( t ) \frac{I \pm {Z}_{B ( t ) : 1}}{2} {V ( t )}^{†} ( {A}_{α} ( t ) ⊗ \\ {Π}^{+} ( t ) ) V ( t ) \frac{I \pm {Z}_{B ( t ) : 1}}{2} {V ( t )}^{†} {W ( t )}^{†} \\ = W ( t ) V ( t ) \frac{I \pm {Z}_{B ( t ) : 1}}{2} {V ( t )}^{†} ( {A}_{α} ( t ) ⊗ I ) V ( t ) {V ( t )}^{†} ( I ⊗ \\ {Π}^{+} ( t ) ) V ( t ) \frac{I \pm {Z}_{B ( t ) : 1}}{2} {V ( t )}^{†} {W ( t )}^{†} \\ = W ( t ) V ( t ) \frac{I \pm {Z}_{B ( t ) : 1}}{2} {V ( t )}^{†} ( {A}_{α} ( t ) ⊗ I ) V ( t ) ( I ⊗ \\ {Π}^{+} ( t ) ) \frac{I \pm {Z}_{B ( t ) : 1}}{2} {V ( t )}^{†} {W ( t )}^{†} \\ = W ( t ) V ( t ) \frac{I \pm {Z}_{B ( t ) : 1}}{2} {V ( t )}^{†} ( {A}_{α} ( t ) ⊗ I ) V ( t ) ( I ⊗ \\ {Π}^{+} ( t ) ) \frac{{{H}_{B ( t ) : 1} ( {X}_{B ( t ) : 1} )}^{{s}_{a ( t )}}}{\sqrt{2}} {V ( t )}^{†} {W ( t )}^{†} \\ = W ( t ) V ( t ) \frac{I \pm {Z}_{B ( t ) : 1}}{2} {V ( t )}^{†} ( {A}_{α} ( t ) ⊗ I ) ( I ⊗ \\ {Π}^{+} ( t ) ) V ( t ) \frac{{{H}_{B ( t ) : 1} ( {X}_{B ( t ) : 1} )}^{{s}_{a ( t )}}}{\sqrt{2}} {V ( t )}^{†} {W ( t )}^{†} \\ = W ( t ) V ( t ) \frac{I \pm {Z}_{B ( t ) : 1}}{2} {V ( t )}^{†} ( I ⊗ {Π}^{+} ( t ) ) ( {A}_{α} ( t ) ⊗ \\ I ) V ( t ) \frac{{{H}_{B ( t ) : 1} ( {X}_{B ( t ) : 1} )}^{{s}_{a ( t )}}}{\sqrt{2}} {V ( t )}^{†} {W ( t )}^{†} \\ = W ( t ) V ( t ) \frac{I \pm {Z}_{B ( t ) : 1}}{2} ( I ⊗ {Π}^{+} ( t ) ) {V ( t )}^{†} ( {A}_{α} ( t ) ⊗ \\ I ) V ( t ) \frac{{{H}_{B ( t ) : 1} ( {X}_{B ( t ) : 1} )}^{{s}_{a ( t )}}}{\sqrt{2}} {V ( t )}^{†} {W ( t )}^{†} \\ = W ( t ) V ( t ) \frac{{( {X}_{B ( t ) : 1} )}^{{s}_{a ( t )}} {H}_{B ( t ) : 1}}{\sqrt{2}} ( I ⊗ {Π}^{+} ( t ) ) {V ( t )}^{†} ( {A}_{α} ( t ) ⊗ \\ I ) V ( t ) \frac{{{H}_{B ( t ) : 1} ( {X}_{B ( t ) : 1} )}^{{s}_{a ( t )}}}{\sqrt{2}} {V ( t )}^{†} {W ( t )}^{†} \\ = \frac{1}{2} W ( t ) V ( t ) {( {X}_{B ( t ) : 1} )}^{{s}_{a ( t )}} {H}_{B ( t ) : 1} {V ( t )}^{†} ( {A}_{α} ( t ) ⊗ \\ {Π}^{+} ( t ) ) {{H}_{B ( t ) : 1} ( {X}_{B ( t ) : 1} )}^{{s}_{a ( t )}} V {( t )}^{†} {W ( t )}^{†}\end{matrix} .$$

Therein, the second line uses Eq. (59a), the third line is the insertion of the identity, the fourth line uses Eq. (59b), and the fifth line uses the fact that (I+Z)/2|+)=|0 [symbol] |+ [symbol] =|0 [symbol] /\sqrt{2}=H|+ [symbol] /\sqrt{2}. Lines 6 and 8 use Eq. (59b) again, line 7 the fact that A(t) and Π⁺(t) live on different tensor factors, hence commute. Line 9 uses the same argument as line 5, and line 10 uses Eq. (59b) again.
The upshot is

Ã(t+1)=W(t+1)(A_{α}(t+1)⊗Π⁺(t+1))W(t+1)^{†},

with

A_{α}(t+1)=A_{α}(t),

W(t+1)=W(t)V(t)(X_{B(t):1})^{s}^{ₐ₍ₜ₎}H_{B(t):1}V(t)^{†},

K(t+1)=K(t). (60)

Most importantly, the phase point α remains what it was. No sampling is involved in the update. The measurement outcome sₐ₍ₜ₎ is the result of an unbiased coin flip, p_{a(t),±}=½. ▪

2. Size of the Phase Space Needed for Sampling

Theorem 13 Given a quantum computation starts in the magic state |T [symbol] ^{⊗n}, the phase point operators Ã_{α(t)} being the notion of state in the classical simulation Algorithm 2 can be described each by 2n³+O(n²) bits.

That is, we have a classical efficient description of quantum states, and this description is powerful enough to be applied to universal quantum computation.

Proof of Theorem 13. As defined in Eq. (47), the operators Ã(t) that the classical simulation algorithm updates consists of three parts, namely the Clifford unitary W(t), the phase point operator A_{α}(t) on a reduced set A(t) of qubits, and the size K(t)=|A(t)| of that set. While the non-trivial sampling step only involves A,(t),W (t) is needed to execute the case distinction, and K(t) is needed in the update of W(t). Namely, K(t) affects V(t) in cases Ib and II, and V(t) in turn is involved in the update of W(t). We now discuss the memory requirements for these components separately.
(a) K(t). Since for all t, 0≤K(t)≤n, the memory consumption for K(t) is

mem[K(t)]≤[log₂n] bits,∀t. (61)
(b) W(t). Since W(t) is an n-qubit Clifford unitary, it is described, up to an irrelevant overall phase, by the images of the 2n Pauli operators Xᵢ, Zᵢ under W(t), i.e., W(t)XᵢW(t)^{†}, W(t)ZᵢW(t)^{†}, i=1, . . . , n. Straightforwardly this requires 2n×(2n+1) bits. However, Clifford transformations, being unitary, preserve the commutation relations. For those, we have to subtract 2n(2n−1)/2 bits worth of constraints. Thus,

mem[W(t)]=2n²+3n bits,∀t. (62)
(c) A_{α}(t). First we observe that Δ_{K(t)} is a polytope embedded in dimension 4^{K(t)}−1, and, by Caratheodory's theorem, every point in it can be represented as a probabilistic mixture of 4^{K(t)} vertices, or less. Given any operator B∈Δ_{K(t)}, it is possible to single out a definite support Supp(B) for such a probability distribution, and order the elements in it. With respect to that choice and ordering, every vertex label β appearing in the expansion can be described by 2K(t) bits. It is important to remember that Supp(B) is a function of B.
   We now specify the labels α(s) of A_{α}(s) as the result of a sequence of sampling processes. We observe that case Ib is the only one where A_{α}(s) is updated. The sampling history [symbol] (s) of α(s) is defined as

$$ℋ ( s ) = [ {α}_{0} ] ∪ {⋃}_{1 \leq t \leq s \vert ( S ( t ) {Π}^{+} = \pm {Π}^{+} ) ∧ ( S ( t ) \neq \pm I )} [ W ( t ) , K ( t ) , v ( t ) ] \times [ a ( t ) , {s}_{a ( t )} ] . \qquad ( 63 )$$

Therein, α₀ is the result of sampling from the distribution corresponding to the initial state |T [symbol] ^{⊗n}, and v(t) is the result of sampling in step t, v∈ [symbol] ₂^{2K(t+1)}.

We now prove by induction that for all times s the phase point label α(s) is fully specified by the sampling history [symbol] (s). Suppose the label α(t) of A_{α}(t) is fully specified, and the next measurement falls under case Ib (which is all we need to look at). Then, there is one bit worth of outcome sₐ₍ₜ₎ that needs to be stored. Conditioned on it, there is a definite support Supp (B_{α,±}(t+1)) for a probability distribution q_{α,α}. As per Eq. (56), the observable B_{α,±}(t+1), and therefore also Supp (B_{α,±}(t+1)), depend on V(t), α(t) and sₐ₍ₜ₎. Thereof, V(t) depends on K(t) and R(t), cf. Eq. (55), the latter of which in turn depends on a(t) and W(t), cf. Eq. (48). Therefore, tracing back all the dependencies, we find that Supp (B_{α,±}(t+1)) depends on [W(t), K(t), α(t)]×[a(t), sₐ₍ₜ₎]. Herein, the first triple represents the HVM state at time t (before the t-th measurement), and the second pair the t-th measurement.

The phase space a (t+1) is fully defined by v(t+1)∈ [symbol] ₂^{2K(t+1)}, the result of the sampling in round t+1, and Supp (B_{α,±}(t+1)). Regarding the first dependency, v(t+1)∈ [symbol] (t+1), cf. Eq. (63).

Regarding the second dependency of α(t+1), we observe that four of the five parameters of Supp(B_{α,±}(t+1)), namely W(t), K(t), a(t), sₐ₍ₜ₎, are explicitly contained in [symbol] (t), hence fully specified by it. We now invoke the induction assumption that a(t) is fully specified by [symbol] (t). Thus, [W(t), K(t), α(t)]×[a(t),sₐ₍ₜ₎] is fully specified by [symbol] (t); hence also by [symbol] (t+1) which contains the former as a subset. Thus, a(t+1) is fully specified by [symbol] (t+1). This concludes the induction step.

Also, for s=0 we find α(0)=α₀, which completes the induction proof that a(s) is fully specified by [symbol] (s) for all s.
We now count the information content in [symbol] (s). For a particular value K(t), with the above we have

$$mem [ [ W ( t ) , K ( t ) , v ( t ) ] \times [ a ( t ) , {s}_{a ( t )} ] ] \leq 2 {n}^{2} + 3 n + ⌈ {log}_{2} n ⌉ + 2 K ( t ) + 2 n + 1 = 2 {n}^{2} + O ( n ) .$$

Furthermore, the sum of Eq. (63) includes only terms that pertain to case Ib, and in this case, K(t) is reduced by 1 each time. There are thus at most n terms in the sum. Therefore,

mem[ [symbol] (s)]≤2n³+O(n²). (64)

The history [symbol] (s) contains all W(t) and K(t) besides α(t), so their memory requirements don't have to be counted separately. Therefore, the state [W(t), K(t), α(t)] is specified by at most 2n³+O(n²) bits. ▪

### REFERENCES

[1] V. Veitch, C. Ferrie, D. Gross, and J. Emerson, Negative Quasi-probability as a Resource for Quantum Computation, New J. Phys. 14, 113011 (2012).
[2] E. F. Galvao, Discrete Wigner functions and quantum computational speedup, Phys. Rev. A 71, 042302 (2005).
[3] Joel J. Wallman, Stephen D. Bartlett, Nonnegative subtheories and quasiprobability representations of qubits, Phys. Rev. A 85, 062121 (2012).
[4] M. Howard et al., Nature (London) 510, 351 (2014).
[5] N. Delfosse, P. Allard-Guerin, J. Bian and R. Raussendorf, Wigner Function Negativity and Contextuality in Quantum Computation on Rebits, Phys. Rev. X 5, 021003 (2015).
[6] R. Raussendorf, D. E. Browne, N. Delfosse, C. Okay, and J. Bermejo-Vega, Contextuality and Wigner function negativity in qubit quantum computation, Phys. Rev. A 95, 052334 (2017).
[7] Mark Howard, Earl T. Campbell, Application of a resource theory for magic states to fault-tolerant quantum computing, Phys. Rev. Lett. 118, 090501 (2017).
[8] Markus Heinrich, David Gross, Quantum 3, 132 (2019).
[9] L. Kocia and P. Love, Discrete Wigner Formalism for Qubits and Non-Contextuality of Clifford Gates on Qubit Stabilizer States, Phys. Rev. A 96, 062134 (2017).
[10] Robert Raussendorf, Juani Bermejo-Vega, Emily Tyhurst, Cihan Okay, Michael Zurel, Phase space simulation method for quantum computation with magic states on qubits, Phys. Rev. A 101, 012350 (2020); arXiv:1905.05374v2.
[11] William M. Kirby, Peter J. Love, Classical Simulation of Noncontextual Pauli Hamiltonians, arXiv:2002.05693v1.
[12] James R. Seddon, Bartosz Regula, Hakop Pashayan, Yingkai Ouyang, Earl T. Campbell, Quantifying quantum speedups: improved classical simulation from tighter magic monotones, arXiv:2002.06181v1.
[13] Hakop Pashayan, Joel J. Wallman, Stephen D. Bartlett, Estimating outcome probabilities of quantum circuits using quasiprobabilities, Phys. Rev. Lett. 115, 070501 (2015).
[14] D. Gross, Computational Power of Quantum Many-Body States and Some Results on Discrete Phase Spaces, Ph.D thesis, Imperial College London, 2005.
[15] K. S. Gibbons, M. J. Hoffman, and W. K. Wootters, Discrete Phase Space Based on Finite Fields, Phys. Rev. A 70, 062101 (2004).
[16]H. Zhu, Phys. Rev. Lett. 116, 040501 (2016).
[17] T Morimae, T. Koshiba, Impossibility of perfectly-secure one-round delegated quantum computation for classical client, arXiv: 1407.1636.
[18] S. Aaronson et al., Complexity-theoretic limitations on blind delegated quantum computation, arXiv: 1704.08482.
[19] Anne Broadbent, Joseph Fitzsimons, Elham Kashefi, Universal blind quantum computation, arXiv: 0807.4154.
[20] A. Peres, Quantum Theory: Concepts and Methods, Springer, 1995.
[21] Feynman, R. P.; Leighton, R. B.; Sands, M., Probability Amplitudes. The Feynman Lectures on Physics. Volume 3. Redwood City: Addison-Wesley (1989).
[22] S. Bravyi and A. Kitaev, Universal Quantum Computation with Ideal Clifford Gates and Noisy Ancillas, Phys. Rev. A 71, 022316 (2005).
[23] E. Tyhurst, Cost of contextuality quantified by a classical simulation of Mermin's Square, undergraduate thesis, UBC (2017).
[24] Michael J. Bremner, Richard Jozsa and Dan J. Shepherd, Classical simulation of commuting quantum computations implies collapse of the polynomial hierarchy, Proc. R. Soc. A, 467, 459 (2011).
[25] Michael J. Bremner, Ashley Montanaro, and Dan J. Shepherd, Average-Case Complexity Versus Approximate Simulation of Commuting Quantum Computations, Phys. Rev. Lett. 117, 080501 (2016).
[26] Scott Aaronson and Alex Arkhipov, The Computational Complexity of Linear Optics, Theory of Computing 9, 143 (2013).
[27] M. J. Hoban et al., Measurement-Based Classical Computation, Phys. Rev. Lett. 112, 140505 (2014).
[28] M. Aschbacher, Finite group theory, Vol. 10. Cambridge University Press, 2000.
[29] Fitzsimons, J. F. Private quantum computation: an introduction to blind quantum computing and related protocols. npj Quantum Inf 3, 23 (2017).
[30] Andrew M. Childs. 2005. Secure assisted quantum computation. Quantum Info. Comput. 5, 6 (September 2005), 456-466.
[31] Spekkens, Robert W. Contextuality for preparations, transformations, and unsharp measurements. Physical Review A 71.5 (2005)
[32] Schmid, David, Robert W. Spekkens, and Elie Wolfe. All the noncontextuality inequalities for arbitrary prepare-and-measure experiments with respect to any fixed set of operational equivalences. Physical Review A 97.6 (2018).
[33] Mermin, N. David. Hidden variables and the two theorems of John Bell. Reviews of Modern Physics 65.3 (1993).
[34] Chvatal, Vašgek, Linear Programming, Freeman Custom Publishing (1980).
[35] M. Nielsen and I. Chuang, Quantum Computation and Quantum Information, Cambridge University Press, 10th edition (2016).
[36] M. Zurel, C. Okay, R. Raussendorf, A hidden variable model for universal quantum computation with magic states on qubits, Phys. Rev. Lett. 125, 260404 (2020).
[37] M. Aschbacher. Finite group theory, volume 10 of Cambridge Studies in Advanced Mathematics. Cambridge University Press, Cambridge, 1986.
[38] B. Grünbaum. Convex polytopes, Springer Science & Business Media. volume 221, 2013.
[39] S. Akbari, A. Ghafari, K. Kazemian, M. Nahviem Some Criteria for a Signed Graph to Have Full Rank, Discrete Mathematics, 2020.
[40] Michael Beverland, Earl Campbell, Mark Howard, Vadym Kliuchnikov, Lower bounds on the non-Clifford resources for quantum computations, arXiv: 1904.01124.

### Interpretation of Terms

Unless the context clearly requires otherwise, throughout the description and the claims:
“in particular” means “for example” or “optionally”;
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms;
words that indicate directions such as “vertical”, “transverse”, “horizontal”, “upward”, “downward”, “forward”, “backward”, “inward”, “outward”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Embodiments of the invention may comprise computational systems or processors implemented using specifically designed hardware, configurable hardware, programmable data processors configured by the provision of software (which may optionally comprise “firmware”) capable of executing on the data processors, special purpose computers or data processors that are specifically programmed, configured, or constructed to perform one or more steps in a method as explained in detail herein and/or combinations of two or more of these. Examples of specifically designed hardware are: logic circuits, application-specific integrated circuits (“ASICs”), large scale integrated circuits (“LSIs”), very large scale integrated circuits (“VLSIs”), and the like. Examples of configurable hardware are: one or more programmable logic devices such as programmable array logic (“PALs”), programmable logic arrays (“PLAs”), and field programmable gate arrays (“FPGAs”). Examples of programmable data processors are: microprocessors, digital signal processors (“DSPs”), quantum computers, embedded processors, graphics processors, math co-processors, general purpose computers, server computers, cloud computers, mainframe computers, computer workstations, and the like. For example, one or more data processors in a control circuit for a device may implement methods as described herein by executing software instructions in a program memory accessible to the processors.

Processing may be centralized or distributed. Where processing is distributed, information including software and/or data may be kept centrally or distributed. Such information may be exchanged between different systems or other functional units by way of a communications network, such as a Local Area Network (LAN), Wide Area Network (WAN), or the Internet, wired or wireless data links, optical data links, electromagnetic signals, or other data communication channel(s).

For any embodiment described herein in which certain functions are performed at two or more systems (e.g. some combination of a first system, a second system and a third system) there is another embodiment of the invention in which those functions are provided by one system and there are other embodiments in which those functions are provided by different arrangements of two or more communicatively coupled systems.

Methods as described herein may be varied in ways that do not prevent achieving desired results of the methods. For example, where described embodiments present or perform steps, processes or blocks in a given order, alternative embodiments include methods in which some or all of the steps, processes or blocks are presented or performed in a different order or simultaneously or in parallel without changing an overall result of the method. Other variations may include deleting, moving, adding, subdividing, combining, and/or modifying some steps, processes or blocks to provide alternatives or subcombinations. Described steps processes or blocks may be implemented in a variety of different ways.

In some embodiments an aspect of the invention is provided in the form of a program product. The program product may comprise any non-transitory medium which carries a set of computer-readable instructions which, when executed by a data processor, cause the data processor to execute a method of the invention. Program products according to the invention may be in any of a wide variety of forms. The program product may comprise, for example, non-transitory media such as magnetic data storage media including floppy diskettes, hard disk drives, optical data storage media including CD ROMs, DVDs, electronic data storage media including ROMs, flash RAM, EPROMs, hardwired or preprogrammed chips (e.g., EEPROM semiconductor chips), nanotechnology memory, or the like. The computer-readable signals on the program product may optionally be compressed or encrypted.

In some embodiments, the invention may be implemented in software. For greater clarity, “software” includes any instructions executed on a processor, and may include (but is not limited to) firmware, resident software, microcode, and the like. Both processing hardware and software may be centralized or distributed (or a combination thereof), in whole or in part, as known to those skilled in the art. For example, software and other modules may be accessible via local memory, via a network, via a browser or other application in a distributed computing context, or via other means suitable for the purposes described above.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

Various features are described herein as being “in particular” or present in “some embodiments” or in an “aspect”. Such features are not mandatory in all embodiments and may not be present in all embodiments. Embodiments of the invention may include zero, any one or any combination of two or more of such features. All possible combinations of such features are contemplated by this disclosure even where such features are shown in different drawings and/or described in different sections, sentences or paragraphs. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible).

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

While the foregoing is directed to embodiments of the disclosure, other and further embodiments of the disclosure may be devised without departing from the basic scope thereof, and the scope thereof is determined by the claims that follow.

1. A method of simulating a quantum computation, comprising:
determining, by a first system (110) comprising one or more first processing units (112), a size parameter of a quantum computation, wherein the quantum computation is configured for solving a computational problem, wherein the size parameter is characteristic of an input size of the computational problem;
communicating, by the first system, the size parameter to a second system (120) comprising one or more second processing units (122);
communicating, by the second system, a computational key to the first system, wherein the computational key is based on the size parameter of the quantum computation; and
performing, by the first system, a simulation of the quantum computation based on the computational key.

2. The method according to claim 1, wherein the simulation of the quantum computation performed by the first system is a classical simulation performed by a non-quantum computing system.

3. The method according to claim 1, wherein performing the simulation of the quantum computation based on the computational key includes computing a solution to the computational problem based on the computational key.

4. The method according to claim 1, wherein the quantum computation is a first quantum computation (212), the method further comprising:
performing, by the first system, a simulation of a second quantum computation (214) based on the computational key, wherein the second quantum computation is different from the first quantum computation, wherein the second quantum computation has a size parameter which is equal to or less than the size parameter of the first quantum computation.

5. The method according to claim 1, wherein the quantum computation is a first quantum computation, the method further comprising:
communicating, by a third system (330), a size parameter of a second quantum computation to the second system, wherein the second quantum computation is different from the first quantum computation, wherein the size parameter of the second quantum computation is equal to or less than the size parameter of the first quantum computation;
communicating, by the second system, the computational key to the third system; and
performing, by the third system, a simulation of the second quantum computation based on the computational key.

6. The method according to claim 4, wherein the second quantum computation is configured to solve a second computational problem different from the first computational problem, wherein performing a simulation of the second quantum computation based on the computational key includes computing a solution to the second computational problem based on the computational key.

7. The method according to claim 1, wherein the quantum computation is a first quantum computation, the method further comprising:
performing a simulation of a plurality of quantum computations based on the computational key, wherein each quantum computation of the plurality of quantum computations has a size parameter which is equal to or less than the size parameter of the first quantum computation, wherein the plurality of quantum computations includes 3, 4, 5, 6, 7, 8, 9, 10 or more quantum computations.

8. The method according to claim 1, wherein the size parameter of the quantum computation increases as the input size of the computational problem increases.

9. The method according to claim 1, wherein the computational key depends only on the size parameter of the quantum computation, such that two quantum computations which are different from each other but which have the same size parameter result in the same computational key.

10. The method according to claim 1, wherein all measurements performed in the quantum computation are Pauli measurements, and/or wherein all unitary operations performed in the quantum computation are Clifford unitary operations.

11. The method according to claim 1, wherein the quantum computation includes an input quantum state, particularly wherein the input quantum state is not a Pauli stabilizer state.

12. The method according to claim 11, wherein the input quantum state includes or consists of a tensor product of K first quantum states and a tensor product of N second quantum states, wherein each first quantum state is a Pauli stabilizer state and each second quantum state is not a Pauli stabilizer state.

13. The method according to claim 12, wherein the size parameter of the quantum computation depends on at least one of:
the number N of second quantum states; and
the total number of qubits of the N second quantum states, particularly wherein each i-th second quantum state is a state of mᵢ qubits, wherein the total number of qubits of the N second quantum states is equal to m₁+ . . . +m_{N}.

14. The method of claim 12, wherein the size parameter of the quantum computation increases with the number N of second quantum states.

15. The method according to claim 11, wherein the computational key is associated with the input quantum state of the quantum computation.

16. The method according to claim 11, wherein the input quantum state is representable, particularly approximately representable, as a probability distribution Pᵢₙₚᵤₜ, wherein the computational key contains information allowing the first system to obtain at least one sample of the probability distribution Pᵢₙₚᵤₜ.

17. The method according to claim 16, wherein the probability distribution Pᵢₙₚᵤₜ is a probability distribution over a plurality of extreme points of a convex operator set Δ.

18. The method according to claim 17, wherein the convex operator set Δ consists of all Hermitian n-qubit operators X such that Tr (X)=1 and Tr (|σ><σ|X)≥0 for all n-qubit Pauli stabilizer states |σ>.

19. (canceled)

20. The method according to claim 17, wherein the method further comprises:
providing a sample of the probability distribution Pᵢₙₚᵤₜ, wherein the sample is generated by the first system using the computational key or wherein the sample is included in the computational key communicated to the first system by the second system, wherein the sample yields, as an outcome of the sample, an extreme point of the convex operator set Δ.

21. The method according to claim 17, wherein the convex operator set Δ is a set of n-qubit operators, denoted as Δ=Δ(n), wherein the quantum computation includes a first measurement, particularly a Pauli measurement, wherein the first measurement is representable as a probability distribution P₁, wherein the simulation of the quantum computation performed by the first system includes:
based on the sample of the probability distribution Pᵢₙₚᵤₜ, providing a sample of the probability distribution P₁, wherein the sample of the probability distribution P₁ yields, as an outcome of the sample, an extreme point of a convex operator set Δ(n₁) and a simulated measurement outcome of the first measurement,
wherein the convex operator set Δ(n₁) is a set of n₁-qubit operators, wherein either (a) n₁ is equal to n and the convex operator set Δ(n₁) is equal to the convex operator set Δ(n) or (b) n₁ is smaller than n and the convex operator set Δ(n₁) is different from the convex operator set Δ(n).

22. The method according to claim 21, wherein the convex operator set Δ(n₁) consists of all Hermitian n₁-qubit operators X such that Tr (X)=1 and Tr (|σ><σ|X)≥0 for all n₁-qubit Pauli stabilizer states |σ>.

23. The method according to claim 21, wherein the quantum computation includes a second measurement, particularly a Pauli measurement, wherein the second measurement is configured to be performed after the first measurement, wherein the second measurement is representable as a probability distribution P₂, wherein the simulation of the quantum computation performed by the first system includes:
providing a sample of the probability distribution P₂, wherein the sample of the probability distribution P₂ yields, as an outcome of the sample, an extreme point of a convex operator set Δ(n₂) and a simulated measurement outcome of the second measurement, wherein the convex operator set Δ(n₂) is a set of n₂-qubit operators, wherein (a) n₂ is equal to n₁ and the convex operator set Δ(n₂) is equal to the convex operator set Δ(n₁) or (b) n₂ is smaller than n₁ and the convex operator set Δ(n₂) is different from the convex operator set Δ(n₁)

24. The method according to claim 23, wherein the convex operator set Δ(n₂) consists of all Hermitian n₂-qubit operators X such that Tr (X)=1 and Tr (|σ><σ|X)≥0 for all n₂-qubit Pauli stabilizer states |σ>.

25.-26. (canceled)

27. The method according to claim 1, wherein the quantum computation includes a plurality of measurements M₁, M₂ . . . M_{T}, wherein T is 5 or larger, 10 or larger, or 100 or larger, particularly wherein the plurality of measurements are Pauli measurements,
wherein, for each i, the (i+1)-th measurement Mᵢ₊₁ of the plurality of measurements is configured to be performed after the i-th measurement Mᵢ of the plurality of measurements, wherein each i-th measurement M is representable as a probability distribution Pᵢ,
wherein the simulation of the quantum computation performed by the first system includes, for each i-th measurement Mᵢ:
providing a sample of the probability distribution Pᵢ, wherein the sample of the probability distribution Pᵢ yields, as an outcome of the sample, an extreme point of a convex operator set Δ(nᵢ) and a simulated measurement outcome of the i-th measurement Mᵢ, wherein the convex operator set Δ(nᵢ) is a set of nᵢ-qubit operators,
wherein, for each i, the number of qubits nᵢ₊₁ associated with the convex operator set Δ(nᵢ₊₁) relating to the (i+1)-th measurement Mᵢ₊₁ is smaller than or equal to, particularly smaller than, the number of qubits nᵢ associated with the convex operator set Δ(nᵢ) relating to the i-th measurement Mᵢ.

28. The method according to claim 27, wherein, for each i, the convex operator set Δ(nᵢ) consists of all Hermitian nᵢ-qubit operators X such that Tr (X)=1 and Tr (|σ><σ|X)≥0 for all nᵢ-qubit Pauli stabilizer states |σ>.

29. The method according to claim 1, wherein the quantum computation includes an i-th measurement and an (i+1)th measurement configured to be performed directly after the i-th measurement, wherein the i-th measurement is representable as a probability distribution Pᵢ, wherein the simulation of the quantum computation performed by the first system includes:
providing a sample of the probability distribution Pᵢ, wherein the sample of the probability distribution Pᵢ yields, as an outcome of the sample, an extreme point of a convex operator set Δ(nᵢ) and a simulated measurement outcome of the i-th measurement, wherein the convex operator set Δ(nᵢ) is a set of nᵢ-qubit operators;
determining whether the extreme point of the convex operator set Δ(nᵢ) obtained by sampling the probability distribution Pᵢ has the form U A_{α}⊗πU*, wherein U is a unitary Clifford operator, IT is a Pauli projector and A_{α} is an extreme point of a convex operator set Δ(m) of m-qubit operators where m is smaller than nᵢ; and
if the extreme point obtained by sampling the probability distribution Pᵢ has the form U A_{α}⊗πU*, providing a sample of a probability distribution Pᵢ₊₁ wherein the sample of the probability distribution Pᵢ₊₁ yields, as an outcome of the sample, an extreme point of the convex operator set Δ(m) and a simulated measurement outcome of the (i+1)th measurement.

30. The method according to claim 1, further comprising:
determining, by the second system, the computational key from the size parameter.

31. The method according to claim 30, wherein the computational key is determined using a linear programming algorithm.

32. The method according to claim 1, further comprising:
storing the computational key by the second system.

33. The method according to claim 1, wherein the first system comprises a plurality of processing units, wherein the simulation of the quantum computation is performed in parallel by the plurality of processing units.

34.-36. (canceled)

37. A system (10) for simulating a quantum computation, comprising:
a first system (110) comprising one or more first processing units (112); and
a second system (120) comprising one or more second processing units (122), the second system being communicatively coupled to the first system,
wherein the first system is configured to communicate a size parameter of a quantum computation to the second system, wherein the quantum computation is configured for solving a computational problem, wherein the size parameter is characteristic of an input size of the computational problem,
wherein the second system is configured for communicating a computational key to the first system, wherein the computational key is based on the size parameter of the quantum computation, and
wherein the first system is configured for performing a simulation of the quantum computation based on the computational key.

38-40. (canceled)
